(19) United States
(12) Patent Application Publication
(10) Pub. No.: US 2026/0073694 A1
(43) Pub. Date: Mar. 12, 2026

(54) RESPONSE GENERATION WITH MULTIMODAL CONTEXT

(71) Applicant: Apple Inc., Cupertino, CA (US)

(72) Inventors: Adrian ZUMBRUNNEN, San Francisco, CA (US); Shiraz AKMAL, Playa Vista, CA (US); St John W. COLON, Los Angeles, CA (US); Brad K. HERMAN, Culver City, CA (US); James N. JONES, San Francisco, CA (US); Johnnie B. MANZARI, San Francisco, CA (US)

(21) Appl. No.: 19/295,463

(22) Filed: Aug. 8, 2025

Related U.S. Application Data
(60) Provisional application No. 63/692,156, filed on Sep. 8, 2024.
(60) Provisional application No. 63/793,553, filed on Apr. 23, 2025.

(51) Int. Cl. G06V 20/50; G06F 9/451

(52) U.S. Cl. CPC G06V 20/50; G06F 9/453

(57) ABSTRACT

Systems and processes for operating an intelligent automated assistant are provided. Example methods include displaying a representation of a current field-of-view of a camera and, while displaying the representation, generating responses to user inputs based on context information determined from the current field-of-view of the camera.

### CROSS-REFERENCE TO RELATED APPLICATIONS

This application claims priority to U.S. Provisional Patent Application Ser. No. 63/793,553, entitled “RESPONSE GENERATION WITH MULTIMODAL CONTEXT,” filed Apr. 23, 2025, and claims priority to U.S. Provisional Patent Application 63/692,156, entitled “RESPONSE GENERATION WITH MULTIMODAL CONTEXT,” filed Sep. 8, 2024. The contents of each of these applications are incorporated herein by reference in its entirety.

### FIELD

This relates generally to intelligent automated assistants and, more specifically, to intelligent automated assistants integrating visual context.

### BACKGROUND

Intelligent automated assistants (or digital assistants) can provide a beneficial interface between human users and electronic devices. Such assistants can allow users to interact with devices or systems using natural language in spoken and/or text forms. For example, a user can provide a speech input containing a user request to a digital assistant operating on an electronic device. The digital assistant can interpret the user's intent from the speech input and operationalize the user's intent into tasks. For example, the digital assistant implements natural-language processing techniques to interpret and operationalize the intent of the speech input, including disambiguating the language of the speech input and extracting information needed for the tasks (e.g., parameter values). The tasks can then be performed by executing one or more services of the electronic device, and a relevant output responsive to the user request can be returned to the user.

### SUMMARY

Example methods are disclosed herein. An example method includes, at an electronic device with a display generation component, one or more cameras, one or more processors, and memory: displaying, via the display generation component, a representation of a feed of camera data from the one or more cameras; while displaying the representation of the feed of the camera data from the one or more cameras, detecting a user input; determining, based on the camera data from the one or more cameras, first visual context information; in response to detecting the user input, providing a representation of the user input and the first visual context information to a digital assistant agent; and generating, using the digital assistant agent, a response based on the representation of the user input and the first visual context information, wherein generating the response includes: selecting an application intent corresponding to the user input; and providing the application intent to an application, wherein providing the application intent to the application causes the application to execute a task.

Example non-transitory computer-readable media are disclosed herein. An example non-transitory computer-readable storage medium stores one or more programs. The one or more programs comprise instructions, which when executed by one or more processors of an electronic device with a display generation component and one or more cameras, cause the electronic device to display, via the display generation component, a representation of a feed of camera data from the one or more cameras; while displaying the representation of the feed of the camera data from the one or more cameras, detect a user input; determine, based on the camera data from the one or more cameras, first visual context information; in response to detecting the user input, provide a representation of the user input and the first visual context information to a digital assistant agent; and generate, using the digital assistant agent, a response based on the representation of the user input and the first visual context information, wherein generating the response includes: selecting an application intent corresponding to the user input; and providing the application intent to an application, wherein providing the application intent to the application causes the application to execute a task.

Example electronic devices are disclosed herein. An example electronic device comprises a display generation component; one or more cameras; one or more processors; a memory; and one or more programs, where the one or more programs are stored in the memory and configured to be executed by the one or more processors, the one or more programs including instructions for displaying, via the display generation component, a representation of a feed of camera data from the one or more cameras; while displaying the representation of the feed of the camera data from the one or more cameras, detecting a user input; determining, based on the camera data from the one or more cameras, first visual context information; in response to detecting the user input, providing a representation of the user input and the first visual context information to a digital assistant agent; and generating, using the digital assistant agent, a response based on the representation of the user input and the first visual context information, wherein generating the response includes: selecting an application intent corresponding to the user input; and providing the application intent to an application, wherein providing the application intent to the application causes the application to execute a task.

An example electronic device comprises a display generation component, one or more cameras, and means for displaying, via the display generation component, a representation of a feed of camera data from the one or more cameras; means for, while displaying the representation of the feed of the camera data from the one or more cameras, detecting a user input; means for determining, based on the camera data from the one or more cameras, first visual context information; means for, in response to detecting the user input, providing a representation of the user input and the first visual context information to a digital assistant agent; and means for generating, using the digital assistant agent, a response based on the representation of the user input and the first visual context information, wherein generating the response includes: selecting an application intent corresponding to the user input; and providing the application intent to an application, wherein providing the application intent to the application causes the application to execute a task.

Example methods are disclosed herein. An example method includes, at an electronic device with a display generation component, one or more cameras, one or more processors, and memory: displaying, via the display generation component, a representation a feed of camera data received from the one or more cameras in a first mode, wherein displaying the representation of the feed of camera data in the first mode includes: receiving, via the one or more cameras, the feed of the camera data; and in response to receiving the feed of the camera data, updating the representation of the feed of the camera data; while displaying the representation of the feed of camera data in the first mode, detecting a user input; and in response to detecting the user input: in accordance with a determination that the user input satisfies a set of one or more prompt criteria: displaying the representation of the feed of the camera data in a second mode, wherein displaying the representation of the feed of the camera data in the second mode includes foregoing updating the representation of feed of the camera data; while displaying the representation of the feed of the camera data in the second mode, displaying, via the display generation component, a first frame of the camera data corresponding to the user input; and outputting a response to the user input, wherein the response to the user input is based on the first frame of camera data corresponding to the user input.

Example non-transitory computer-readable media are disclosed herein. An example non-transitory computer-readable storage medium stores one or more programs. The one or more programs comprise instructions, which when executed by one or more processors of an electronic device with a display generation component and one or more cameras, cause the electronic device to: display, via the display generation component, a representation a feed of camera data received from the one or more cameras in a first mode, wherein displaying the representation of the feed of camera data in the first mode includes: receive, via the one or more cameras, the feed of the camera data; and in response to receiving the feed of the camera data, updating the representation of the feed of the camera data; while displaying the representation of the feed of camera data in the first mode, detect a user input; and in response to detecting the user input: in accordance with a determination that the user input satisfies a set of one or more prompt criteria: display the representation of the feed of the camera data in a second mode, wherein displaying the representation of the feed of the camera data in the second mode includes foregoing updating the representation of feed of the camera data; while displaying the representation of the feed of the camera data in the second mode, display, via the display generation component, a first frame of the camera data corresponding to the user input; and output a response to the user input, wherein the response to the user input is based on the first frame of camera data corresponding to the user input.

Example electronic devices are disclosed herein. An example electronic device comprises a display generation component; one or more cameras; one or more processors; a memory; and one or more programs, where the one or more programs are stored in the memory and configured to be executed by the one or more processors, the one or more programs including instructions for: displaying, via the display generation component, a representation a feed of camera data received from the one or more cameras in a first mode, wherein displaying the representation of the feed of camera data in the first mode includes: receiving, via the one or more cameras, the feed of the camera data; and in response to receiving the feed of the camera data, updating the representation of the feed of the camera data; while displaying the representation of the feed of camera data in the first mode, detecting a user input; and in response to detecting the user input: in accordance with a determination that the user input satisfies a set of one or more prompt criteria: displaying the representation of the feed of the camera data in a second mode, wherein displaying the representation of the feed of the camera data in the second mode includes foregoing updating the representation of feed of the camera data; while displaying the representation of the feed of the camera data in the second mode, displaying, via the display generation component, a first frame of the camera data corresponding to the user input; and outputting a response to the user input, wherein the response to the user input is based on the first frame of camera data corresponding to the user input.

An example electronic device comprises a display generation component, one or more cameras, and means for displaying, via the display generation component, a representation a feed of camera data received from the one or more cameras in a first mode, wherein displaying the representation of the feed of camera data in the first mode includes: receiving, via the one or more cameras, the feed of the camera data; and in response to receiving the feed of the camera data, updating the representation of the feed of the camera data; means for, while displaying the representation of the feed of camera data in the first mode, detecting a user input; and means for, in response to detecting the user input: in accordance with a determination that the user input satisfies a set of one or more prompt criteria: displaying the representation of the feed of the camera data in a second mode, wherein displaying the representation of the feed of the camera data in the second mode includes foregoing updating the representation of feed of the camera data; while displaying the representation of the feed of the camera data in the second mode, displaying, via the display generation component, a first frame of the camera data corresponding to the user input; and outputting a response to the user input, wherein the response to the user input is based on the first frame of camera data corresponding to the user input.

Example methods are disclosed herein. An example method includes, at an electronic device with a display generation component, one or more cameras, one or more hardware input devices, one or more processors, and memory: receiving a first user input including a first prompt; in response to receiving the first user input including the first prompt, storing the first prompt as a prompt associated with a first hardware input device of the one or more hardware input devices; displaying, via the display generation component, a representation of a feed of camera data from the one or more cameras; while displaying the representation of the feed of the camera data from the one or more cameras, detecting, via the first hardware input device, a second user input; and in response to detecting the second user input: outputting a response to the prompt associated with the first hardware input device based on a first portion of the feed of the camera data, wherein the first portion of the feed of the camera data corresponds to the second user input, wherein outputting the response to the prompt associated with the first hardware input device includes: in accordance with a determination that the first prompt is stored as the prompt associated with the first hardware input device when the second user input is detected, outputting a first response to the first prompt based on the first portion of the feed of the camera data.

Example non-transitory computer-readable media are disclosed herein. An example non-transitory computer-readable storage medium stores one or more programs. The one or more programs comprise instructions, which when executed by one or more processors of an electronic device with a display generation component, one or more cameras, and one or more hardware input devices, cause the electronic device to: receive a first user input including a first prompt; in response to receiving the first user input including the first prompt, store the first prompt as a prompt associated with a first hardware input device of the one or more hardware input devices; display, via the display generation component, a representation of a feed of camera data from the one or more cameras; while displaying the representation of the feed of the camera data from the one or more cameras, detect, via the first hardware input device, a second user input; and in response to detecting the second user input: output a response to the prompt associated with the first hardware input device based on a first portion of the feed of the camera data, wherein the first portion of the feed of the camera data corresponds to the second user input, wherein outputting the response to the prompt associated with the first hardware input device includes: in accordance with a determination that the first prompt is stored as the prompt associated with the first hardware input device when the second user input is detected, outputting a first response to the first prompt based on the first portion of the feed of the camera data.

Example electronic devices are disclosed herein. An example electronic device comprises a display generation component; one or more cameras; one or more hardware input devices; one or more processors; a memory; and one or more programs, where the one or more programs are stored in the memory and configured to be executed by the one or more processors, the one or more programs including instructions for: receiving a first user input including a first prompt; in response to receiving the first user input including the first prompt, storing the first prompt as a prompt associated with a first hardware input device of the one or more hardware input devices; displaying, via the display generation component, a representation of a feed of camera data from the one or more cameras; while displaying the representation of the feed of the camera data from the one or more cameras, detecting, via the first hardware input device, a second user input; and in response to detecting the second user input: outputting a response to the prompt associated with the first hardware input device based on a first portion of the feed of the camera data, wherein the first portion of the feed of the camera data corresponds to the second user input, wherein outputting the response to the prompt associated with the first hardware input device includes: in accordance with a determination that the first prompt is stored as the prompt associated with the first hardware input device when the second user input is detected, outputting a first response to the first prompt based on the first portion of the feed of the camera data.

An example electronic device comprises a display generation component, one or more cameras, one or more hardware input devices, and means for receiving a first user input including a first prompt; means for, in response to receiving the first user input including the first prompt, storing the first prompt as a prompt associated with a first hardware input device of the one or more hardware input devices; means for displaying, via the display generation component, a representation of a feed of camera data from the one or more cameras; means for, while displaying the representation of the feed of the camera data from the one or more cameras, detecting, via the first hardware input device, a second user input; and means for, in response to detecting the second user input: outputting a response to the prompt associated with the first hardware input device based on a first portion of the feed of the camera data, wherein the first portion of the feed of the camera data corresponds to the second user input, wherein outputting the response to the prompt associated with the first hardware input device includes: in accordance with a determination that the first prompt is stored as the prompt associated with the first hardware input device when the second user input is detected, outputting a first response to the first prompt based on the first portion of the feed of the camera data.

Example methods are disclosed herein. An example method includes, at an electronic device with a display generation component, one or more cameras, one or more processors, and memory: receiving a first user input including a request to activate a digital assistant; in response to receiving the first user input including the request to activate the digital assistant, displaying, via the display generation component, a digital assistant user interface, wherein the digital assistant user interface includes a first selectable user interface object; receiving a second user input selecting the first selectable user interface object; in response to receiving the second user input selecting the first selectable user interface object, displaying, via the display generation component, a representation of a feed of camera data from the one or more cameras; while displaying the representation of the feed of the camera data from the one or more cameras, receiving a third user input including a prompt; and in response to receiving the third user input including the prompt, outputting a response to the prompt, wherein the response to the prompt is based on the representation of the feed of the camera data from the one or more cameras.

Example non-transitory computer-readable media are disclosed herein. An example non-transitory computer-readable storage medium stores one or more programs. The one or more programs comprise instructions, which when executed by one or more processors of an electronic device with a display generation component and one or more cameras, cause the electronic device to: receive a first user input including a request to activate a digital assistant; in response to receiving the first user input including the request to activate the digital assistant, display, via the display generation component, a digital assistant user interface, wherein the digital assistant user interface includes a first selectable user interface object; receive a second user input selecting the first selectable user interface object; in response to receiving the second user input selecting the first selectable user interface object, display, via the display generation component, a representation of a feed of camera data from the one or more cameras; while displaying the representation of the feed of the camera data from the one or more cameras, receive a third user input including a prompt; and in response to receiving the third user input including the prompt, output a response to the prompt, wherein the response to the prompt is based on the representation of the feed of the camera data from the one or more cameras.

Example electronic devices are disclosed herein. An example electronic device comprises a display generation component; one or more cameras; one or more processors; a memory; and one or more programs, where the one or more programs are stored in the memory and configured to be executed by the one or more processors, the one or more programs including instructions for: receiving a first user input including a request to activate a digital assistant; in response to receiving the first user input including the request to activate the digital assistant, displaying, via the display generation component, a digital assistant user interface, wherein the digital assistant user interface includes a first selectable user interface object; receiving a second user input selecting the first selectable user interface object; in response to receiving the second user input selecting the first selectable user interface object, displaying, via the display generation component, a representation of a feed of camera data from the one or more cameras; while displaying the representation of the feed of the camera data from the one or more cameras, receiving a third user input including a prompt; and in response to receiving the third user input including the prompt, outputting a response to the prompt, wherein the response to the prompt is based on the representation of the feed of the camera data from the one or more cameras.

An example electronic device comprises a display generation component, one or more cameras, and means for receiving a first user input including a request to activate a digital assistant; means for, in response to receiving the first user input including the request to activate the digital assistant, displaying, via the display generation component, a digital assistant user interface, wherein the digital assistant user interface includes a first selectable user interface object; means for receiving a second user input selecting the first selectable user interface object; means for, in response to receiving the second user input selecting the first selectable user interface object, displaying, via the display generation component, a representation of a feed of camera data from the one or more cameras; means for, while displaying the representation of the feed of the camera data from the one or more cameras, receiving a third user input including a prompt; and means for, in response to receiving the third user input including the prompt, outputting a response to the prompt, wherein the response to the prompt is based on the representation of the feed of the camera data from the one or more cameras.

Example methods are disclosed herein. An example method includes, at an electronic device with a display generation component, one or more input devices, one or more processors, and memory: while displaying, via the display generation component, a first set of one or more visual context items within a digital assistant user interface, detecting a set of one or more inputs selecting a second set of one or more visual context items from the first set of visual context items; in response to detecting the set of one or more inputs selecting the second set of one or more visual context items, modifying a display state of at least one visual context item of the first set of one or more visual context items based on the first set of one or more inputs; while displaying the digital assistant user interface, receiving a user request; and in response to receiving the user request, providing a response to the user request based the second set of one or more visual context items.

Example non-transitory computer-readable media are disclosed herein. An example non-transitory computer-readable storage medium stores one or more programs. The one or more programs comprise instructions, which when executed by one or more processors of an electronic device with a display generation component and one or more input devices, cause the electronic device to: while displaying, via the display generation component, a first set of one or more visual context items within a digital assistant user interface, detect a set of one or more inputs selecting a second set of one or more visual context items from the first set of visual context items; in response to detecting the set of one or more inputs selecting the second set of one or more visual context items, modify a display state of at least one visual context item of the first set of one or more visual context items based on the first set of one or more inputs; while displaying the digital assistant user interface, receive a user request; and in response to receiving the user request, provide a response to the user request based the second set of one or more visual context items.

Example electronic devices are disclosed herein. An example electronic device comprises a display generation component; one or more input devices; one or more processors; a memory; and one or more programs, where the one or more programs are stored in the memory and configured to be executed by the one or more processors, the one or more programs including instructions for: while displaying, via the display generation component, a first set of one or more visual context items within a digital assistant user interface, detecting a set of one or more inputs selecting a second set of one or more visual context items from the first set of visual context items; in response to detecting the set of one or more inputs selecting the second set of one or more visual context items, modifying a display state of at least one visual context item of the first set of one or more visual context items based on the first set of one or more inputs; while displaying the digital assistant user interface, receiving a user request; and in response to receiving the user request, providing a response to the user request based the second set of one or more visual context items.

An example electronic device comprises a display generation component, one or more input devices, and means for, while displaying, via the display generation component, a first set of one or more visual context items within a digital assistant user interface, detecting a set of one or more inputs selecting a second set of one or more visual context items from the first set of visual context items; means for, in response to detecting the set of one or more inputs selecting the second set of one or more visual context items, modifying a display state of at least one visual context item of the first set of one or more visual context items based on the first set of one or more inputs; means for, while displaying the digital assistant user interface, receiving a user request; and means for, in response to receiving the user request, providing a response to the user request based the second set of one or more visual context items.

Example methods are disclosed herein. An example method includes, at an electronic device with a display generation component, one or more input devices, one or more processors, and memory: detecting, via the one or more input devices, a first plurality of user inputs; in response to detecting the first plurality of user inputs, displaying, via the display generation component, a set of visual context items within a digital assistant user interface, wherein displaying the set of visual context items within the digital assistant user interface includes: in response to detecting a first user input of the first plurality of user inputs, displaying, within the digital assistant user interface, a first visual context item including a representation of first content, wherein the first user input of the first plurality of user inputs is detected while displaying, via the display generation component, the first content; and in response to detecting a second user input of the first plurality of user inputs, displaying, within the digital assistant user interface, a second visual context item including a representation of second content, wherein the second user input of the first plurality of user inputs is detected while displaying, via the display generation component, the second content; while displaying the digital assistant user interface, receiving a user request; and in response to receiving the user request, providing a response to the user request based on a subset of one or more of the set of visual context items.

Example non-transitory computer-readable media are disclosed herein. An example non-transitory computer-readable storage medium stores one or more programs. The one or more programs comprise instructions, which when executed by one or more processors of an electronic device with a display generation component and one or more input devices, cause the electronic device to: detect, via the one or more input devices, a first plurality of user inputs; in response to detecting the first plurality of user inputs, display, via the display generation component, a set of visual context items within a digital assistant user interface, wherein displaying the set of visual context items within the digital assistant user interface includes: in response to detecting a first user input of the first plurality of user inputs, displaying, within the digital assistant user interface, a first visual context item including a representation of first content, wherein the first user input of the first plurality of user inputs is detected while displaying, via the display generation component, the first content; and in response to detecting a second user input of the first plurality of user inputs, displaying, within the digital assistant user interface, a second visual context item including a representation of second content, wherein the second user input of the first plurality of user inputs is detected while displaying, via the display generation component, the second content; while displaying the digital assistant user interface, receive a user request; and in response to receiving the user request, provide a response to the user request based on a subset of one or more of the set of visual context items.

Example electronic devices are disclosed herein. An example electronic device comprises a display generation component; one or more cameras; one or more processors; a memory; and one or more programs, where the one or more programs are stored in the memory and configured to be executed by the one or more processors, the one or more programs including instructions for: detecting, via the one or more input devices, a first plurality of user inputs; in response to detecting the first plurality of user inputs, displaying, via the display generation component, a set of visual context items within a digital assistant user interface, wherein displaying the set of visual context items within the digital assistant user interface includes: in response to detecting a first user input of the first plurality of user inputs, displaying, within the digital assistant user interface, a first visual context item including a representation of first content, wherein the first user input of the first plurality of user inputs is detected while displaying, via the display generation component, the first content; and in response to detecting a second user input of the first plurality of user inputs, displaying, within the digital assistant user interface, a second visual context item including a representation of second content, wherein the second user input of the first plurality of user inputs is detected while displaying, via the display generation component, the second content; while displaying the digital assistant user interface, receiving a user request; and in response to receiving the user request, providing a response to the user request based on a subset of one or more of the set of visual context items.

An example electronic device comprises a display generation component, one or more cameras, and means for detecting, via the one or more input devices, a first plurality of user inputs; means for, in response to detecting the first plurality of user inputs, displaying, via the display generation component, a set of visual context items within a digital assistant user interface, wherein displaying the set of visual context items within the digital assistant user interface includes: in response to detecting a first user input of the first plurality of user inputs, displaying, within the digital assistant user interface, a first visual context item including a representation of first content, wherein the first user input of the first plurality of user inputs is detected while displaying, via the display generation component, the first content; and in response to detecting a second user input of the first plurality of user inputs, displaying, within the digital assistant user interface, a second visual context item including a representation of second content, wherein the second user input of the first plurality of user inputs is detected while displaying, via the display generation component, the second content; means for, while displaying the digital assistant user interface, receiving a user request; and means for, in response to receiving the user request, providing a response to the user request based on a subset of one or more of the set of visual context items.

Providing multimodal digital assistant systems that integrate visual context as described herein provides improved, more efficient control of electronic devices. For example, digital assistant systems that include user interfaces for interacting with the visible environment (e.g., using live- or near-live camera data from one or more cameras) reduce the time and number of inputs used to control electronic devices, which reduces the power usage and improves the battery life of computer systems by enabling the user to use the devices more quickly and efficiently. Doing so also improves the user experience by providing a wider variety of device functionality and more relevant responses to user inputs, for example, using the context of the visible environment to inform outputs and perform tasks, which improves user confidence in the digital assistant system and reduces the cognitive burden on the user when interacting with the digital assistant system. Additionally, collecting and presenting visual context as described herein (e.g., as part of a visual memory) provides users with improved control and visual feedback when using multimodal digital assistant systems that integrate visual context, improving the ease of use and breadth of functionality, and thus also reducing the power usage and improving the battery life of the system by enabling the user to use the devices more quickly and efficiently.

### BRIEF DESCRIPTION OF THE DRAWINGS

FIG. 1 is a block diagram illustrating a system and environment for implementing a digital assistant, according to various examples.

FIG. 2A is a block diagram illustrating a portable multifunction device implementing the client-side portion of a digital assistant, according to various examples.

FIG. 2B is a block diagram illustrating exemplary components for event handling, according to various examples.

FIG. 3 illustrates a portable multifunction device implementing the client-side portion of a digital assistant, according to various examples.

FIG. 4A is a block diagram of an exemplary multifunction device with a display and a touch-sensitive surface, according to various examples.

FIGS. 4B-4G illustrate the use of Application Programming Interfaces (APIs) to perform operations.

FIG. 5A illustrates an exemplary user interface for a menu of applications on a portable multifunction device, according to various examples.

FIG. 5B illustrates an exemplary user interface for a multifunction device with a touch-sensitive surface that is separate from the display, according to various examples.

FIG. 6A illustrates a personal electronic device, according to various examples.

FIG. 6B is a block diagram illustrating a personal electronic device, according to various examples.

FIG. 7A is a block diagram illustrating a digital assistant system or a server portion thereof, according to various examples.

FIG. 7B illustrates the functions of the digital assistant shown in FIG. 7A, according to various examples.

FIG. 7C illustrates a portion of an ontology, according to various examples.

FIG. 8 illustrates an exemplary foundation system, according to various examples.

FIG. 9 illustrates a block diagram of a digital assistant system for integrating visual context, according to various examples.

FIGS. 10A-10V illustrate systems for implementing digital assistants with visual context integration, according to various examples.

FIG. 11 illustrates a flow diagram for operating a digital assistant that integrates visual context with application task performance, according to various examples.

FIG. 12 illustrates a flow diagram for controlling a user interface for integrating visual context with a digital assistant, according to various examples.

FIG. 13 illustrates a flow diagram for controlling a digital assistant that integrates visual context using hardware button inputs, according to various examples.

FIG. 14 illustrates a flow diagram for controlling a user interface for a digital assistant that integrates visual context, according to various examples.

FIGS. 15A-15L illustrate user interfaces for interacting with collected items of visual context, according to various examples.

FIG. 16 illustrates a flow diagram for controlling a visual memory used by a digital assistant for response generation, according to various examples.

FIG. 17 illustrates a flow diagram for collecting a plurality of visual context items used as a visual memory for response generation, according to various examples.

### DETAILED DESCRIPTION

In the following description of examples, reference is made to the accompanying drawings in which are shown by way of illustration specific examples that can be practiced. It is to be understood that other examples can be used and structural changes can be made without departing from the scope of the various examples.

While displaying a live (e.g., or near-live) camera feed capturing visual information about the surrounding environment, in response to receiving a user input (e.g., a prompt), an electronic device generates a response to the user input based on the visual information represented in the camera feed at or around the time the user input is received (e.g., current visual context). Displaying the camera feed provides an efficient and intuitive way for users to “show” the electronic device relevant visual information, which reduces the time and number of inputs needed to use the electronic devices and provides users with improved visual feedback on interactions with the electronic devices. In some embodiments described herein, the response includes using an application to perform one or more tasks based on the current visual context, which provides efficient and intuitive ways for users to interact with applications without requiring the user to manually input visual context to different applications and/or requiring applications to independently integrate visual context. In some embodiments, the electronic device provides controls for pausing (e.g., freezing) and resuming the view of the live/near-live camera feed, which provides efficient and intuitive ways for users to interact with transient visual context. In some embodiments, the electronic device provides hardware controls for prompting responses, which reduces visual clutter and distraction while viewing the camera feed and reduces the time and number of inputs needed to prompt the electronic devices. In some embodiments, the live camera feed is accessible from within a digital assistant session, which provides efficient and intuitive ways for users to interact with digital assistants using visual context. Displaying multiple items of captured visual context (e.g., captured from the live camera feed and/or other visual sources, such as applications, web pages, media libraries, and the like) provides an efficient and intuitive way for users to see, and to control, the items of visual context the electronic device is “looking at” to generate responses. In some embodiments described herein, the electronic device provides user interfaces for capturing and displaying multiple visual context items (e.g., at once and/or at different times) for use as a visual memory for response generation, and in some embodiments described herein, the electronic device provides user interfaces for controlling which captured and displayed visual context items are used for response generation.

Although the following description uses terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input are both inputs and, in some cases, are separate and different inputs.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### 1. System and Environment

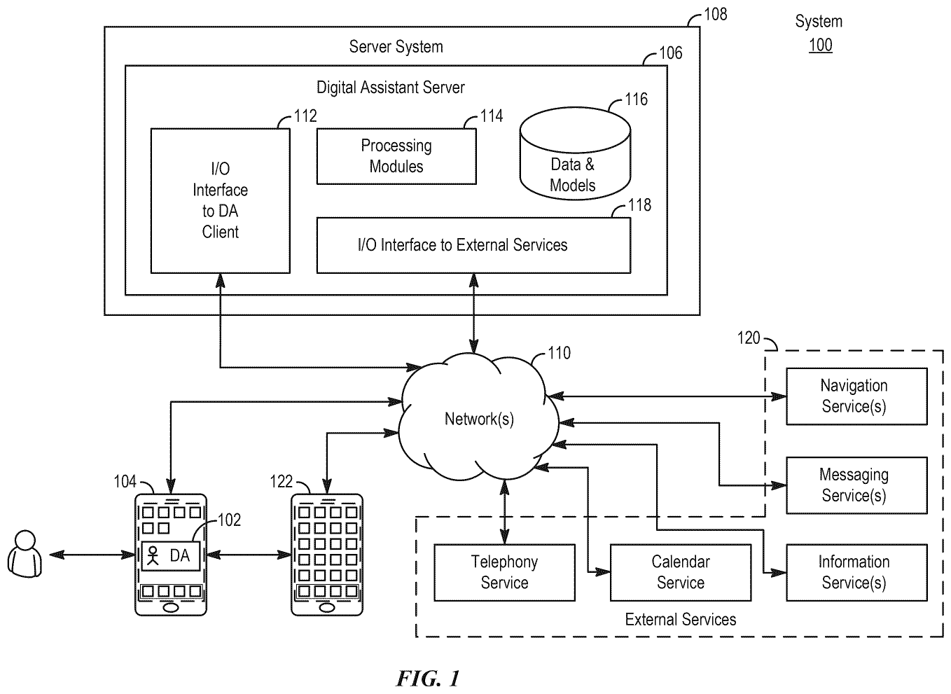

FIG. 1 illustrates a block diagram of system 100 according to various examples. In some examples, system 100 implements a digital assistant. The terms “digital assistant,” “virtual assistant,” “intelligent automated assistant,” or “automatic digital assistant” refer to any information processing system that interprets natural language input in spoken and/or textual form to infer user intent, and performs actions based on the inferred user intent. For example, to act on an inferred user intent, the system performs one or more of the following: identifying a task flow with steps and parameters designed to accomplish the inferred user intent, inputting specific requirements from the inferred user intent into the task flow; executing the task flow by invoking programs, methods, services, APIs, or the like; and generating output responses to the user in an audible (e.g., speech) and/or visual form.

Specifically, a digital assistant is capable of accepting a user request at least partially in the form of a natural language command, request, statement, narrative, and/or inquiry. Typically, the user request seeks either an informational answer or performance of a task by the digital assistant. A satisfactory response to the user request includes a provision of the requested informational answer, a performance of the requested task, or a combination of the two. For example, a user asks the digital assistant a question, such as “Where am I right now?” Based on the user's current location, the digital assistant answers, “You are in Central Park near the west gate.” The user also requests the performance of a task, for example, “Please invite my friends to my girlfriend's birthday party next week.” In response, the digital assistant can acknowledge the request by saying “Yes, right away,” and then send a suitable calendar invite on behalf of the user to each of the user's friends listed in the user's electronic address book. During performance of a requested task, the digital assistant sometimes interacts with the user in a continuous dialogue involving multiple exchanges of information over an extended period of time. There are numerous other ways of interacting with a digital assistant to request information or performance of various tasks. In addition to providing verbal responses and taking programmed actions, the digital assistant also provides responses in other visual or audio forms, e.g., as text, alerts, music, videos, animations, etc.

As shown in FIG. 1, in some examples, a digital assistant is implemented according to a client-server model. The digital assistant includes client-side portion 102 (hereafter “DA client 102”) executed on user device 104 and server-side portion 106 (hereafter “DA server 106”) executed on server system 108. DA client 102 communicates with DA server 106 through one or more networks 110. DA client 102 provides client-side functionalities such as user-facing input and output processing and communication with DA server 106. DA server 106 provides server-side functionalities for any number of DA clients 102 each residing on a respective user device 104.

In some examples, DA server 106 includes client-facing I/O interface 112, one or more processing modules 114, data and models 116, and I/O interface to external services 118. The client-facing I/O interface 112 facilitates the client-facing input and output processing for DA server 106. One or more processing modules 114 utilize data and models 116 to process speech input and determine the user's intent based on natural language input. Further, one or more processing modules 114 perform task execution based on inferred user intent. In some examples, DA server 106 communicates with external services 120 through network(s) 110 for task completion or information acquisition. I/O interface to external services 118 facilitates such communications.

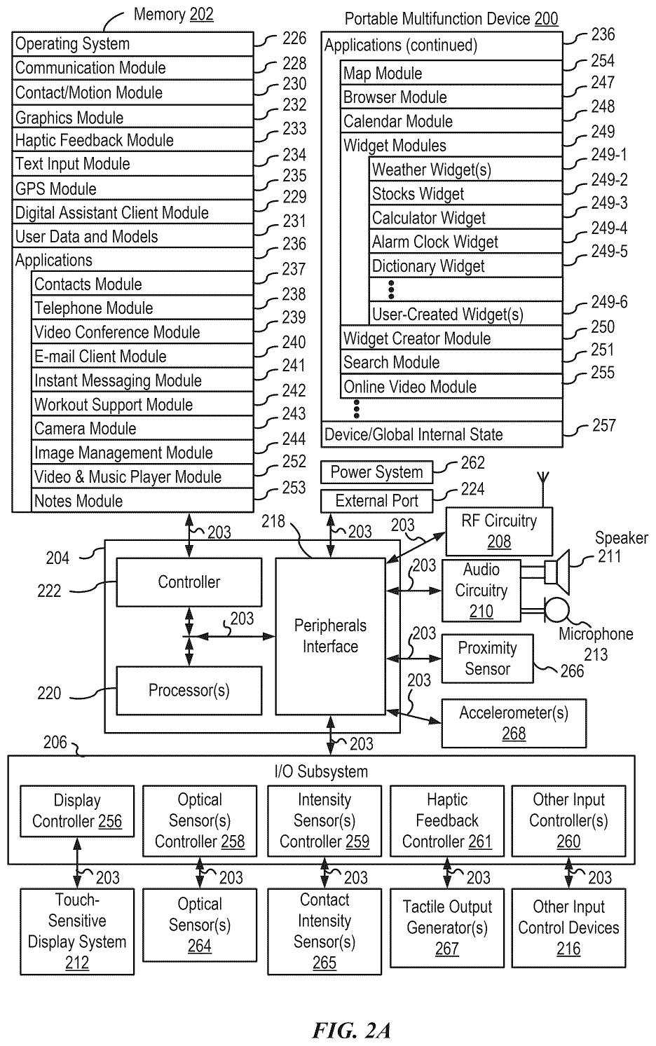

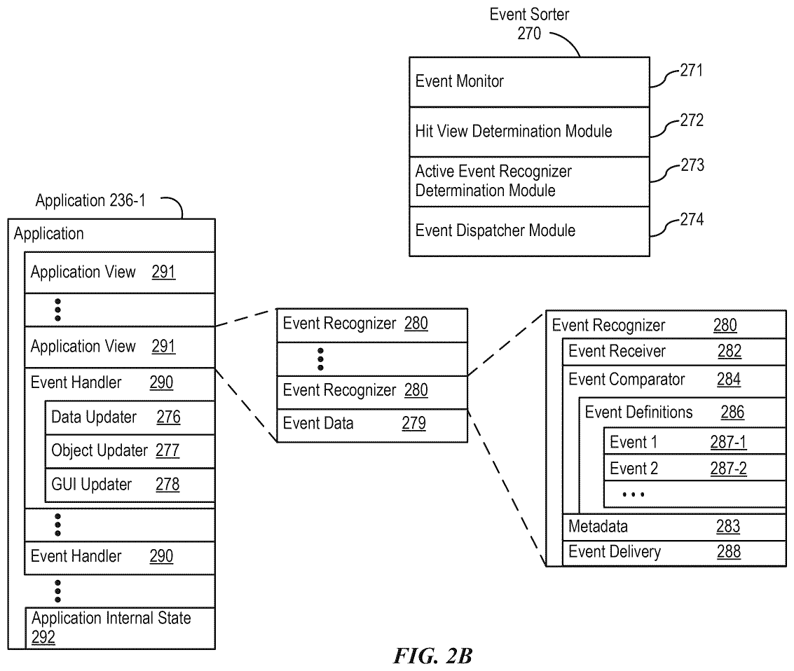

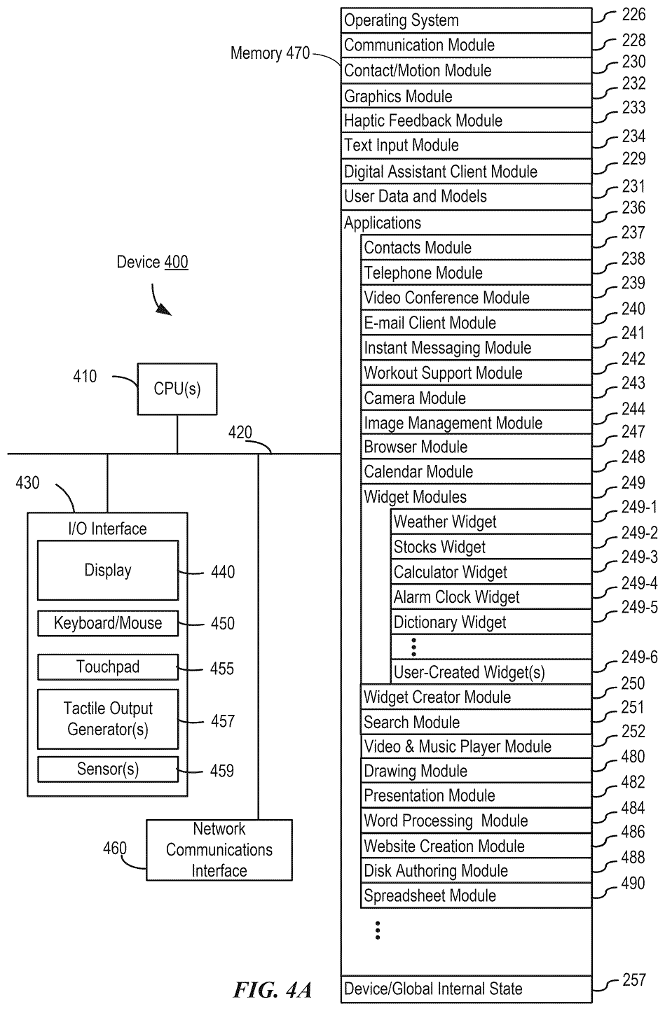

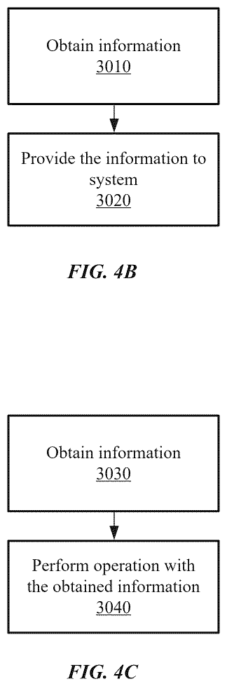

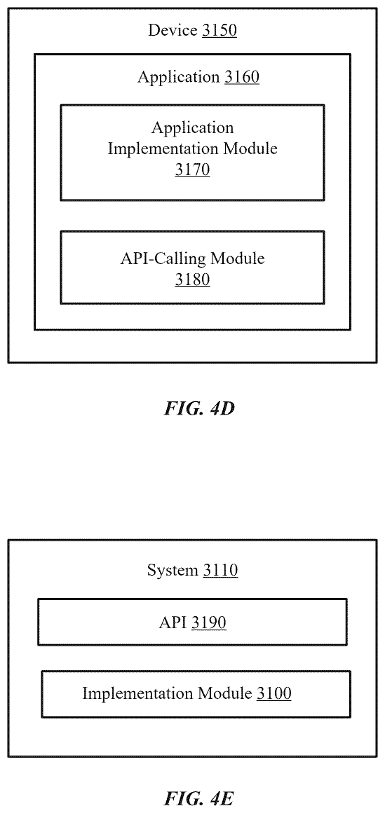

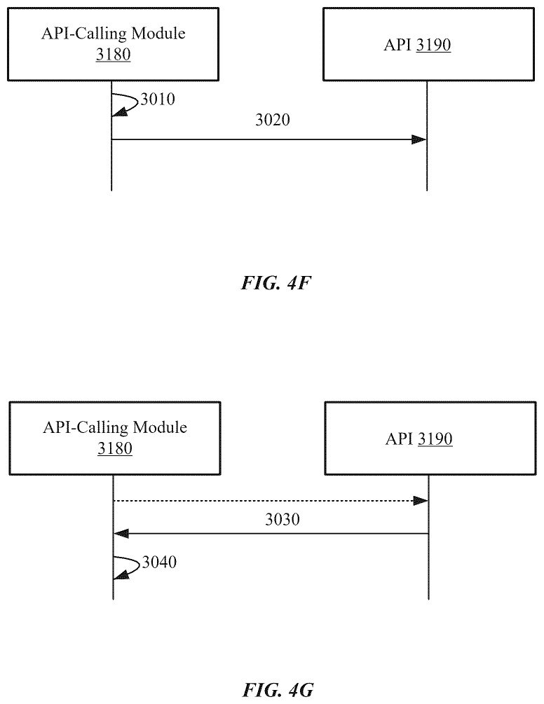

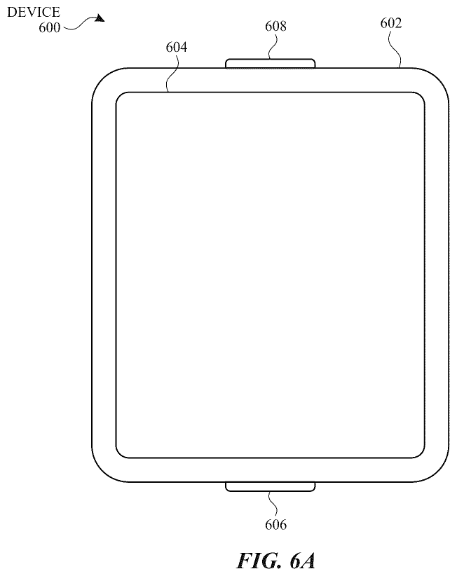

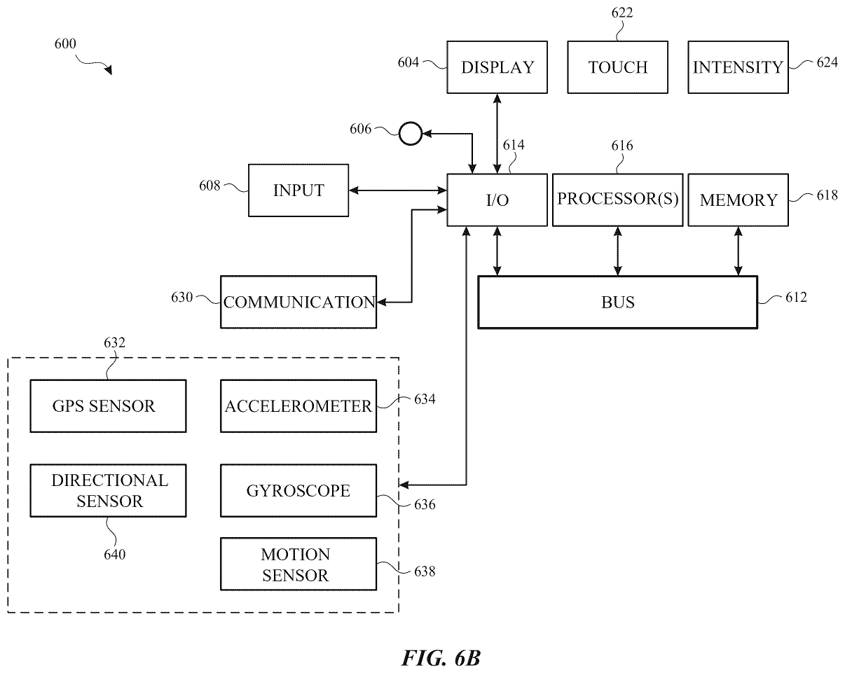

User device 104 can be any suitable electronic device. In some examples, user device 104 is a portable multifunctional device (e.g., device 200, described below with reference to FIG. 2A), a multifunctional device (e.g., device 400, described below with reference to FIG. 4A), or a personal electronic device (e.g., device 600, described below with reference to FIGS. 6A-6B). A portable multifunctional device is, for example, a mobile telephone that also contains other functions, such as PDA and/or music player functions. Specific examples of portable multifunction devices include the Apple Watch®, iPhone®, iPod Touch®, and iPad® devices from Apple Inc. of Cupertino, California. Other examples of portable multifunction devices include, without limitation, earphones/headphones, speakers, and laptop or tablet computers. Further, in some examples, user device 104 is a non-portable multifunctional device. In particular, user device 104 is a desktop computer, a game console, a speaker, a television, or a television set-top box. In some examples, user device 104 includes a touch-sensitive surface (e.g., touch screen displays and/or touchpads). Further, user device 104 optionally includes one or more other physical user-interface devices, such as a physical keyboard, a mouse, and/or a joystick. Various examples of electronic devices, such as multifunctional devices, are described below in greater detail.

Examples of communication network(s) 110 include local area networks (LAN) and wide area networks (WAN), e.g., the Internet. Communication network(s) 110 is implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

Server system 108 is implemented on one or more standalone data processing apparatus or a distributed network of computers. In some examples, server system 108 also employs various virtual devices and/or services of third-party service providers (e.g., third-party cloud service providers) to provide the underlying computing resources and/or infrastructure resources of server system 108.

In some examples, user device 104 communicates with DA server 106 via second user device 122. Second user device 122 is similar or identical to user device 104. For example, second user device 122 is similar to devices 200, 400, or 600 described below with reference to FIGS. 2A, 4A, and 6A-6B. User device 104 is configured to communicatively couple to second user device 122 via a direct communication connection, such as Bluetooth, NFC, BTLE, or the like, or via a wired or wireless network, such as a local Wi-Fi network. In some examples, second user device 122 is configured to act as a proxy between user device 104 and DA server 106. For example, DA client 102 of user device 104 is configured to transmit information (e.g., a user request received at user device 104) to DA server 106 via second user device 122. DA server 106 processes the information and returns relevant data (e.g., data content responsive to the user request) to user device 104 via second user device 122.

In some examples, user device 104 is configured to communicate abbreviated requests for data to second user device 122 to reduce the amount of information transmitted from user device 104. Second user device 122 is configured to determine supplemental information to add to the abbreviated request to generate a complete request to transmit to DA server 106. This system architecture can advantageously allow user device 104 having limited communication capabilities and/or limited battery power (e.g., a watch or a similar compact electronic device) to access services provided by DA server 106 by using second user device 122, having greater communication capabilities and/or battery power (e.g., a mobile phone, laptop computer, tablet computer, or the like), as a proxy to DA server 106. While only two user devices 104 and 122 are shown in FIG. 1, it should be appreciated that system 100, in some examples, includes any number and type of user devices configured in this proxy configuration to communicate with DA server system 106.

Although the digital assistant shown in FIG. 1 includes both a client-side portion (e.g., DA client 102) and a server-side portion (e.g., DA server 106), in some examples, the functions of a digital assistant are implemented as a standalone application installed on a user device. In addition, the divisions of functionalities between the client and server portions of the digital assistant can vary in different implementations. For instance, in some examples, the DA client is a thin-client that provides only user-facing input and output processing functions, and delegates all other functionalities of the digital assistant to a backend server.

### 2. Electronic Devices

Attention is now directed toward embodiments of electronic devices for implementing the client-side portion of a digital assistant. FIG. 2A is a block diagram illustrating portable multifunction device 200 with touch-sensitive display system 212 in accordance with some embodiments. Touch-sensitive display 212 is sometimes called a “touch screen” for convenience and is sometimes known as or called a “touch-sensitive display system.” Device 200 includes memory 202 (which optionally includes one or more computer-readable storage mediums), memory controller 222, one or more processing units (CPUs) 220, peripherals interface 218, RF circuitry 208, audio circuitry 210, speaker 211, microphone 213, input/output (I/O) subsystem 206, other input control devices 216, and external port 224. Device 200 optionally includes one or more optical sensors 264. Device 200 optionally includes one or more contact intensity sensors 265 for detecting intensity of contacts on device 200 (e.g., a touch-sensitive surface such as touch-sensitive display system 212 of device 200). Device 200 optionally includes one or more tactile output generators 267 for generating tactile outputs on device 200 (e.g., generating tactile outputs on a touch-sensitive surface such as touch-sensitive display system 212 of device 200 or touchpad 455 of device 400). These components optionally communicate over one or more communication buses or signal lines 203.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 200 is only one example of a portable multifunction device, and that device 200 optionally has more or fewer components than shown, optionally combines two or more components, or optionally has a different configuration or arrangement of the components. The various components shown in FIG. 2A are implemented in hardware, software, or a combination of both hardware and software, including one or more signal processing and/or application-specific integrated circuits.

Memory 202 includes one or more computer-readable storage mediums. The computer-readable storage mediums are, for example, tangible and non-transitory. Memory 202 includes high-speed random access memory and also includes non-volatile memory, such as one or more magnetic disk storage devices, flash memory devices, or other non-volatile solid-state memory devices. Memory controller 222 controls access to memory 202 by other components of device 200.

In some examples, a non-transitory computer-readable storage medium of memory 202 is used to store instructions (e.g., for performing aspects of processes described below) for use by or in connection with an instruction execution system, apparatus, or device, such as a computer-based system, processor-containing system, or other system that can fetch the instructions from the instruction execution system, apparatus, or device and execute the instructions. In other examples, the instructions (e.g., for performing aspects of the processes described below) are stored on a non-transitory computer-readable storage medium (not shown) of the server system 108 or are divided between the non-transitory computer-readable storage medium of memory 202 and the non-transitory computer-readable storage medium of server system 108.

Peripherals interface 218 is used to couple input and output peripherals of the device to CPU 220 and memory 202. The one or more processors 220 run or execute various software programs and/or sets of instructions stored in memory 202 to perform various functions for device 200 and to process data. In some embodiments, peripherals interface 218, CPU 220, and memory controller 222 are implemented on a single chip, such as chip 204. In some other embodiments, they are implemented on separate chips.

RF (radio frequency) circuitry 208 receives and sends RF signals, also called electromagnetic signals. RF circuitry 208 converts electrical signals to/from electromagnetic signals and communicates with communications networks and other communications devices via the electromagnetic signals. RF circuitry 208 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 208 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 208 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

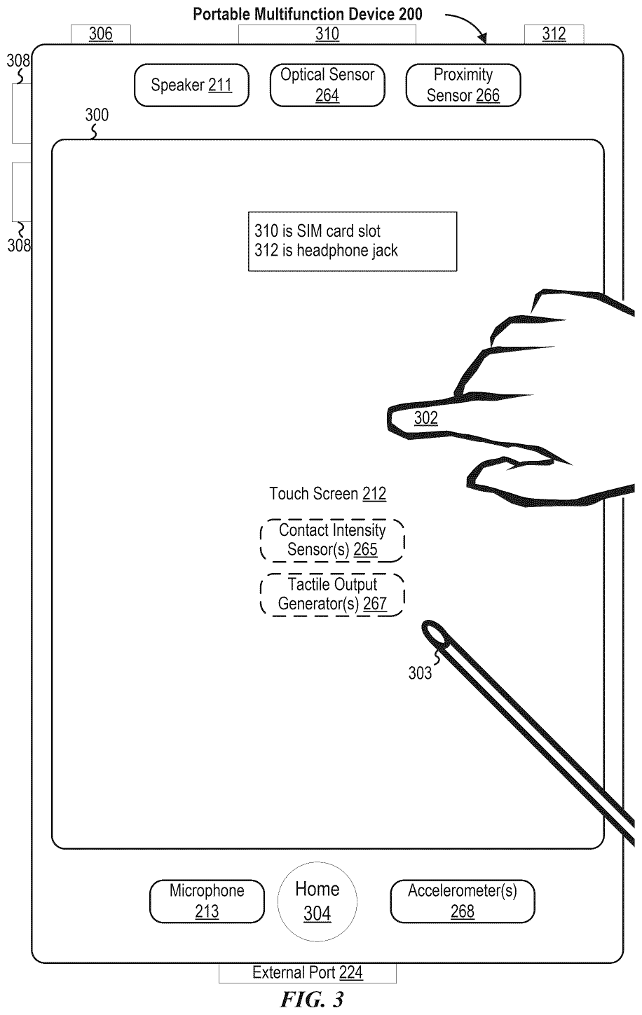

Audio circuitry 210, speaker 211, and microphone 213 provide an audio interface between a user and device 200. Audio circuitry 210 receives audio data from peripherals interface 218, converts the audio data to an electrical signal, and transmits the electrical signal to speaker 211. Speaker 211 converts the electrical signal to human-audible sound waves. Audio circuitry 210 also receives electrical signals converted by microphone 213 from sound waves. Audio circuitry 210 converts the electrical signal to audio data and transmits the audio data to peripherals interface 218 for processing. Audio data are retrieved from and/or transmitted to memory 202 and/or RF circuitry 208 by peripherals interface 218. In some embodiments, audio circuitry 210 also includes a headset jack (e.g., 312, FIG. 3). The headset jack provides an interface between audio circuitry 210 and removable audio input/output peripherals, such as output-only headphones or a headset with both output (e.g., a headphone for one or both ears) and input (e.g., a microphone).

I/O subsystem 206 couples input/output peripherals on device 200, such as touch screen 212 and other input control devices 216, to peripherals interface 218. I/O subsystem 206 optionally includes display controller 256, optical sensor controller 258, intensity sensor controller 259, haptic feedback controller 261, and one or more input controllers 260 for other input or control devices. The one or more input controllers 260 receive/send electrical signals from/to other input control devices 216. The other input control devices 216 optionally include physical buttons (e.g., push buttons, rocker buttons, etc.), dials, slider switches, joysticks, click wheels, and so forth. In some alternate embodiments, input controller(s) 260 are, optionally, coupled to any (or none) of the following: a keyboard, an infrared port, a USB port, and a pointer device such as a mouse. The one or more buttons (e.g., 308, FIG. 3) optionally include an up/down button for volume control of speaker 211 and/or microphone 213. The one or more buttons optionally include a push button (e.g., 306, FIG. 3).

A quick press of the push button disengages a lock of touch screen 212 or begin a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 306) turns power to device 200 on or off. The user is able to customize a functionality of one or more of the buttons. Touch screen 212 is used to implement virtual or soft buttons and one or more soft keyboards.

Touch-sensitive display 212 provides an input interface and an output interface between the device and a user. Display controller 256 receives and/or sends electrical signals from/to touch screen 212. Touch screen 212 displays visual output to the user. The visual output includes graphics, text, icons, video, and any combination thereof (collectively termed “graphics”). In some embodiments, some or all of the visual output correspond to user-interface objects.

Touch screen 212 has a touch-sensitive surface, sensor, or set of sensors that accepts input from the user based on haptic and/or tactile contact. Touch screen 212 and display controller 256 (along with any associated modules and/or sets of instructions in memory 202) detect contact (and any movement or breaking of the contact) on touch screen 212 and convert the detected contact into interaction with user-interface objects (e.g., one or more soft keys, icons, web pages, or images) that are displayed on touch screen 212. In an exemplary embodiment, a point of contact between touch screen 212 and the user corresponds to a finger of the user.

Touch screen 212 uses LCD (liquid crystal display) technology, LPD (light emitting polymer display) technology, or LED (light emitting diode) technology, although other display technologies may be used in other embodiments. Touch screen 212 and display controller 256 detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 212. In an exemplary embodiment, projected mutual capacitance sensing technology is used, such as that found in the iPhone® and iPod Touch® from Apple Inc. of Cupertino, California.

A touch-sensitive display in some embodiments of touch screen 212 is analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 212 displays visual output from device 200, whereas touch-sensitive touchpads do not provide visual output.

A touch-sensitive display in some embodiments of touch screen 212 is as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 212 has, for example, a video resolution in excess of 100 dpi. In some embodiments, the touch screen has a video resolution of approximately 160 dpi. The user makes contact with touch screen 212 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 200 includes a touchpad (not shown) for activating or deactivating particular functions. In some embodiments, the touchpad is a touch-sensitive area of the device that, unlike the touch screen, does not display visual output. The touchpad is a touch-sensitive surface that is separate from touch screen 212 or an extension of the touch-sensitive surface formed by the touch screen.

Device 200 also includes power system 262 for powering the various components. Power system 262 includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 200 also includes one or more optical sensors 264. FIG. 2A shows an optical sensor coupled to optical sensor controller 258 in I/O subsystem 206. Optical sensor 264 includes charge-coupled device (CCD) or complementary metal-oxide semiconductor (CMOS) phototransistors. Optical sensor 264 receives light from the environment, projected through one or more lenses, and converts the light to data representing an image. In conjunction with imaging module 243 (also called a camera module), optical sensor 264 captures still images or video. In some embodiments, an optical sensor is located on the back of device 200, opposite touch screen display 212 on the front of the device so that the touch screen display is used as a viewfinder for still and/or video image acquisition. In some embodiments, an optical sensor is located on the front of the device so that the user's image is obtained for video conferencing while the user views the other video conference participants on the touch screen display. In some embodiments, the position of optical sensor 264 can be changed by the user (e.g., by rotating the lens and the sensor in the device housing) so that a single optical sensor 264 is used along with the touch screen display for both video conferencing and still and/or video image acquisition.

Device 200 optionally also includes one or more contact intensity sensors 265. FIG. 2A shows a contact intensity sensor coupled to intensity sensor controller 259 in I/O subsystem 206. Contact intensity sensor 265 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 265 receives contact intensity information (e.g., pressure information or a proxy for pressure information) from the environment. In some embodiments, at least one contact intensity sensor is collocated with, or proximate to, a touch-sensitive surface (e.g., touch-sensitive display system 212). In some embodiments, at least one contact intensity sensor is located on the back of device 200, opposite touch screen display 212, which is located on the front of device 200.

Device 200 also includes one or more proximity sensors 266. FIG. 2A shows proximity sensor 266 coupled to peripherals interface 218. Alternately, proximity sensor 266 is coupled to input controller 260 in I/O subsystem 206. Proximity sensor 266 is performed as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 212 when the multifunction device is placed near the user's ear (e.g., when the user is making a phone call).

Device 200 optionally also includes one or more tactile output generators 267. FIG. 2A shows a tactile output generator coupled to haptic feedback controller 261 in I/O subsystem 206. Tactile output generator 267 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 265 receives tactile feedback generation instructions from haptic feedback module 233 and generates tactile outputs on device 200 that are capable of being sensed by a user of device 200. In some embodiments, at least one tactile output generator is collocated with, or proximate to, a touch-sensitive surface (e.g., touch-sensitive display system 212) and, optionally, generates a tactile output by moving the touch-sensitive surface vertically (e.g., in/out of a surface of device 200) or laterally (e.g., back and forth in the same plane as a surface of device 200). In some embodiments, at least one tactile output generator sensor is located on the back of device 200, opposite touch screen display 212, which is located on the front of device 200.

Device 200 also includes one or more accelerometers 268. FIG. 2A shows accelerometer 268 coupled to peripherals interface 218. Alternately, accelerometer 268 is coupled to an input controller 260 in I/O subsystem 206. Accelerometer 268 performs, for example, as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 200 optionally includes, in addition to accelerometer(s) 268, a magnetometer (not shown) and a GPS (or GLONASS or other global navigation system) receiver (not shown) for obtaining information concerning the location and orientation (e.g., portrait or landscape) of device 200.

In some embodiments, the software components stored in memory 202 include operating system 226, communication module (or set of instructions) 228, contact/motion module (or set of instructions) 230, graphics module (or set of instructions) 232, text input module (or set of instructions) 234, Global Positioning System (GPS) module (or set of instructions) 235, Digital Assistant Client Module 229, and applications (or sets of instructions) 236. Further, memory 202 stores data and models, such as user data and models 231. Furthermore, in some embodiments, memory 202 (FIG. 2A) or 470 (FIG. 4A) stores device/global internal state 257, as shown in FIGS. 2A and 4A. Device/global internal state 257 includes one or more of: active application state, indicating which applications, if any, are currently active; display state, indicating what applications, views or other information occupy various regions of touch screen display 212; sensor state, including information obtained from the device's various sensors and input control devices 216; and location information concerning the device's location and/or attitude.

Operating system 226 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 228 facilitates communication with other devices over one or more external ports 224 and also includes various software components for handling data received by RF circuitry 208 and/or external port 224. External port 224 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 230 optionally detects contact with touch screen 212 (in conjunction with display controller 256) and other touch-sensitive devices (e.g., a touchpad or physical click wheel). Contact/motion module 230 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 230 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 230 and display controller 256 detect contact on a touchpad.

In some embodiments, contact/motion module 230 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 200). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 230 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 232 includes various known software components for rendering and displaying graphics on touch screen 212 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 232 stores data representing graphics to be used. Each graphic is, optionally, assigned a corresponding code. Graphics module 232 receives, from applications etc., one or more codes specifying graphics to be displayed along with, if necessary, coordinate data and other graphic property data, and then generates screen image data to output to display controller 256.

Haptic feedback module 233 includes various software components for generating instructions used by tactile output generator(s) 267 to produce tactile outputs at one or more locations on device 200 in response to user interactions with device 200.

Text input module 234, which is, in some examples, a component of graphics module 232, provides soft keyboards for entering text in various applications (e.g., contacts module 237, e-mail client module 240, instant messaging (IM) module 241, browser module 247, and any other application that needs text input).

GPS module 235 determines the location of the device and provides this information for use in various applications (e.g., to telephone module 238 for use in location-based dialing; to camera module 243 as picture/video metadata; and to applications that provide location-based services such as weather widgets, local yellow page widgets, and map/navigation widgets).

Digital assistant client module 229 includes various client-side digital assistant instructions to provide the client-side functionalities of the digital assistant. For example, digital assistant client module 229 is capable of accepting voice input (e.g., speech input), text input, touch input, and/or gestural input through various user interfaces (e.g., microphone 213, accelerometer(s) 268, touch-sensitive display system 212, optical sensor(s) 264, other input control devices 216, etc.) of portable multifunction device 200. Digital assistant client module 229 is also capable of providing output in audio (e.g., speech output), visual, and/or tactile forms through various output interfaces (e.g., speaker 211, touch-sensitive display system 212, tactile output generator(s) 267, etc.) of portable multifunction device 200. For example, output is provided as voice, sound, alerts, text messages, menus, graphics, videos, animations, vibrations, and/or combinations of two or more of the above. During operation, digital assistant client module 229 communicates with DA server 106 using RF circuitry 208.

User data and models 231 include various data associated with the user (e.g., user-specific vocabulary data, user preference data, user-specified name pronunciations, data from the user's electronic address book, to-do lists, shopping lists, etc.) to provide the client-side functionalities of the digital assistant. Further, user data and models 231 include various models (e.g., speech recognition models, statistical language models, natural language processing models, ontology, task flow models, service models, etc.) for processing user input and determining user intent.

In some examples, digital assistant client module 229 utilizes the various sensors, subsystems, and peripheral devices of portable multifunction device 200 to gather additional information from the surrounding environment of the portable multifunction device 200 to establish a context associated with a user, the current user interaction, and/or the current user input. In some examples, digital assistant client module 229 provides the contextual information or a subset thereof with the user input to DA server 106 to help infer the user's intent. In some examples, the digital assistant also uses the contextual information to determine how to prepare and deliver outputs to the user. Contextual information is referred to as context data.

In some examples, the contextual information that accompanies the user input includes sensor information, e.g., lighting, ambient noise, ambient temperature, images or videos of the surrounding environment, etc. In some examples, the contextual information can also include the physical state of the device, e.g., device orientation, device location, device temperature, power level, speed, acceleration, motion patterns, cellular signals strength, etc. In some examples, information related to the software state of DA server 106, e.g., running processes, installed programs, past and present network activities, background services, error logs, resources usage, etc., and of portable multifunction device 200 is provided to DA server 106 as contextual information associated with a user input.

In some examples, the digital assistant client module 229 selectively provides information (e.g., user data 231) stored on the portable multifunction device 200 in response to requests from DA server 106. In some examples, digital assistant client module 229 also elicits additional input from the user via a natural language dialogue or other user interfaces upon request by DA server 106. Digital assistant client module 229 passes the additional input to DA server 106 to help DA server 106 in intent deduction and/or fulfillment of the user's intent expressed in the user request.

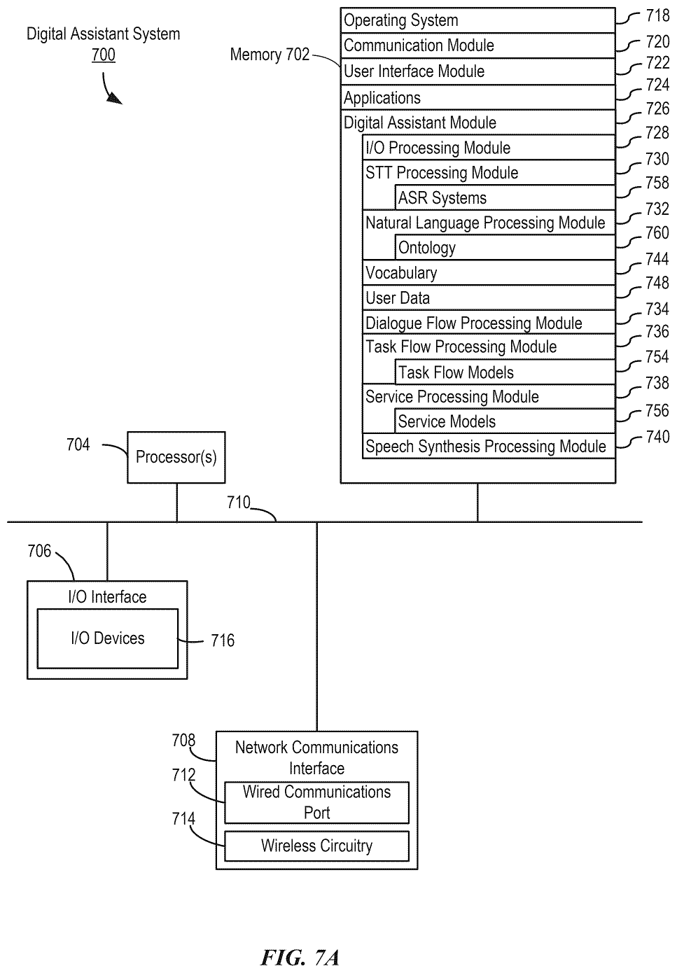

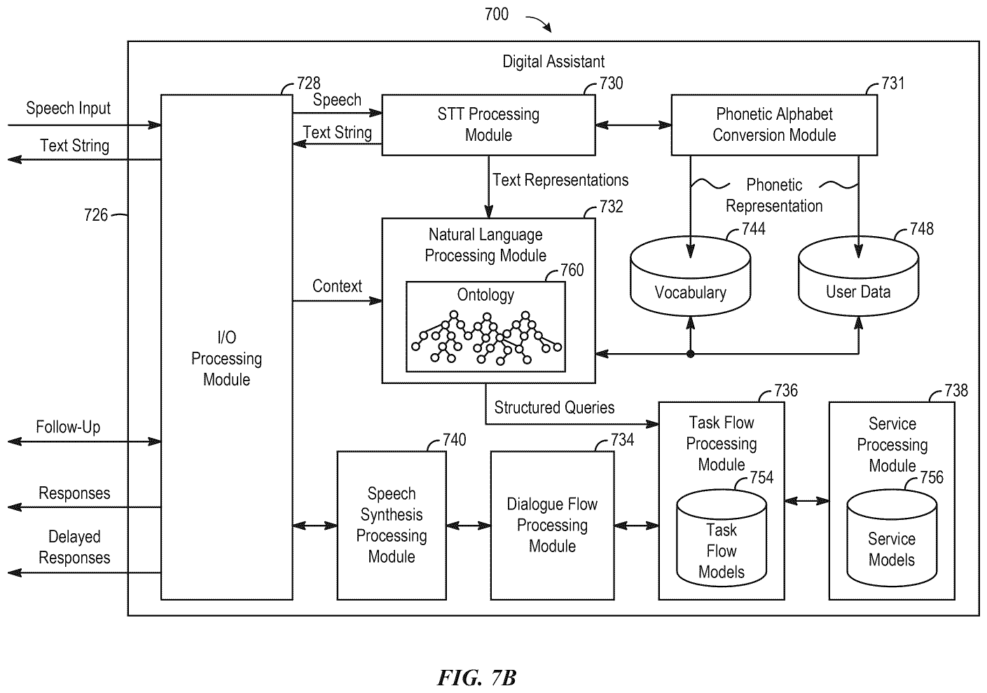

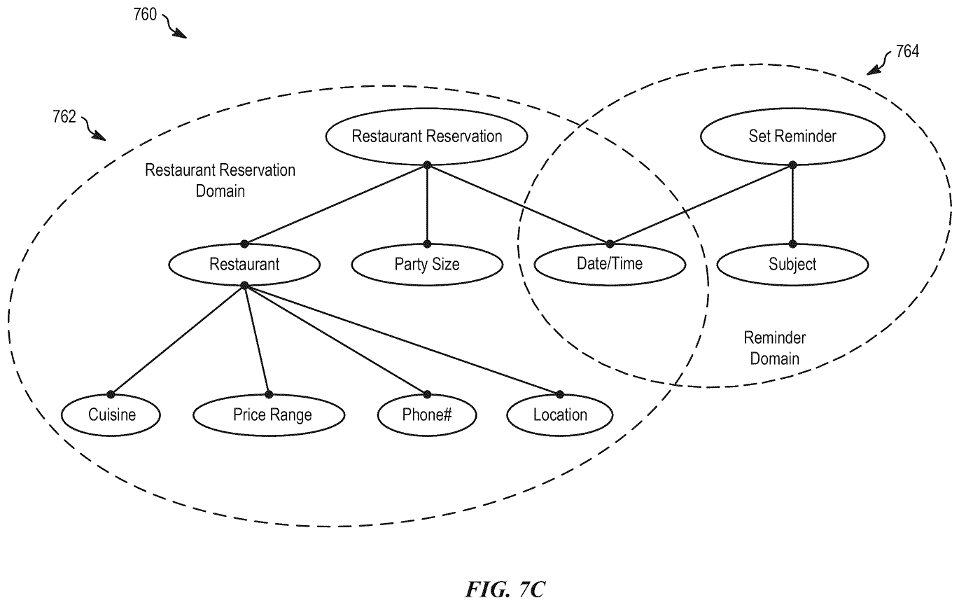

A more detailed description of a digital assistant is described below with reference to FIGS. 7A-7C. It should be recognized that digital assistant client module 229 can include any number of the sub-modules of digital assistant module 726 described below.

Applications 236 include the following modules (or sets of instructions), or a subset or superset thereof:
Contacts module 237 (sometimes called an address book or contact list);
Telephone module 238;
Video conference module 239;
E-mail client module 240;
Instant messaging (IM) module 241;
Workout support module 242;
Camera module 243 for still and/or video images;
Image management module 244;
Video player module;
Music player module;
Browser module 247;
Calendar module 248;
Widget modules 249, which includes, in some examples, one or more of: weather widget 249-1, stocks widget 249-2, calculator widget 249-3, alarm clock widget 249-4, dictionary widget 249-5, and other widgets obtained by the user, as well as user-created widgets 249-6;
Widget creator module 250 for making user-created widgets 249-6;
Search module 251;
Video and music player module 252, which merges video player module and music player module;
Notes module 253;
Map module 254; and/or
Online video module 255.

Examples of other applications 236 that are stored in memory 202 include other word processing applications, other image editing applications, drawing applications, presentation applications, JAVA-enabled applications, encryption, digital rights management, voice recognition, and voice replication.

In conjunction with touch screen 212, display controller 256, contact/motion module 230, graphics module 232, and text input module 234, contacts module 237 are used to manage an address book or contact list (e.g., stored in application internal state 292 of contacts module 237 in memory 202 or memory 470), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 238, video conference module 239, e-mail client module 240, or IM module 241; and so forth.

In conjunction with RF circuitry 208, audio circuitry 210, speaker 211, microphone 213, touch screen 212, display controller 256, contact/motion module 230, graphics module 232, and text input module 234, telephone module 238 are used to enter a sequence of characters corresponding to a telephone number, access one or more telephone numbers in contacts module 237, modify a telephone number that has been entered, dial a respective telephone number, conduct a conversation, and disconnect or hang up when the conversation is completed. As noted above, the wireless communication uses any of a plurality of communications standards, protocols, and technologies.

In conjunction with RF circuitry 208, audio circuitry 210, speaker 211, microphone 213, touch screen 212, display controller 256, optical sensor 264, optical sensor controller 258, contact/motion module 230, graphics module 232, text input module 234, contacts module 237, and telephone module 238, video conference module 239 includes executable instructions to initiate, conduct, and terminate a video conference between a user and one or more other participants in accordance with user instructions.

In conjunction with RF circuitry 208, touch screen 212, display controller 256, contact/motion module 230, graphics module 232, and text input module 234, e-mail client module 240 includes executable instructions to create, send, receive, and manage e-mail in response to user instructions. In conjunction with image management module 244, e-mail client module 240 makes it very easy to create and send e-mails with still or video images taken with camera module 243.

In conjunction with RF circuitry 208, touch screen 212, display controller 256, contact/motion module 230, graphics module 232, and text input module 234, the instant messaging module 241 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 208, touch screen 212, display controller 256, contact/motion module 230, graphics module 232, text input module 234, GPS module 235, map module 254, and music player module, workout support module 242 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 212, display controller 256, optical sensor(s) 264, optical sensor controller 258, contact/motion module 230, graphics module 232, and image management module 244, camera module 243 includes executable instructions to capture still images or video (including a video stream) and store them into memory 202, modify characteristics of a still image or video, or delete a still image or video from memory 202.

In conjunction with touch screen 212, display controller 256, contact/motion module 230, graphics module 232, text input module 234, and camera module 243, image management module 244 includes executable instructions to arrange, modify (e.g., edit), or otherwise manipulate, label, delete, present (e.g., in a digital slide show or album), and store still and/or video images.

In conjunction with RF circuitry 208, touch screen 212, display controller 256, contact/motion module 230, graphics module 232, and text input module 234, browser module 247 includes executable instructions to browse the Internet in accordance with user instructions, including searching, linking to, receiving, and displaying web pages or portions thereof, as well as attachments and other files linked to web pages.

In conjunction with RF circuitry 208, touch screen 212, display controller 256, contact/motion module 230, graphics module 232, text input module 234, e-mail client module 240, and browser module 247, calendar module 248 includes executable instructions to create, display, modify, and store calendars and data associated with calendars (e.g., calendar entries, to-do lists, etc.) in accordance with user instructions.

In conjunction with RF circuitry 208, touch screen 212, display controller 256, contact/motion module 230, graphics module 232, text input module 234, and browser module 247, widget modules 249 are mini-applications that can be downloaded and used by a user (e.g., weather widget 249-1, stocks widget 249-2, calculator widget 249-3, alarm clock widget 249-4, and dictionary widget 249-5) or created by the user (e.g., user-created widget 249-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 208, touch screen 212, display controller 256, contact/motion module 230, graphics module 232, text input module 234, and browser module 247, the widget creator module 250 are used by a user to create widgets (e.g., turning a user-specified portion of a web page into a widget).

In conjunction with touch screen 212, display controller 256, contact/motion module 230, graphics module 232, and text input module 234, search module 251 includes executable instructions to search for text, music, sound, image, video, and/or other files in memory 202 that match one or more search criteria (e.g., one or more user-specified search terms) in accordance with user instructions.

In conjunction with touch screen 212, display controller 256, contact/motion module 230, graphics module 232, audio circuitry 210, speaker 211, RF circuitry 208, and browser module 247, video and music player module 252 includes executable instructions that allow the user to download and play back recorded music and other sound files stored in one or more file formats, such as MP3 or AAC files, and executable instructions to display, present, or otherwise play back videos (e.g., on touch screen 212 or on an external, connected display via external port 224). In some embodiments, device 200 optionally includes the functionality of an MP3 player, such as an iPod (trademark of Apple Inc.).

In conjunction with touch screen 212, display controller 256, contact/motion module 230, graphics module 232, and text input module 234, notes module 253 includes executable instructions to create and manage notes, to-do lists, and the like in accordance with user instructions.

In conjunction with RF circuitry 208, touch screen 212, display controller 256, contact/motion module 230, graphics module 232, text input module 234, GPS module 235, and browser module 247, map module 254 are used to receive, display, modify, and store maps and data associated with maps (e.g., driving directions, data on stores and other points of interest at or near a particular location, and other location-based data) in accordance with user instructions.

In conjunction with touch screen 212, display controller 256, contact/motion module 230, graphics module 232, audio circuitry 210, speaker 211, RF circuitry 208, text input module 234, e-mail client module 240, and browser module 247, online video module 255 includes instructions that allow the user to access, browse, receive (e.g., by streaming and/or download), play back (e.g., on the touch screen or on an external, connected display via external port 224), send an e-mail with a link to a particular online video, and otherwise manage online videos in one or more file formats, such as H.264. In some embodiments, instant messaging module 241, rather than e-mail client module 240, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules can be combined or otherwise rearranged in various embodiments. For example, video player module can be combined with music player module into a single module (e.g., video and music player module 252, FIG. 2A). In some embodiments, memory 202 stores a subset of the modules and data structures identified above. Furthermore, memory 202 stores additional modules and data structures not described above.

In some embodiments, device 200 is a device where operation of a predefined set of functions on the device is performed exclusively through a touch screen and/or a touchpad. By using a touch screen and/or a touchpad as the primary input control device for operation of device 200, the number of physical input control devices (such as push buttons, dials, and the like) on device 200 is reduced.

The predefined set of functions that are performed exclusively through a touch screen and/or a touchpad optionally include navigation between user interfaces. In some embodiments, the touchpad, when touched by the user, navigates device 200 to a main, home, or root menu from any user interface that is displayed on device 200. In such embodiments, a “menu button” is implemented using a touchpad. In some other embodiments, the menu button is a physical push button or other physical input control device instead of a touchpad.

FIG. 2B is a block diagram illustrating exemplary components for event handling in accordance with some embodiments. In some embodiments, memory 202 (FIG. 2A) or 470 (FIG. 4A) includes event sorter 270 (e.g., in operating system 226) and a respective application 236-1 (e.g., any of the aforementioned applications 237-251, 255, 480-490).

Event sorter 270 receives event information and determines the application 236-1 and application view 291 of application 236-1 to which to deliver the event information. Event sorter 270 includes event monitor 271 and event dispatcher module 274. In some embodiments, application 236-1 includes application internal state 292, which indicates the current application view(s) displayed on touch-sensitive display 212 when the application is active or executing. In some embodiments, device/global internal state 257 is used by event sorter 270 to determine which application(s) is (are) currently active, and application internal state 292 is used by event sorter 270 to determine application views 291 to which to deliver event information.

In some embodiments, application internal state 292 includes additional information, such as one or more of: resume information to be used when application 236-1 resumes execution, user interface state information that indicates information being displayed or that is ready for display by application 236-1, a state queue for enabling the user to go back to a prior state or view of application 236-1, and a redo/undo queue of previous actions taken by the user.

Event monitor 271 receives event information from peripherals interface 218. Event information includes information about a sub-event (e.g., a user touch on touch-sensitive display 212, as part of a multi-touch gesture). Peripherals interface 218 transmits information it receives from I/O subsystem 206 or a sensor, such as proximity sensor 266, accelerometer(s) 268, and/or microphone 213 (through audio circuitry 210). Information that peripherals interface 218 receives from I/O subsystem 206 includes information from touch-sensitive display 212 or a touch-sensitive surface.

In some embodiments, event monitor 271 sends requests to the peripherals interface 218 at predetermined intervals. In response, peripherals interface 218 transmits event information. In other embodiments, peripherals interface 218 transmits event information only when there is a significant event (e.g., receiving an input above a predetermined noise threshold and/or for more than a predetermined duration).

In some embodiments, event sorter 270 also includes a hit view determination module 272 and/or an active event recognizer determination module 273.

Hit view determination module 272 provides software procedures for determining where a sub-event has taken place within one or more views when touch-sensitive display 212 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected correspond to programmatic levels within a programmatic or view hierarchy of the application. For example, the lowest level view in which a touch is detected is called the hit view, and the set of events that are recognized as proper inputs is determined based, at least in part, on the hit view of the initial touch that begins a touch-based gesture.

Hit view determination module 272 receives information related to sub events of a touch-based gesture. When an application has multiple views organized in a hierarchy, hit view determination module 272 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 272, the hit view typically receives all sub-events related to the same touch or input source for which it was identified as the hit view.

Active event recognizer determination module 273 determines which view or views within a view hierarchy should receive a particular sequence of sub-events. In some embodiments, active event recognizer determination module 273 determines that only the hit view should receive a particular sequence of sub-events. In other embodiments, active event recognizer determination module 273 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 274 dispatches the event information to an event recognizer (e.g., event recognizer 280). In embodiments including active event recognizer determination module 273, event dispatcher module 274 delivers the event information to an event recognizer determined by active event recognizer determination module 273. In some embodiments, event dispatcher module 274 stores in an event queue the event information, which is retrieved by a respective event receiver 282.

In some embodiments, operating system 226 includes event sorter 270. Alternatively, application 236-1 includes event sorter 270. In yet other embodiments, event sorter 270 is a stand-alone module, or a part of another module stored in memory 202, such as contact/motion module 230.

In some embodiments, application 236-1 includes a plurality of event handlers 290 and one or more application views 291, each of which includes instructions for handling touch events that occur within a respective view of the application's user interface. Each application view 291 of the application 236-1 includes one or more event recognizers 280. Typically, a respective application view 291 includes a plurality of event recognizers 280. In other embodiments, one or more of event recognizers 280 are part of a separate module, such as a user interface kit (not shown) or a higher level object from which application 236-1 inherits methods and other properties. In some embodiments, a respective event handler 290 includes one or more of: data updater 276, object updater 277, GUI updater 278, and/or event data 279 received from event sorter 270. Event handler 290 utilizes or calls data updater 276, object updater 277, or GUI updater 278 to update the application internal state 292. Alternatively, one or more of the application views 291 include one or more respective event handlers 290. Also, in some embodiments, one or more of data updater 276, object updater 277, and GUI updater 278 are included in a respective application view 291.

A respective event recognizer 280 receives event information (e.g., event data 279) from event sorter 270 and identifies an event from the event information. Event recognizer 280 includes event receiver 282 and event comparator 284. In some embodiments, event recognizer 280 also includes at least a subset of: metadata 283, and event delivery instructions 288 (which include sub-event delivery instructions).

Event receiver 282 receives event information from event sorter 270. The event information includes information about a sub-event, for example, a touch or a touch movement. Depending on the sub-event, the event information also includes additional information, such as location of the sub-event. When the sub-event concerns motion of a touch, the event information also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 284 compares the event information to predefined event or sub-event definitions and, based on the comparison, determines an event or sub event, or determines or updates the state of an event or sub-event. In some embodiments, event comparator 284 includes event definitions 286. Event definitions 286 contain definitions of events (e.g., predefined sequences of sub-events), for example, event 1 (287-1), event 2 (287-2), and others. In some embodiments, sub-events in an event (287) include, for example, touch begin, touch end, touch movement, touch cancellation, and multiple touching. In one example, the definition for event 1 (287-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (287-2) is a dragging on a displayed object. The dragging, for example, comprises a touch (or contact) on the displayed object for a predetermined phase, a movement of the touch across touch-sensitive display 212, and liftoff of the touch (touch end). In some embodiments, the event also includes information for one or more associated event handlers 290.

In some embodiments, event definition 287 includes a definition of an event for a respective user-interface object. In some embodiments, event comparator 284 performs a hit test to determine which user-interface object is associated with a sub-event. For example, in an application view in which three user-interface objects are displayed on touch-sensitive display 212, when a touch is detected on touch-sensitive display 212, event comparator 284 performs a hit test to determine which of the three user-interface objects is associated with the touch (sub-event). If each displayed object is associated with a respective event handler 290, the event comparator uses the result of the hit test to determine which event handler 290 should be activated. For example, event comparator 284 selects an event handler associated with the sub-event and the object triggering the hit test.

In some embodiments, the definition for a respective event (287) also includes delayed actions that delay delivery of the event information until after it has been determined whether the sequence of sub-events does or does not correspond to the event recognizer's event type.

When a respective event recognizer 280 determines that the series of sub-events do not match any of the events in event definitions 286, the respective event recognizer 280 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 280 includes metadata 283 with configurable properties, flags, and/or lists that indicate how the event delivery system should perform sub-event delivery to actively involved event recognizers. In some embodiments, metadata 283 includes configurable properties, flags, and/or lists that indicate how event recognizers interact, or are enabled to interact, with one another. In some embodiments, metadata 283 includes configurable properties, flags, and/or lists that indicate whether sub-events are delivered to varying levels in the view or programmatic hierarchy.

In some embodiments, a respective event recognizer 280 activates event handler 290 associated with an event when one or more particular sub-events of an event are recognized. In some embodiments, a respective event recognizer 280 delivers event information associated with the event to event handler 290. Activating an event handler 290 is distinct from sending (and deferred sending) sub-events to a respective hit view. In some embodiments, event recognizer 280 throws a flag associated with the recognized event, and event handler 290 associated with the flag catches the flag and performs a predefined process.

In some embodiments, event delivery instructions 288 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 276 creates and updates data used in application 236-1. For example, data updater 276 updates the telephone number used in contacts module 237, or stores a video file used in video player module. In some embodiments, object updater 277 creates and updates objects used in application 236-1. For example, object updater 277 creates a new user-interface object or updates the position of a user-interface object. GUI updater 278 updates the GUI. For example, GUI updater 278 prepares display information and sends it to graphics module 232 for display on a touch-sensitive display.

In some embodiments, event handler(s) 290 includes or has access to data updater 276, object updater 277, and GUI updater 278. In some embodiments, data updater 276, object updater 277, and GUI updater 278 are included in a single module of a respective application 236-1 or application view 291. In other embodiments, they are included in two or more software modules.

It shall be understood that the foregoing discussion regarding event handling of user touches on touch-sensitive displays also applies to other forms of user inputs to operate multifunction devices 200 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 3 illustrates a portable multifunction device 200 having a touch screen 212 in accordance with some embodiments. The touch screen optionally displays one or more graphics within user interface (UI) 300. In this embodiment, as well as others described below, a user is enabled to select one or more of the graphics by making a gesture on the graphics, for example, with one or more fingers 302 (not drawn to scale in the figure) or one or more styluses 303 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 200. In some implementations or circumstances, inadvertent contact with a graphic does not select the graphic. For example, a swipe gesture that sweeps over an application icon optionally does not select the corresponding application when the gesture corresponding to selection is a tap.

Device 200 also includes one or more physical buttons, such as “home” or menu button 304. As described previously, menu button 304 is used to navigate to any application 236 in a set of applications that is executed on device 200. Alternatively, in some embodiments, the menu button is implemented as a soft key in a GUI displayed on touch screen 212.

In one embodiment, device 200 includes touch screen 212, menu button 304, push button 306 for powering the device on/off and locking the device, volume adjustment button(s) 308, subscriber identity module (SIM) card slot 310, headset jack 312, and docking/charging external port 224. Push button 306 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 200 also accepts verbal input for activation or deactivation of some functions through microphone 213. Device 200 also, optionally, includes one or more contact intensity sensors 265 for detecting intensity of contacts on touch screen 212 and/or one or more tactile output generators 267 for generating tactile outputs for a user of device 200.

FIG. 4A is a block diagram of an exemplary multifunction device with a display and a touch-sensitive surface in accordance with some embodiments. Device 400 need not be portable. In some embodiments, device 400 is a laptop computer, a desktop computer, a tablet computer, a multimedia player device, a navigation device, an educational device (such as a child's learning toy), a gaming system, or a control device (e.g., a home or industrial controller). Device 400 typically includes one or more processing units (CPUs) 410, one or more network or other communications interfaces 460, memory 470, and one or more communication buses 420 for interconnecting these components. Communication buses 420 optionally include circuitry (sometimes called a chipset) that interconnects and controls communications between system components. Device 400 includes input/output (I/O) interface 430 comprising display 440, which is typically a touch screen display. I/O interface 430 also optionally includes a keyboard and/or mouse (or other pointing device) 450 and touchpad 455, tactile output generator 457 for generating tactile outputs on device 400 (e.g., similar to tactile output generator(s) 267 described above with reference to FIG. 2A), sensors 459 (e.g., optical, acceleration, proximity, touch-sensitive, and/or contact intensity sensors similar to contact intensity sensor(s) 265 described above with reference to FIG. 2A). Memory 470 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 470 optionally includes one or more storage devices remotely located from CPU(s) 410. In some embodiments, memory 470 stores programs, modules, and data structures analogous to the programs, modules, and data structures stored in memory 202 of portable multifunction device 200 (FIG. 2A), or a subset thereof. Furthermore, memory 470 optionally stores additional programs, modules, and data structures not present in memory 202 of portable multifunction device 200. For example, memory 470 of device 400 optionally stores drawing module 480, presentation module 482, word processing module 484, website creation module 486, disk authoring module 488, and/or spreadsheet module 490, while memory 202 of portable multifunction device 200 (FIG. 2A) optionally does not store these modules.

Each of the above-identified elements in FIG. 4A is, in some examples, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are combined or otherwise rearranged in various embodiments. In some embodiments, memory 470 stores a subset of the modules and data structures identified above. Furthermore, memory 470 stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 4B, the method of FIG. 4C, and/or one or more other processes and/or methods described herein.

It should be recognized that application 3160 (shown in FIG. 4D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 4B and FIG. 4F application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 4E) is an operating system hosted on device 3150. In some embodiments, the system (e.g., 3110 shown in FIG. 4E) is an external device (e.g., a server, a peripheral device, an accessory, and/or a personal computing device) that includes an operating system.

Referring to FIG. 4C and FIG. 4G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 4B and/or the method of FIG. 4C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 4B and/or the method of FIG. 4C by calling an application programming interface (API) (e.g., API 3190) provided by system 3110. In some embodiments, application 3160 performs at least a portion of the method of FIG. 4B and/or the method of FIG. 4C without calling API 3190.

In some embodiments, one or more steps of the method of FIG. 4B and/or the method of FIG. 4C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 4D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 4D, device 3150 includes application 3160 and an operating system (e.g., system 3110 shown in FIG. 4E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 4D and 4E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 4E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

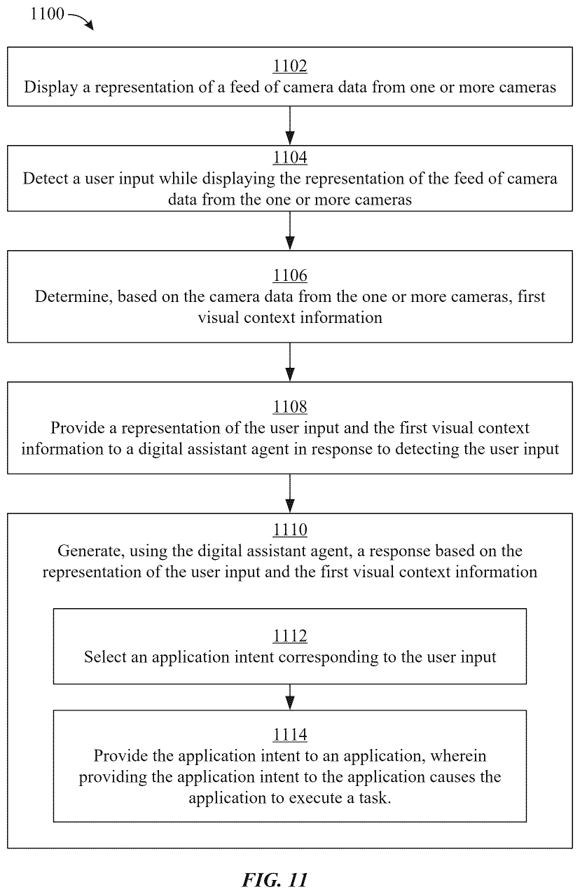

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform processes 1100, 1200, 1300, and/or 1400 (FIGS. 11, 12, 13, and/or 14) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that can be implemented on, for example, portable multifunction device 200.

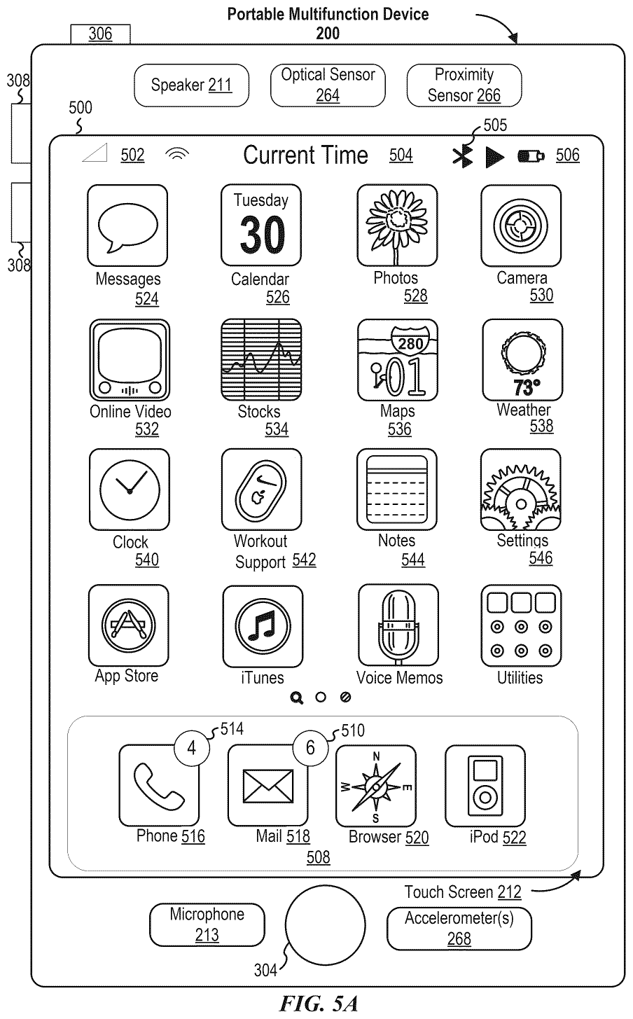

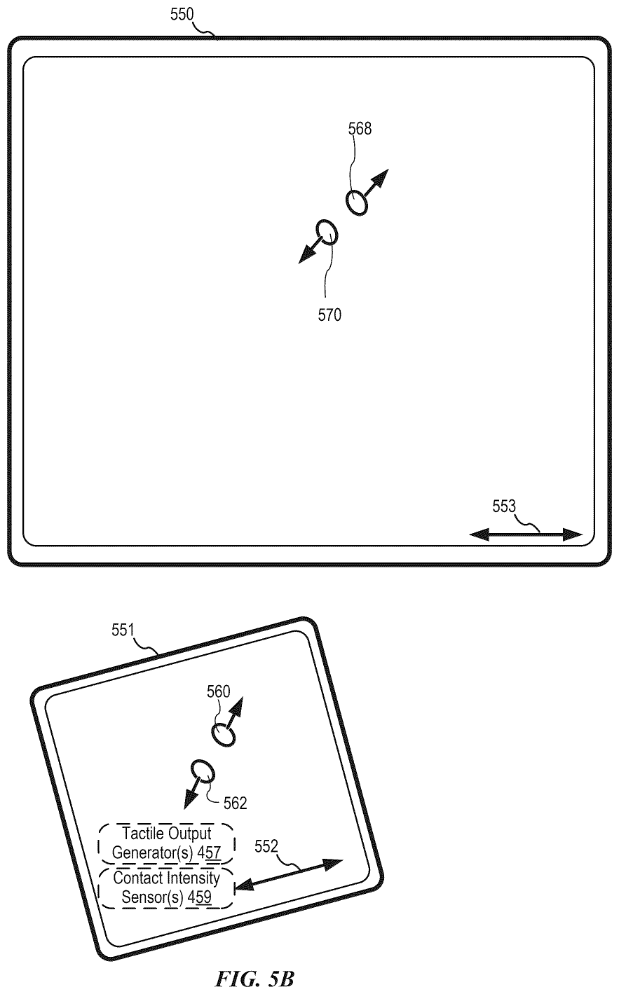

FIG. 5A illustrates an exemplary user interface for a menu of applications on portable multifunction device 200 in accordance with some embodiments. Similar user interfaces are implemented on device 400. In some embodiments, user interface 500 includes the following elements, or a subset or superset thereof:

Signal strength indicator(s) 502 for wireless communication(s), such as cellular and Wi-Fi signals;
Time 504;
Bluetooth indicator 505;
Battery status indicator 506;
Tray 508 with icons for frequently used applications, such as:
   Icon 516 for telephone module 238, labeled “Phone,” which optionally includes an indicator 514 of the number of missed calls or voicemail messages;
   Icon 518 for e-mail client module 240, labeled “Mail,” which optionally includes an indicator 510 of the number of unread e-mails;
   Icon 520 for browser module 247, labeled “Browser;” and
   Icon 522 for video and music player module 252, also referred to as iPod (trademark of Apple Inc.) module 252, labeled “iPod;” and
Icons for other applications, such as:
   Icon 524 for IM module 241, labeled “Messages;”
   Icon 526 for calendar module 248, labeled “Calendar;”
   Icon 528 for image management module 244, labeled “Photos;”
   Icon 530 for camera module 243, labeled “Camera;”
   Icon 532 for online video module 255, labeled “Online Video;”
   Icon 534 for stocks widget 249-2, labeled “Stocks;”
   Icon 536 for map module 254, labeled “Maps;”
   Icon 538 for weather widget 249-1, labeled “Weather;”
   Icon 540 for alarm clock widget 249-4, labeled “Clock;”
   Icon 542 for workout support module 242, labeled “Workout Support;”
   Icon 544 for notes module 253, labeled “Notes;” and
   Icon 546 for a settings application or module, labeled “Settings,” which provides access to settings for device 200 and its various applications 236.

It should be noted that the icon labels illustrated in FIG. 5A are merely exemplary. For example, icon 522 for video and music player module 252 is optionally labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 5B illustrates an exemplary user interface on a device (e.g., device 400, FIG. 4A) with a touch-sensitive surface 551 (e.g., a tablet or touchpad 455, FIG. 4A) that is separate from the display 550 (e.g., touch screen display 212). Device 400 also, optionally, includes one or more contact intensity sensors (e.g., one or more of sensors 459) for detecting intensity of contacts on touch-sensitive surface 551 and/or one or more tactile output generators 457 for generating tactile outputs for a user of device 400.

Although some of the examples which follow will be given with reference to inputs on touch screen display 212 (where the touch-sensitive surface and the display are combined), in some embodiments, the device detects inputs on a touch-sensitive surface that is separate from the display, as shown in FIG. 5B. In some embodiments, the touch-sensitive surface (e.g., 551 in FIG. 5B) has a primary axis (e.g., 552 in FIG. 5B) that corresponds to a primary axis (e.g., 553 in FIG. 5B) on the display (e.g., 550). In accordance with these embodiments, the device detects contacts (e.g., 560 and 562 in FIG. 5B) with the touch-sensitive surface 551 at locations that correspond to respective locations on the display (e.g., in FIG. 5B, 560 corresponds to 568 and 562 corresponds to 570). In this way, user inputs (e.g., contacts 560 and 562, and movements thereof) detected by the device on the touch-sensitive surface (e.g., 551 in FIG. 5B) are used by the device to manipulate the user interface on the display (e.g., 550 in FIG. 5B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 6A illustrates exemplary personal electronic device 600. Device 600 includes body 602. In some embodiments, device 600 includes some or all of the features described with respect to devices 200 and 400 (e.g., FIGS. 2A-2B, 3, and 4A). In some embodiments, device 600 has touch-sensitive display screen 604, hereafter touch screen 604. Alternatively, or in addition to touch screen 604, device 600 has a display and a touch-sensitive surface. As with devices 200 and 400, in some embodiments, touch screen 604 (or the touch-sensitive surface) has one or more intensity sensors for detecting intensity of contacts (e.g., touches) being applied. The one or more intensity sensors of touch screen 604 (or the touch-sensitive surface) provide output data that represents the intensity of touches. The user interface of device 600 responds to touches based on their intensity, meaning that touches of different intensities can invoke different user interface operations on device 600.

Techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, and International Patent Application Serial No. PCT/US2013/069483, titled “Device, Method, and Graphical User Interface for Transitioning Between Touch Input to Display Output Relationships,” filed Nov. 11, 2013, each of which is hereby incorporated by reference in their entirety.

In some embodiments, device 600 has one or more input mechanisms 606 and 608. Input mechanisms 606 and 608, if included, are physical. Examples of physical input mechanisms include push buttons and rotatable mechanisms. In some embodiments, device 600 has one or more attachment mechanisms. Such attachment mechanisms, if included, can permit attachment of device 600 with, for example, hats, eyewear, earrings, necklaces, shirts, jackets, bracelets, watch straps, chains, trousers, belts, shoes, purses, backpacks, and so forth. These attachment mechanisms permit device 600 to be worn by a user.

FIG. 6B depicts exemplary personal electronic device 600. In some embodiments, device 600 includes some or all of the components described with respect to FIGS. 2A, 2B, and 4A. Device 600 has bus 612 that operatively couples I/O section 614 with one or more computer processors 616 and memory 618. I/O section 614 is connected to display 604, which can have touch-sensitive component 622 and, optionally, touch-intensity sensitive component 624. In addition, I/O section 614 is connected with communication unit 630 for receiving application and operating system data, using Wi-Fi, Bluetooth, near field communication (NFC), cellular, and/or other wireless communication techniques. Device 600 includes input mechanisms 606 and/or 608. Input mechanism 606 is a rotatable input device or a depressible and rotatable input device, for example. Input mechanism 608 is a button, in some examples.

Input mechanism 608 is a microphone, in some examples. Personal electronic device 600 includes, for example, various sensors, such as GPS sensor 632, accelerometer 634, directional sensor 640 (e.g., compass), gyroscope 636, motion sensor 638, and/or a combination thereof, all of which are operatively connected to I/O section 614.

Memory 618 of personal electronic device 600 is a non-transitory computer-readable storage medium, for storing computer-executable instructions, which, when executed by one or more computer processors 616, for example, cause the computer processors to perform the techniques and processes described below. The computer-executable instructions, for example, are also stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. Personal electronic device 600 is not limited to the components and configuration of FIG. 6B, but can include other or additional components in multiple configurations.

As used here, the term “affordance” refers to a user-interactive graphical user interface object that is, for example, displayed on the display screen of devices 200, 400, 600, and/or 1000 (FIGS. 2A, 4A, 6A-6B, and/or 10A-10V). For example, an image (e.g., icon), a button, and text (e.g., hyperlink) each constitutes an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 455 in FIG. 4A or touch-sensitive surface 551 in FIG. 5B) while the cursor is over a particular user interface element (e.g., a button, window, slider or other user interface element), the particular user interface element is adjusted in accordance with the detected input. In some implementations that include a touch screen display (e.g., touch-sensitive display system 212 in FIG. 2A or touch screen 212 in FIG. 5A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation) rather than being used to determine whether to perform a first operation or a second operation.

In some embodiments, a portion of a gesture is identified for purposes of determining a characteristic intensity. For example, a touch-sensitive surface receives a continuous swipe contact transitioning from a start location and reaching an end location, at which point the intensity of the contact increases. In this example, the characteristic intensity of the contact at the end location is based on only a portion of the continuous swipe contact, and not the entire swipe contact (e.g., only the portion of the swipe contact at the end location). In some embodiments, a smoothing algorithm is applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

### 3. Digital Assistant System

FIG. 7A illustrates a block diagram of digital assistant system 700 in accordance with various examples. In some examples, digital assistant system 700 is implemented on a standalone computer system. In some examples, digital assistant system 700 is distributed across multiple computers. In some examples, some of the modules and functions of the digital assistant are divided into a server portion and a client portion, where the client portion resides on one or more user devices (e.g., devices 104, 122, 200, 400, 600, and/or 1000) and communicates with the server portion (e.g., server system 108) through one or more networks, e.g., as shown in FIG. 1. In some examples, digital assistant system 700 is an implementation of server system 108 (and/or DA server 106) shown in FIG. 1. It should be noted that digital assistant system 700 is only one example of a digital assistant system, and that digital assistant system 700 can have more or fewer components than shown, can combine two or more components, or can have a different configuration or arrangement of the components. The various components shown in FIG. 7A are implemented in hardware, software instructions for execution by one or more processors, firmware, including one or more signal processing and/or application specific integrated circuits, or a combination thereof.

Digital assistant system 700 includes memory 702, one or more processors 704, input/output (I/O) interface 706, and network communications interface 708. These components can communicate with one another over one or more communication buses or signal lines 710.

In some examples, memory 702 includes a non-transitory computer-readable medium, such as high-speed random access memory and/or a non-volatile computer-readable storage medium (e.g., one or more magnetic disk storage devices, flash memory devices, or other non-volatile solid-state memory devices).

In some examples, I/O interface 706 couples input/output devices 716 of digital assistant system 700, such as displays, keyboards, touch screens, and microphones, to user interface module 722. I/O interface 706, in conjunction with user interface module 722, receives user inputs (e.g., voice input, keyboard inputs, touch inputs, etc.) and processes them accordingly. In some examples, e.g., when the digital assistant is implemented on a standalone user device, digital assistant system 700 includes any of the components and I/O communication interfaces described with respect to devices 200, 400, 600, and/or 1000 in FIGS. 2A, 4A, 6A-6B, and 10A-10V respectively. In some examples, digital assistant system 700 represents the server portion of a digital assistant implementation, and can interact with the user through a client-side portion residing on a user device (e.g., devices 104, 200, 400, 600, and/or 1000).

In some examples, the network communications interface 708 includes wired communication port(s) 712 and/or wireless transmission and reception circuitry 714. The wired communication port(s) receives and send communication signals via one or more wired interfaces, e.g., Ethernet, Universal Serial Bus (USB), FIREWIRE, etc. The wireless circuitry 714 receives and sends RF signals and/or optical signals from/to communications networks and other communications devices. The wireless communications use any of a plurality of communications standards, protocols, and technologies, such as GSM, EDGE, CDMA, TDMA, Bluetooth, Wi-Fi, VoIP, Wi-MAX, or any other suitable communication protocol. Network communications interface 708 enables communication between digital assistant system 700 with networks, such as the Internet, an intranet, and/or a wireless network, such as a cellular telephone network, a wireless local area network (LAN), and/or a metropolitan area network (MAN), and other devices.

In some examples, memory 702, or the computer-readable storage media of memory 702, stores programs, modules, instructions, and data structures including all or a subset of: operating system 718, communications module 720, user interface module 722, one or more applications 724, and digital assistant module 726. In particular, memory 702, or the computer-readable storage media of memory 702, stores instructions for performing the processes described below. One or more processors 704 execute these programs, modules, and instructions, and reads/writes from/to the data structures.

Operating system 718 (e.g., Darwin, RTXC, LINUX, UNIX, iOS, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

Communications module 720 facilitates communications between digital assistant system 700 with other devices over network communications interface 708. For example, communications module 720 communicates with RF circuitry 208 of electronic devices such as devices 200, 400, and 600 shown in FIGS. 2A, 4A, 6A-6B, respectively. Communications module 720 also includes various components for handling data received by wireless circuitry 714 and/or wired communications port 712.

User interface module 722 receives commands and/or inputs from a user via I/O interface 706 (e.g., from a keyboard, touch screen, pointing device, controller, and/or microphone), and generate user interface objects on a display. User interface module 722 also prepares and delivers outputs (e.g., speech, sound, animation, text, icons, vibrations, haptic feedback, light, etc.) to the user via the I/O interface 706 (e.g., through displays, audio channels, speakers, touch-pads, etc.).

Applications 724 include programs and/or modules that are configured to be executed by one or more processors 704. For example, if the digital assistant system is implemented on a standalone user device, applications 724 include user applications, such as games, a calendar application, a navigation application, or an email application. If digital assistant system 700 is implemented on a server, applications 724 include resource management applications, diagnostic applications, or scheduling applications, for example.

Memory 702 also stores digital assistant module 726 (or the server portion of a digital assistant). In some examples, digital assistant module 726 includes the following sub-modules, or a subset or superset thereof: input/output processing module 728, speech-to-text (STT) processing module 730, natural language processing module 732, dialogue flow processing module 734, task flow processing module 736, service processing module 738, and speech synthesis processing module 740. Each of these modules has access to one or more of the following systems or data and models of the digital assistant module 726, or a subset or superset thereof: ontology 760, vocabulary index 744, user data 748, task flow models 754, service models 756, and ASR systems 758.

In some examples, using the processing modules, data, and models implemented in digital assistant module 726, the digital assistant can perform at least some of the following: converting speech input into text; identifying a user's intent expressed in a natural language input received from the user; actively eliciting and obtaining information needed to fully infer the user's intent (e.g., by disambiguating words, games, intentions, etc.); determining the task flow for fulfilling the inferred intent; and executing the task flow to fulfill the inferred intent.

In some examples, as shown in FIG. 7B, I/O processing module 728 interacts with the user through I/O devices 716 in FIG. 7A or with a user device (e.g., devices 104, 200, 400, or 600) through network communications interface 708 in FIG. 7A to obtain user input (e.g., a speech input) and to provide responses (e.g., as speech outputs) to the user input. I/O processing module 728 optionally obtains contextual information associated with the user input from the user device, along with or shortly after the receipt of the user input. The contextual information includes user-specific data, vocabulary, and/or preferences relevant to the user input. In some examples, the contextual information also includes software and hardware states of the user device at the time the user request is received, and/or information related to the surrounding environment of the user at the time that the user request was received. In some examples, I/O processing module 728 also sends follow-up questions to, and receive answers from, the user regarding the user request. When a user request is received by I/O processing module 728 and the user request includes speech input, I/O processing module 728 forwards the speech input to STT processing module 730 (or speech recognizer) for speech-to-text conversions.

STT processing module 730 includes one or more ASR systems 758. The one or more ASR systems 758 can process the speech input that is received through I/O processing module 728 to produce a recognition result. Each ASR system 758 includes a front-end speech pre-processor. The front-end speech pre-processor extracts representative features from the speech input. For example, the front-end speech pre-processor performs a Fourier transform on the speech input to extract spectral features that characterize the speech input as a sequence of representative multi-dimensional vectors. Further, each ASR system 758 includes one or more speech recognition models (e.g., acoustic models and/or language models) and implements one or more speech recognition engines. Examples of speech recognition models include Hidden Markov Models, Gaussian-Mixture Models, Deep Neural Network Models, n-gram language models, and other statistical models. Examples of speech recognition engines include the dynamic time warping based engines and weighted finite-state transducers (WFST) based engines. The one or more speech recognition models and the one or more speech recognition engines are used to process the extracted representative features of the front-end speech pre-processor to produce intermediate recognitions results (e.g., phonemes, phonemic strings, and sub-words), and ultimately, text recognition results (e.g., words, word strings, or sequence of tokens). In some examples, the speech input is processed at least partially by a third-party service or on the user's device (e.g., device 104, 200, 400, or 600) to produce the recognition result. Once STT processing module 730 produces recognition results containing a text string (e.g., words, or sequence of words, or sequence of tokens), the recognition result is passed to natural language processing module 732 for intent deduction. In some examples, STT processing module 730 produces multiple candidate text representations of the speech input. Each candidate text representation is a sequence of words or tokens corresponding to the speech input. In some examples, each candidate text representation is associated with a speech recognition confidence score. Based on the speech recognition confidence scores, STT processing module 730 ranks the candidate text representations and provides the n-best (e.g., n highest ranked) candidate text representation(s) to natural language processing module 732 for intent deduction, where n is a predetermined integer greater than zero. For example, in one example, only the highest ranked (n=1) candidate text representation is passed to natural language processing module 732 for intent deduction. In another example, the five highest ranked (n=5) candidate text representations are passed to natural language processing module 732 for intent deduction.

More details on the speech-to-text processing are described in U.S. Utility application Ser. No. 13/236,942 for “Consolidating Speech Recognition Results,” filed on Sep. 20, 2011, the entire disclosure of which is incorporated herein by reference.

In some examples, STT processing module 730 includes and/or accesses a vocabulary of recognizable words via phonetic alphabet conversion module 731. Each vocabulary word is associated with one or more candidate pronunciations of the word represented in a speech recognition phonetic alphabet. In particular, the vocabulary of recognizable words includes a word that is associated with a plurality of candidate pronunciations. For example, the vocabulary includes the word “tomato” that is associated with the candidate pronunciations of [symbol] and [symbol] . Further, vocabulary words are associated with custom candidate pronunciations that are based on previous speech inputs from the user. Such custom candidate pronunciations are stored in STT processing module 730 and are associated with a particular user via the user's profile on the device. In some examples, the candidate pronunciations for words are determined based on the spelling of the word and one or more linguistic and/or phonetic rules. In some examples, the candidate pronunciations are manually generated, e.g., based on known canonical pronunciations.

In some examples, the candidate pronunciations are ranked based on the commonness of the candidate pronunciation. For example, the candidate pronunciation [symbol] is ranked higher than [symbol] , because the former is a more commonly used pronunciation (e.g., among all users, for users in a particular geographical region, or for any other appropriate subset of users). In some examples, candidate pronunciations are ranked based on whether the candidate pronunciation is a custom candidate pronunciation associated with the user. For example, custom candidate pronunciations are ranked higher than canonical candidate pronunciations. This can be useful for recognizing proper nouns having a unique pronunciation that deviates from canonical pronunciation. In some examples, candidate pronunciations are associated with one or more speech characteristics, such as geographic origin, nationality, or ethnicity. For example, the candidate pronunciation [symbol] is associated with the United States, whereas the candidate pronunciation [symbol] is associated with Great Britain. Further, the rank of the candidate pronunciation is based on one or more characteristics (e.g., geographic origin, nationality, ethnicity, etc.) of the user stored in the user's profile on the device. For example, it can be determined from the user's profile that the user is associated with the United States. Based on the user being associated with the United States, the candidate pronunciation [symbol] (associated with the United States) is ranked higher than the candidate pronunciation [symbol] (associated with Great Britain). In some examples, one of the ranked candidate pronunciations is selected as a predicted pronunciation (e.g., the most likely pronunciation).

When a speech input is received, STT processing module 730 is used to determine the phonemes corresponding to the speech input (e.g., using an acoustic model), and then attempt to determine words that match the phonemes (e.g., using a language model). For example, if STT processing module 730 first identifies the sequence of phonemes [symbol] corresponding to a portion of the speech input, it can then determine, based on vocabulary index 744, that this sequence corresponds to the word “tomato.”

In some examples, STT processing module 730 uses approximate matching techniques to determine words in an utterance. Thus, for example, the STT processing module 730 determines that the sequence of phonemes [symbol] corresponds to the word “tomato,” even if that particular sequence of phonemes is not one of the candidate sequence of phonemes for that word.

Natural language processing module 732 (“natural language processor”) of the digital assistant takes the n-best candidate text representation(s) (“word sequence(s)” or “token sequence(s)”) generated by STT processing module 730, and attempts to associate each of the candidate text representations with one or more “actionable intents” recognized by the digital assistant. An “actionable intent” (or “user intent”) represents a task that can be performed by the digital assistant, and can have an associated task flow implemented in task flow models 754. The associated task flow is a series of programmed actions and steps that the digital assistant takes in order to perform the task. The scope of a digital assistant's capabilities is dependent on the number and variety of task flows that have been implemented and stored in task flow models 754, or in other words, on the number and variety of “actionable intents” that the digital assistant recognizes. The effectiveness of the digital assistant, however, also dependents on the assistant's ability to infer the correct “actionable intent(s)” from the user request expressed in natural language.

In some examples, in addition to the sequence of words or tokens obtained from STT processing module 730, natural language processing module 732 also receives contextual information associated with the user request, e.g., from I/O processing module 728. The natural language processing module 732 optionally uses the contextual information to clarify, supplement, and/or further define the information contained in the candidate text representations received from STT processing module 730. The contextual information includes, for example, user preferences, hardware, and/or software states of the user device, sensor information collected before, during, or shortly after the user request, prior interactions (e.g., dialogue) between the digital assistant and the user, and the like. As described herein, contextual information is, in some examples, dynamic, and changes with time, location, content of the dialogue, and other factors.

In some examples, the natural language processing is based on, e.g., ontology 760. Ontology 760 is a hierarchical structure containing many nodes, each node representing either an “actionable intent” or a “property” relevant to one or more of the “actionable intents” or other “properties.” As noted above, an “actionable intent” represents a task that the digital assistant is capable of performing, i.e., it is “actionable” or can be acted on. A “property” represents a parameter associated with an actionable intent or a sub-aspect of another property. A linkage between an actionable intent node and a property node in ontology 760 defines how a parameter represented by the property node pertains to the task represented by the actionable intent node.

In some examples, ontology 760 is made up of actionable intent nodes and property nodes. Within ontology 760, each actionable intent node is linked to one or more property nodes either directly or through one or more intermediate property nodes. Similarly, each property node is linked to one or more actionable intent nodes either directly or through one or more intermediate property nodes. For example, as shown in FIG. 7C, ontology 760 includes a “restaurant reservation” node (i.e., an actionable intent node). Property nodes “restaurant,” “date/time” (for the reservation), and “party size” are each directly linked to the actionable intent node (i.e., the “restaurant reservation” node).

In addition, property nodes “cuisine,” “price range,” “phone number,” and “location” are sub-nodes of the property node “restaurant,” and are each linked to the “restaurant reservation” node (i.e., the actionable intent node) through the intermediate property node “restaurant.” For another example, as shown in FIG. 7C, ontology 760 also includes a “set reminder” node (i.e., another actionable intent node). Property nodes “date/time” (for setting the reminder) and “subject” (for the reminder) are each linked to the “set reminder” node. Since the property “date/time” is relevant to both the task of making a restaurant reservation and the task of setting a reminder, the property node “date/time” is linked to both the “restaurant reservation” node and the “set reminder” node in ontology 760.

An actionable intent node, along with its linked property nodes, is described as a “domain.” In the present discussion, each domain is associated with a respective actionable intent, and refers to the group of nodes (and the relationships there between) associated with the particular actionable intent. For example, ontology 760 shown in FIG. 7C includes an example of restaurant reservation domain 762 and an example of reminder domain 764 within ontology 760. The restaurant reservation domain includes the actionable intent node “restaurant reservation,” property nodes “restaurant,” “date/time,” and “party size,” and sub-property nodes “cuisine,” “price range,” “phone number,” and “location.” Reminder domain 764 includes the actionable intent node “set reminder,” and property nodes “subject” and “date/time.” In some examples, ontology 760 is made up of many domains. Each domain shares one or more property nodes with one or more other domains. For example, the “date/time” property node is associated with many different domains (e.g., a scheduling domain, a travel reservation domain, a movie ticket domain, etc.), in addition to restaurant reservation domain 762 and reminder domain 764.

While FIG. 7C illustrates two example domains within ontology 760, other domains include, for example, “find a movie,” “initiate a phone call,” “find directions,” “schedule a meeting,” “send a message,” and “provide an answer to a question,” “read a list,” “providing navigation instructions,” “provide instructions for a task” and so on. A “send a message” domain is associated with a “send a message” actionable intent node, and further includes property nodes such as “recipient(s),” “message type,” and “message body.” The property node “recipient” is further defined, for example, by the sub-property nodes such as “recipient name” and “message address.”

In some examples, ontology 760 includes all the domains (and hence actionable intents) that the digital assistant is capable of understanding and acting upon. In some examples, ontology 760 is modified, such as by adding or removing entire domains or nodes, or by modifying relationships between the nodes within the ontology 760.

In some examples, nodes associated with multiple related actionable intents are clustered under a “super domain” in ontology 760. For example, a “travel” super-domain includes a cluster of property nodes and actionable intent nodes related to travel. The actionable intent nodes related to travel includes “airline reservation,” “hotel reservation,” “car rental,” “get directions,” “find points of interest,” and so on. The actionable intent nodes under the same super domain (e.g., the “travel” super domain) have many property nodes in common. For example, the actionable intent nodes for “airline reservation,” “hotel reservation,” “car rental,” “get directions,” and “find points of interest” share one or more of the property nodes “start location,” “destination,” “departure date/time,” “arrival date/time,” and “party size.”

In some examples, each node in ontology 760 is associated with a set of words and/or phrases that are relevant to the property or actionable intent represented by the node. The respective set of words and/or phrases associated with each node are the so-called “vocabulary” associated with the node. The respective set of words and/or phrases associated with each node are stored in vocabulary index 744 in association with the property or actionable intent represented by the node. For example, returning to FIG. 7B, the vocabulary associated with the node for the property of “restaurant” includes words such as “food,” “drinks,” “cuisine,” “hungry,” “eat,” “pizza,” “fast food,” “meal,” and so on. For another example, the vocabulary associated with the node for the actionable intent of “initiate a phone call” includes words and phrases such as “call,” “phone,” “dial,” “ring,” “call this number,” “make a call to,” and so on. The vocabulary index 744 optionally includes words and phrases in different languages.

Natural language processing module 732 receives the candidate text representations (e.g., text string(s) or token sequence(s)) from STT processing module 730, and for each candidate representation, determines what nodes are implicated by the words in the candidate text representation. In some examples, if a word or phrase in the candidate text representation is found to be associated with one or more nodes in ontology 760 (via vocabulary index 744), the word or phrase “triggers” or “activates” those nodes. Based on the quantity and/or relative importance of the activated nodes, natural language processing module 732 selects one of the actionable intents as the task that the user intended the digital assistant to perform. In some examples, the domain that has the most “triggered” nodes is selected. In some examples, the domain having the highest confidence value (e.g., based on the relative importance of its various triggered nodes) is selected. In some examples, the domain is selected based on a combination of the number and the importance of the triggered nodes. In some examples, additional factors are considered in selecting the node as well, such as whether the digital assistant has previously correctly interpreted a similar request from a user.

User data 748 includes user-specific information, such as user-specific vocabulary, user preferences, user address, user's default and secondary languages, user's contact list, and other short-term or long-term information for each user. In some examples, natural language processing module 732 uses the user-specific information to supplement the information contained in the user input to further define the user intent. For example, for a user request “invite my friends to my birthday party,” natural language processing module 732 is able to access user data 748 to determine who the “friends” are and when and where the “birthday party” would be held, rather than requiring the user to provide such information explicitly in his/her request.

It should be recognized that in some examples, natural language processing module 732 is implemented using one or more machine learning mechanisms (e.g., neural networks). In particular, the one or more machine learning mechanisms are configured to receive a candidate text representation and contextual information associated with the candidate text representation. Based on the candidate text representation and the associated contextual information, the one or more machine learning mechanisms are configured to determine intent confidence scores over a set of candidate actionable intents. Natural language processing module 732 can select one or more candidate actionable intents from the set of candidate actionable intents based on the determined intent confidence scores. In some examples, an ontology (e.g., ontology 760) is also used to select the one or more candidate actionable intents from the set of candidate actionable intents.

Other details of searching an ontology based on a token string are described in U.S. Utility application Ser. No. 12/341,743 for “Method and Apparatus for Searching Using An Active Ontology,” filed Dec. 22, 2008, the entire disclosure of which is incorporated herein by reference.

In some examples, once natural language processing module 732 identifies an actionable intent (or domain) based on the user request, natural language processing module 732 generates a structured query to represent the identified actionable intent. In some examples, the structured query includes parameters for one or more nodes within the domain for the actionable intent, and at least some of the parameters are populated with the specific information and requirements specified in the user request. For example, the user says “Make me a dinner reservation at a sushi place at 7.” In this case, natural language processing module 732 is able to correctly identify the actionable intent to be “restaurant reservation” based on the user input. According to the ontology, a structured query for a “restaurant reservation” domain includes parameters such as {Cuisine}, {Time}, {Date}, {Party Size}, and the like. In some examples, based on the speech input and the text derived from the speech input using STT processing module 730, natural language processing module 732 generates a partial structured query for the restaurant reservation domain, where the partial structured query includes the parameters {Cuisine=“Sushi” } and {Time=“7 pm” }. However, in this example, the user's utterance contains insufficient information to complete the structured query associated with the domain. Therefore, other necessary parameters such as {Party Size} and {Date} are not specified in the structured query based on the information currently available. In some examples, natural language processing module 732 populates some parameters of the structured query with received contextual information. For example, in some examples, if the user requested a sushi restaurant “near me,” natural language processing module 732 populates a {location} parameter in the structured query with GPS coordinates from the user device.

In some examples, natural language processing module 732 identifies multiple candidate actionable intents for each candidate text representation received from STT processing module 730. Further, in some examples, a respective structured query (partial or complete) is generated for each identified candidate actionable intent. Natural language processing module 732 determines an intent confidence score for each candidate actionable intent and ranks the candidate actionable intents based on the intent confidence scores. In some examples, natural language processing module 732 passes the generated structured query (or queries), including any completed parameters, to task flow processing module 736 (“task flow processor”). In some examples, the structured query (or queries) for the m-best (e.g., m highest ranked) candidate actionable intents are provided to task flow processing module 736, where m is a predetermined integer greater than zero. In some examples, the structured query (or queries) for the m-best candidate actionable intents are provided to task flow processing module 736 with the corresponding candidate text representation(s).

Other details of inferring a user intent based on multiple candidate actionable intents determined from multiple candidate text representations of a speech input are described in U.S. Utility application Ser. No. 14/298,725 for “System and Method for Inferring User Intent From Speech Inputs,” filed Jun. 6, 2014, the entire disclosure of which is incorporated herein by reference.

Task flow processing module 736 is configured to receive the structured query (or queries) from natural language processing module 732, complete the structured query, if necessary, and perform the actions required to “complete” the user's ultimate request. In some examples, the various procedures necessary to complete these tasks are provided in task flow models 754. In some examples, task flow models 754 include procedures for obtaining additional information from the user and task flows for performing actions associated with the actionable intent.

As described above, in order to complete a structured query, task flow processing module 736 needs to initiate additional dialogue with the user in order to obtain additional information, and/or disambiguate potentially ambiguous utterances. When such interactions are necessary, task flow processing module 736 invokes dialogue flow processing module 734 to engage in a dialogue with the user. In some examples, dialogue flow processing module 734 determines how (and/or when) to ask the user for the additional information and receives and processes the user responses. The questions are provided to and answers are received from the users through I/O processing module 728. In some examples, dialogue flow processing module 734 presents dialogue output to the user via audio and/or visual output, and receives input from the user via spoken or physical (e.g., clicking) responses. Continuing with the example above, when task flow processing module 736 invokes dialogue flow processing module 734 to determine the “party size” and “date” information for the structured query associated with the domain “restaurant reservation,” dialogue flow processing module 734 generates questions such as “For how many people?” and “On which day?” to pass to the user. Once answers are received from the user, dialogue flow processing module 734 then populates the structured query with the missing information, or pass the information to task flow processing module 736 to complete the missing information from the structured query.

Once task flow processing module 736 has completed the structured query for an actionable intent, task flow processing module 736 proceeds to perform the ultimate task associated with the actionable intent. Accordingly, task flow processing module 736 executes the steps and instructions in the task flow model according to the specific parameters contained in the structured query. For example, the task flow model for the actionable intent of “restaurant reservation” includes steps and instructions for contacting a restaurant and actually requesting a reservation for a particular party size at a particular time. For example, using a structured query such as: {restaurant reservation, restaurant=ABC Café, date=3/12/2012, time=7 pm, party size=5}, task flow processing module 736 performs the steps of: (1) logging onto a server of the ABC Café or a restaurant reservation system such as OPENTABLE®, (2) entering the date, time, and party size information in a form on the website, (3) submitting the form, and (4) making a calendar entry for the reservation in the user's calendar.

In some examples, task flow processing module 736 employs the assistance of service processing module 738 (“service processing module”) to complete a task requested in the user input or to provide an informational answer requested in the user input. For example, service processing module 738 acts on behalf of task flow processing module 736 to make a phone call, set a calendar entry, invoke a map search, invoke or interact with other user applications installed on the user device, and invoke or interact with third-party services (e.g., a restaurant reservation portal, a social networking website, a banking portal, etc.). In some examples, the protocols and application programming interfaces (API) required by each service are specified by a respective service model among service models 756. Service processing module 738 accesses the appropriate service model for a service and generates requests for the service in accordance with the protocols and APIs required by the service according to the service model.

For example, if a restaurant has enabled an online reservation service, the restaurant submits a service model specifying the necessary parameters for making a reservation and the APIs for communicating the values of the necessary parameter to the online reservation service. When requested by task flow processing module 736, service processing module 738 establishes a network connection with the online reservation service using the web address stored in the service model, and sends the necessary parameters of the reservation (e.g., time, date, party size) to the online reservation interface in a format according to the API of the online reservation service.

In some examples, natural language processing module 732, dialogue flow processing module 734, and task flow processing module 736 are used collectively and iteratively to infer and define the user's intent, obtain information to further clarify and refine the user intent, and finally generate a response (i.e., an output to the user, or the completion of a task) to fulfill the user's intent. The generated response is a dialogue response to the speech input that at least partially fulfills the user's intent. Further, in some examples, the generated response is output as a speech output. In these examples, the generated response is sent to speech synthesis processing module 740 (e.g., speech synthesizer) where it can be processed to synthesize the dialogue response in speech form. In yet other examples, the generated response is data content relevant to satisfying a user request in the speech input.

In examples where task flow processing module 736 receives multiple structured queries from natural language processing module 732, task flow processing module 736 initially processes the first structured query of the received structured queries to attempt to complete the first structured query and/or execute one or more tasks or actions represented by the first structured query. In some examples, the first structured query corresponds to the highest ranked actionable intent. In other examples, the first structured query is selected from the received structured queries based on a combination of the corresponding speech recognition confidence scores and the corresponding intent confidence scores. In some examples, if task flow processing module 736 encounters an error during processing of the first structured query (e.g., due to an inability to determine a necessary parameter), the task flow processing module 736 can proceed to select and process a second structured query of the received structured queries that corresponds to a lower ranked actionable intent. The second structured query is selected, for example, based on the speech recognition confidence score of the corresponding candidate text representation, the intent confidence score of the corresponding candidate actionable intent, a missing necessary parameter in the first structured query, or any combination thereof.

Speech synthesis processing module 740 is configured to synthesize speech outputs for presentation to the user. Speech synthesis processing module 740 synthesizes speech outputs based on text provided by the digital assistant. For example, the generated dialogue response is in the form of a text string. Speech synthesis processing module 740 converts the text string to an audible speech output. Speech synthesis processing module 740 uses any appropriate speech synthesis technique in order to generate speech outputs from text, including, but not limited, to concatenative synthesis, unit selection synthesis, diphone synthesis, domain-specific synthesis, formant synthesis, articulatory synthesis, hidden Markov model (HMM) based synthesis, and sinewave synthesis. In some examples, speech synthesis processing module 740 is configured to synthesize individual words based on phonemic strings corresponding to the words. For example, a phonemic string is associated with a word in the generated dialogue response. The phonemic string is stored in metadata associated with the word. Speech synthesis processing module 740 is configured to directly process the phonemic string in the metadata to synthesize the word in speech form.

In some examples, instead of (or in addition to) using speech synthesis processing module 740, speech synthesis is performed on a remote device (e.g., the server system 108), and the synthesized speech is sent to the user device for output to the user. For example, this can occur in some implementations where outputs for a digital assistant are generated at a server system. And because server systems generally have more processing power or resources than a user device, it is possible to obtain higher quality speech outputs than would be practical with client-side synthesis.

Additional details on digital assistants can be found in the U.S. Utility application Ser. No. 12/987,982, entitled “Intelligent Automated Assistant,” filed Jan. 10, 2011, and U.S. Utility application Ser. No. 13/251,088, entitled “Generating and Processing Task Items That Represent Tasks to Perform,” filed Sep. 30, 2011, the entire disclosures of which are incorporated herein by reference.

### 4. Foundation Model

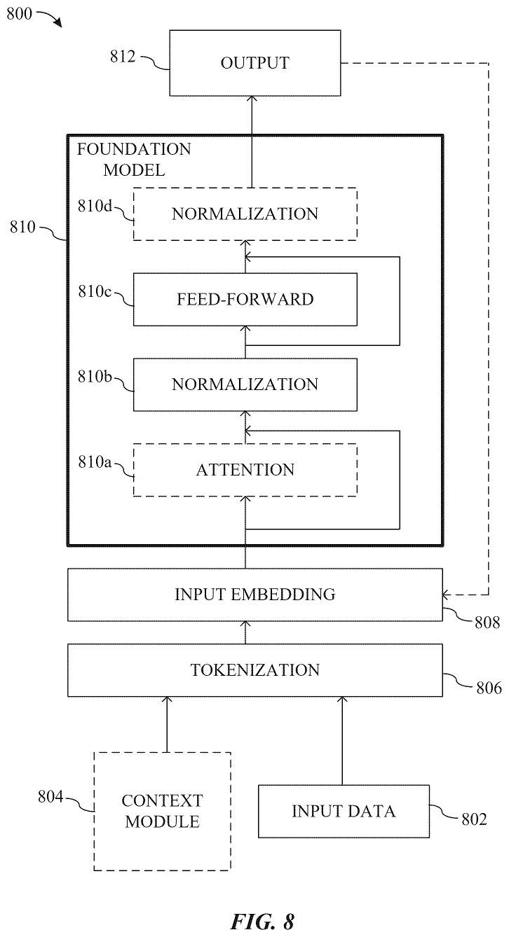

FIG. 8 illustrates exemplary foundation system 800 including foundation model 810, according to various examples. In some examples, the blocks of foundation system 800 are combined, the order of the blocks is changed, and/or blocks of foundation system 800 are removed.

Foundation system 800 includes tokenization module 806, input embedding module 808, and foundation model 810 which use input data 802 and, optionally, context module 804 to train foundation model 810 to process input data 802 to determine output 812.

In some examples, the various components of digital assistant system 700 (e.g., digital assistant module 726, operating system (e.g., 226 or 718), and/or software applications (e.g., 236 and/or 724) installed on device 104, 200, 400, 600, and/or 1000) include and/or are implemented using generative artificial intelligence (AI) such as foundation model 810. In some examples, foundation model 810 include a subset of machine learning models that are trained to generate text, images, and/or other media based on sets of training data that include large amounts of a particular type of data. Foundation model 810 is then integrated into the components of digital assistant system 700 or otherwise available to digital assistant system 700, (e.g., digital assistant module 726, operating system (e.g., 226 or 718), and/or software applications (e.g., 236 and/or 724) installed on device 104, 200, 400, 600, and/or via an API) to provide text, images, and/or other media that digital assistant system 700 uses to determine tasks, perform tasks, and/or provide the outputs of tasks.

Foundation models are generally trained using large sets unlabeled data first and then later adapted to a specific task within the architecture of digital assistant system 700. Thus, a specific task or type of output is not encoded into the foundation models, rather the trained foundation model emerges based on the self-supervised training using the unlabeled data. The trained foundation model is then adapted to a variety of tasks based on the needs of the digital assistant system 700 to efficiently perform tasks for a user.

Generative AI models, such as foundation model 810, are trained on large quantities of data with self-supervised or semi-supervised learning to be adapted to a specific downstream task. For example, foundation model 810 is trained with large sets of different images and corresponding text or metadata to determine the description of newly captured image data as output 812. These descriptions can then be used by digital assistant system 700 to determine user intent, tasks, and/or other information that can be used to perform tasks. For example, generative AI models such as Midjourney, DALL-E, and stable diffusion are trained on large sets of images and are able to convert text to a generated image.

Large language models (LLM) are a type of foundation model that provide text output after being trained on large sets of input text data. As with other foundation models, LLM's can be trained in a self-supervised manner and thus the output of different LLM's trained on the same large set of input text can be different. These LLM's can then be adapted for use with digital assistant system 700 to specific types of text. Thus, in some examples, the LLM is trained to determine a summary of text provided to the LLM as an input while in other examples, the LLM is trained to predict text based on the set of input text. Thus, the LLM can efficiently process large amounts of input text to provide the digital assistant with text that can be used to determine and/or perform tasks. For example, GPT and LLaMA are exemplary large language models that process large amounts of input text and generates text that can be used by a digital assistant, a software application, and/or an operating system.

In some examples, the LLM may be trained in a semi-supervised manner and/or provided human feedback to refine the output of the LLM. In this way, the LLM may be adapted to provide the specific output required for a particular task of digital assistant system 700, such as a summary of large amounts of text or a task for digital assistant system 700 to perform. Further, the input provided to the LLM can be adapted such that the LLM processes data as or more efficiently than digital assistant system 700 could without the use of the LLM.

Once foundation model 810 (e.g., an LLM) has been fully trained, foundation model 810 can process input data 802 as discussed below to determine output 812 which may be used to further train foundation model 810 or can be processed by digital assistant system 700 to perform a task and/or provide an output to the user.

Specifically, input data 802 is received and provided to tokenization module 806 which converts input data 802 into a token and/or a series of tokens which can be processed by input embedding module 808 into a format that is understood by foundation model 810. Tokenization module 806 converts input data into a series of characters that has a specific semantic meaning to foundation model 810.

In some examples, tokenization module 806 tokenizes contextual data from context module 804 to add further information to input data 802 for processing by foundation model 810. For example, context module 804 can provide information related to input data 802 such as a location that input data 802 was received, a time that input data 802 was received, other data that was received contemporaneously with input data 802, and/or other contextual information that relates to input data 802. Tokenization module 806 can then tokenize this contextual data with input data 802 to be provided to foundation model 810.

After input data 802 has been tokenized, input data 802 is provided to input embedding module 808 to convert the tokens to a vector representation that can be processed by foundation model 810. In some examples, the vector representation includes information provided by context module 804. In some examples, the vector representation includes information determined from output 812. Accordingly, input embedding module 808 converts the various data provided as an input into a format that foundation model 810 can parse and process.

For example, when foundation model 810 is a large language model (LLM) tokenization module 806 converts input data 802 into text which is then converted into a vector representation by input embedding module 808 that can be processed by foundation model 810 to determine a response to input data 802 as output 812 or to determine a summary of input data 802 as output 812. As another example, when foundation model 810 is a model that has been trained to determine descriptions of images, input data 802 of images can be tokenized into characters and then converted into a vector representation by input embedding module 808 that is processed by foundation model 810 to determine a description of the images as output 812.

Foundation model 810 processes the received vector representation using a series of layers including, in some embodiments, attention layer 810a, normalization layer 810b, feed-forward layer 810c, and/or normalization layer 810d. In some examples, foundation model 810 includes additional layers similar to these layers to further process the vector representation. Accordingly, foundation model 810 can be customized based on the specific task that foundation model 810 has been trained to perform. Each of the layers of foundation model 810 perform a specific task to process the vector representation into output 812.

Attention layer 810a provides access to all portions of the vector representation at the same time, increasing the speed at which the vector representation can be processed and ensuring that the data is processed equally across the portions of the vector representation. Normalization layer 810b and normalization layer 810d scale the data that is being processed by foundation model 810 up or down based on the needs of the other layers of foundation model 810. This allows foundation model 810 to manipulate the data during processing as needed. Feed-forward layer 810c assigns weights to the data that is being processed and provides the data for further processing within foundation model 810. These layers work together to process the vector representation provided to foundation model 810 to determine the appropriate output 812.

For example, as discussed above, when foundation model 810 is a large language model (LLM) foundation model 810 processes input text to determine a summary and/or further follow-up text as output 812. As another example, as discussed above, when foundation model 810 is a model trained to determine descriptions of images, foundation model 810 processes input images to determine a description of the image and/or tasks that can be performed based on the content of the images as output 812.

In some examples, output 812 is further processed by digital assistant system 700 (e.g., digital assistant module 726, operating system (e.g., 226 or 718), software applications (e.g., 236 and/or 724) installed on device 104, 200, 400, 600, and/or 1000) to provide an output or execute a task. For example, when output 812 is a sentence describing a task that digital assistant system 700 has performed, digital assistant system 700 can use the text to create a visual or audio output to be provided to a user. As another example, when output 812 is text that includes a function and a parameter for the function, digital assistant system 700 can perform a function call to execute the function with the provided parameter

In some examples, digital assistant system 700 includes multiple generative AI (e.g., foundation) models that work together to process data in an efficient manner. In some examples, components of digital assistant system 700 may be replaced with generative AI (e.g., foundation) models trained to perform the same function as the component. In some examples, these generative AI models are more efficient than traditional components and/or provide more flexible processing and/or outputs for digital assistant system 700 to utilize.

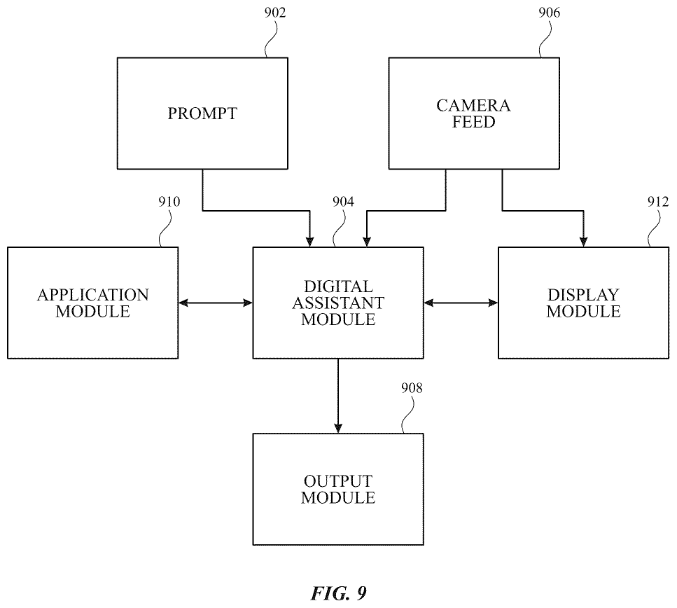

FIG. 9 is a block diagram illustrating system 900 for integrating visual context, according to various examples. System 900 is implemented, for example, using one or more electronic devices (e.g., a mobile device, a personal computer, a wearable electronic device, and/or a peripheral device) that is in communication with one or more display generation components (e.g., display 1002) and implements a digital assistant (e.g., digital assistant system 700, foundation system 800). In some examples, system 900 is implemented using a client-server system (e.g., system 100), and the functions of system 900 are divided up in any manner between the server (e.g., DA server 106) and a client device (e.g., 104, 200, 400, 600, and/or 1000). In other examples, the functions of system 900 are divided up between the server and multiple client devices. Thus, while some functions of system 900 are described herein as being performed by particular devices of a client-server system, it will be appreciated that system 1000 is not so limited. In other examples, system 900 is implemented using only a client device (e.g., 104, 200, 400, 600, and/or 1000) or only multiple client devices. Some functions of system 900 are, optionally, combined, the order of some functions is, optionally, changed, and some functions are, optionally, omitted. In some examples, additional functions may be performed in combination with the described functions of system 900.

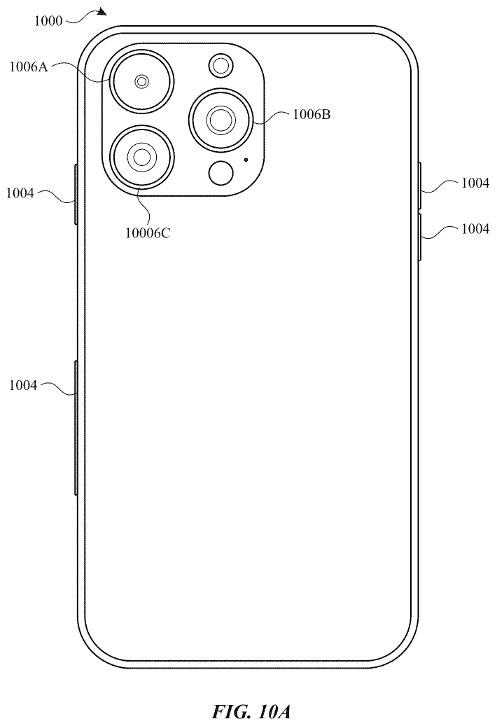

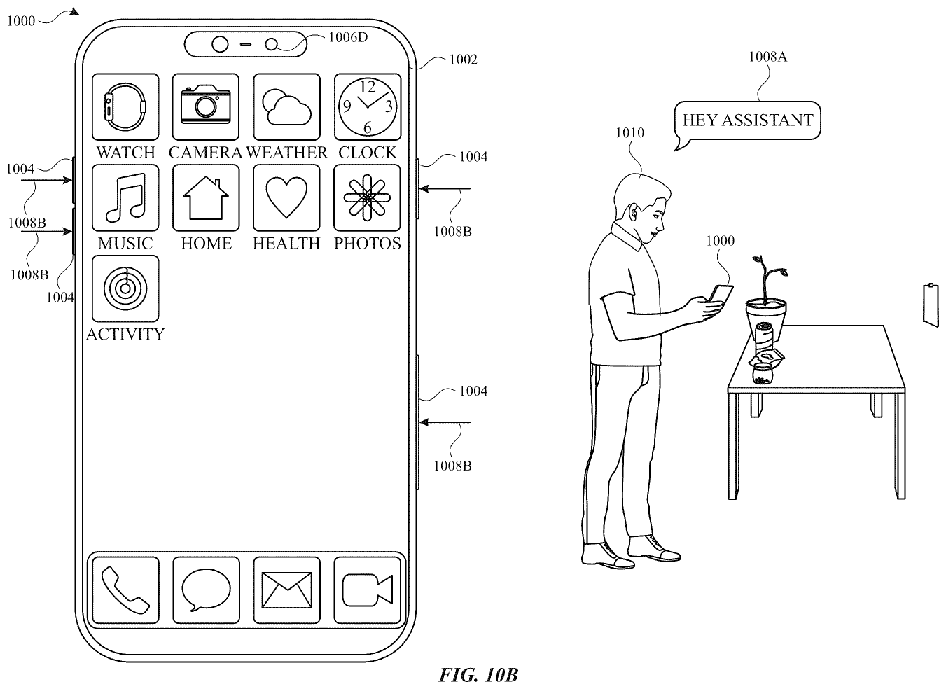

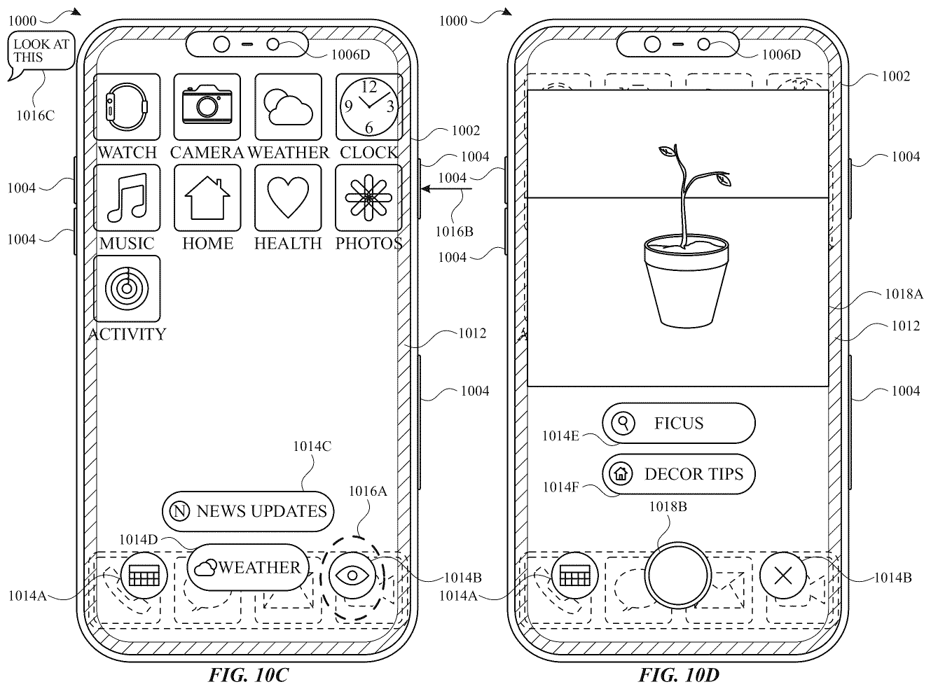

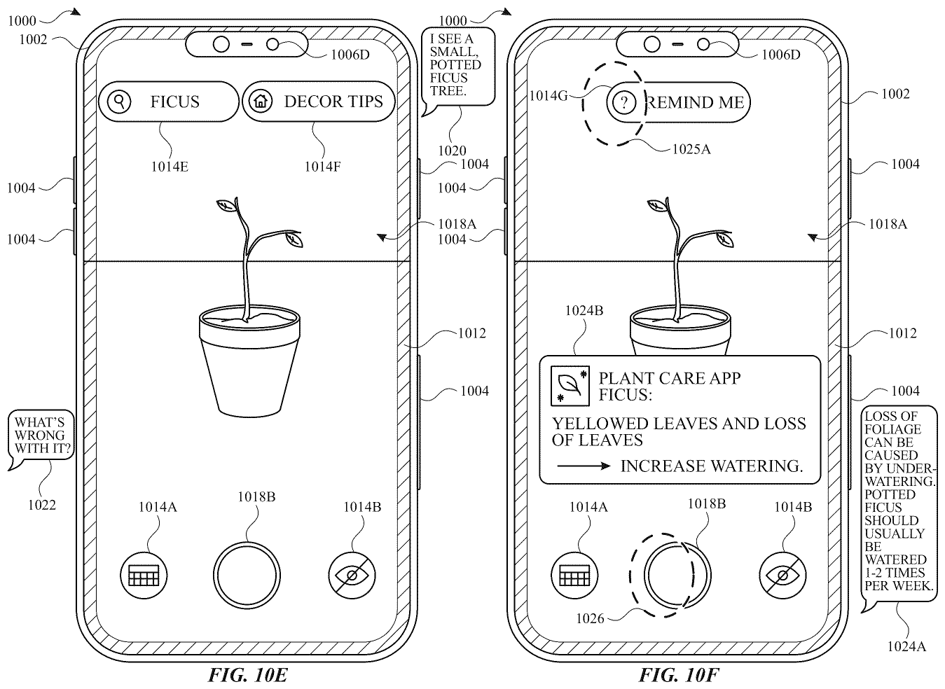

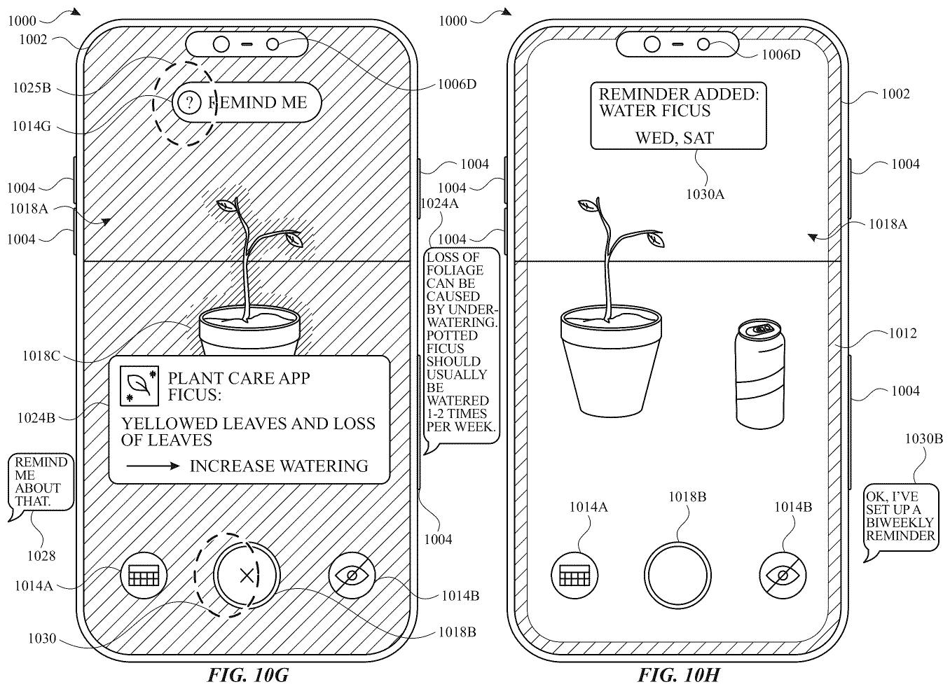

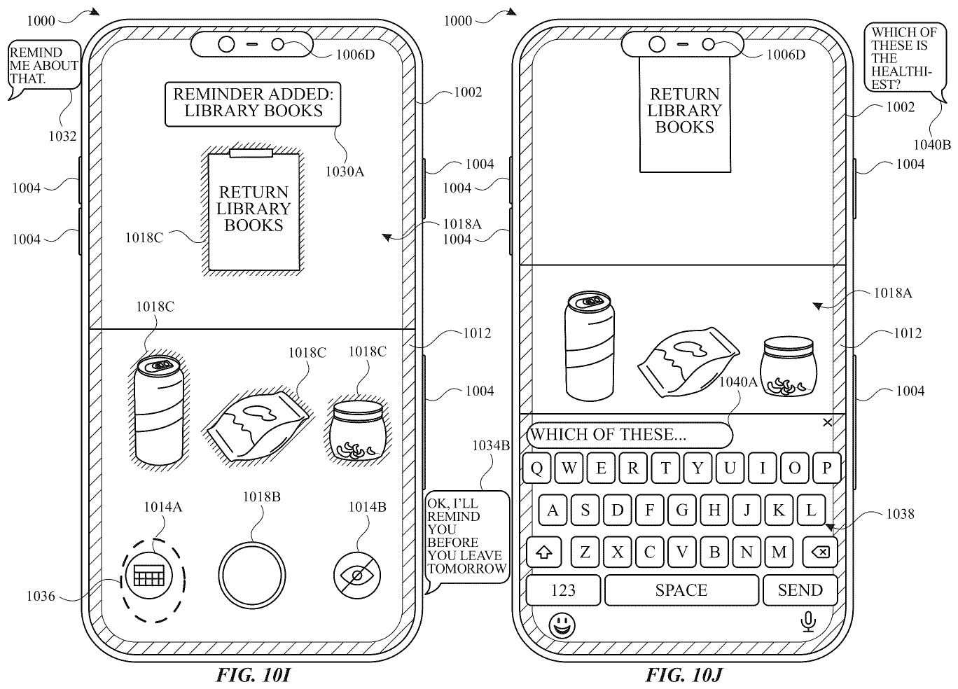

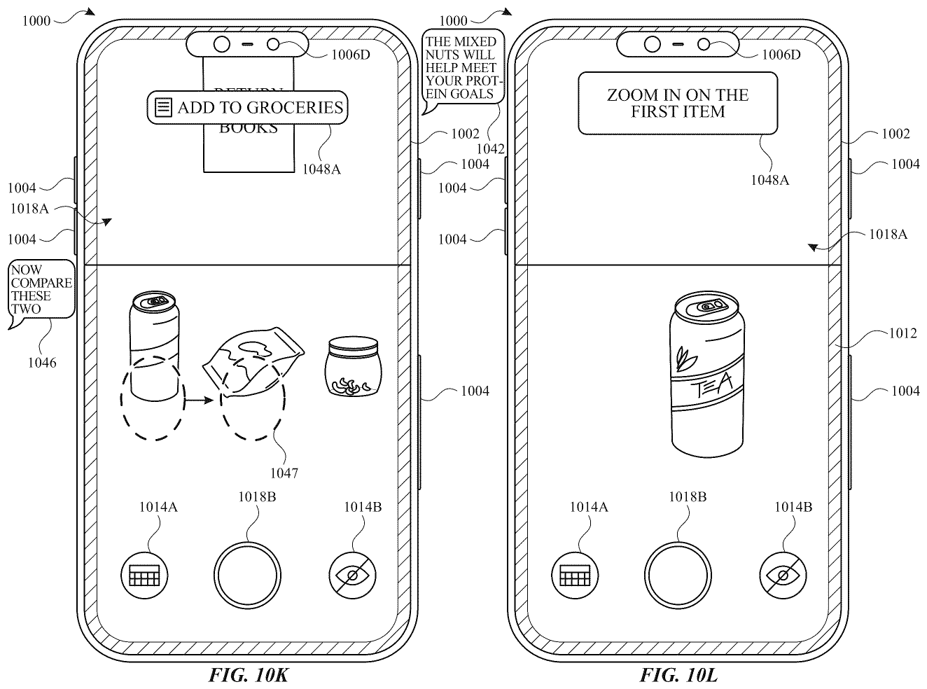

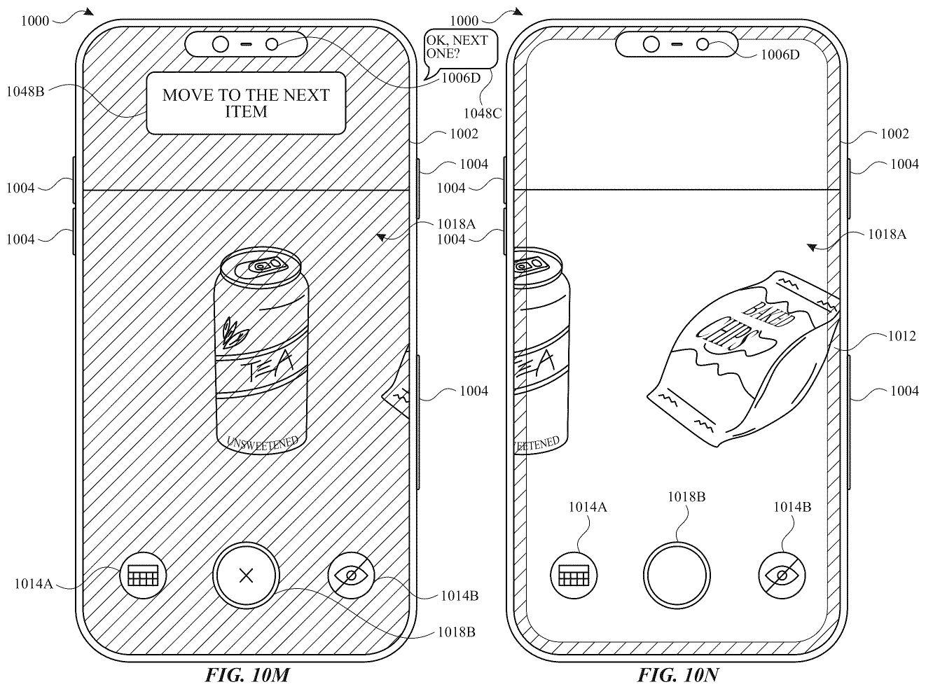

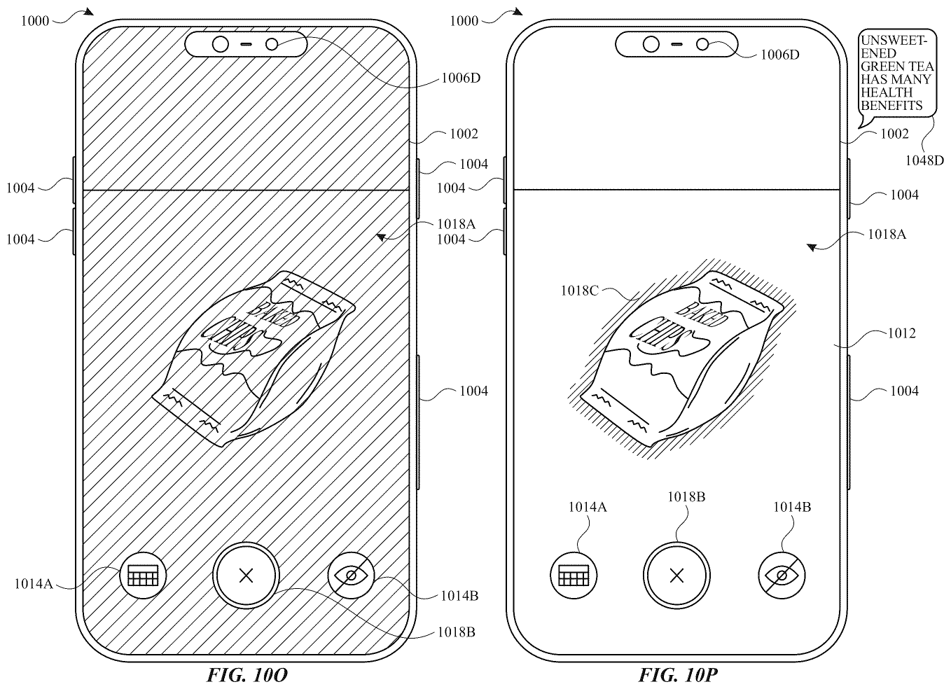

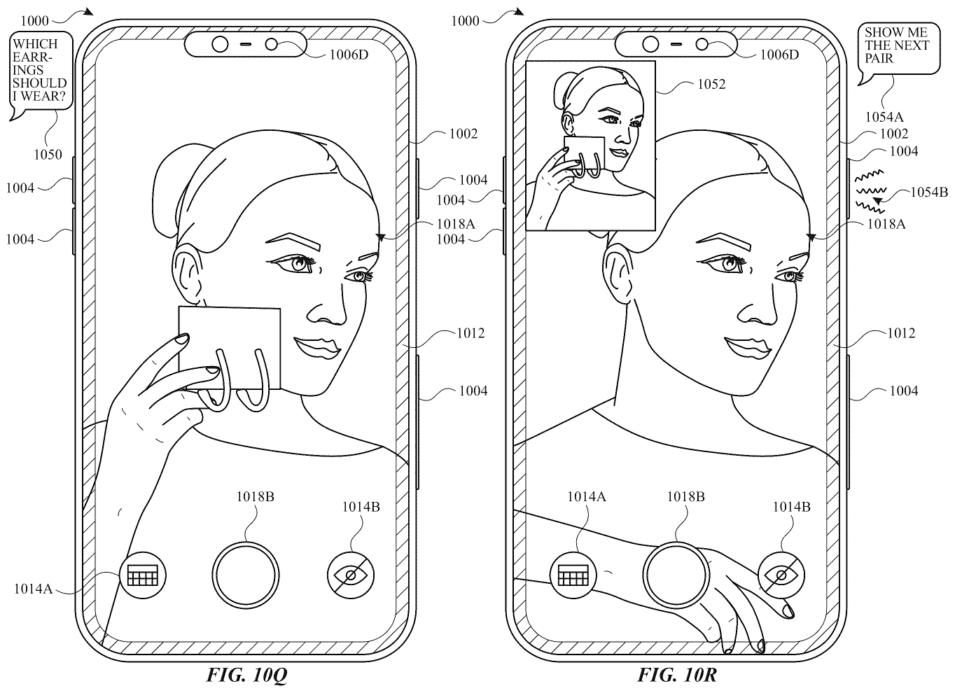

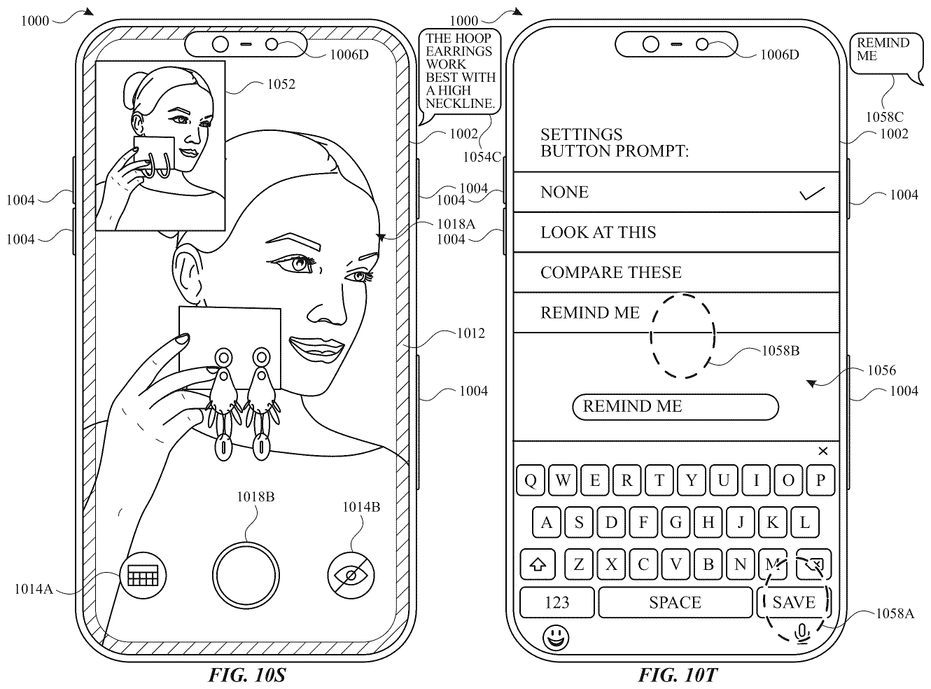

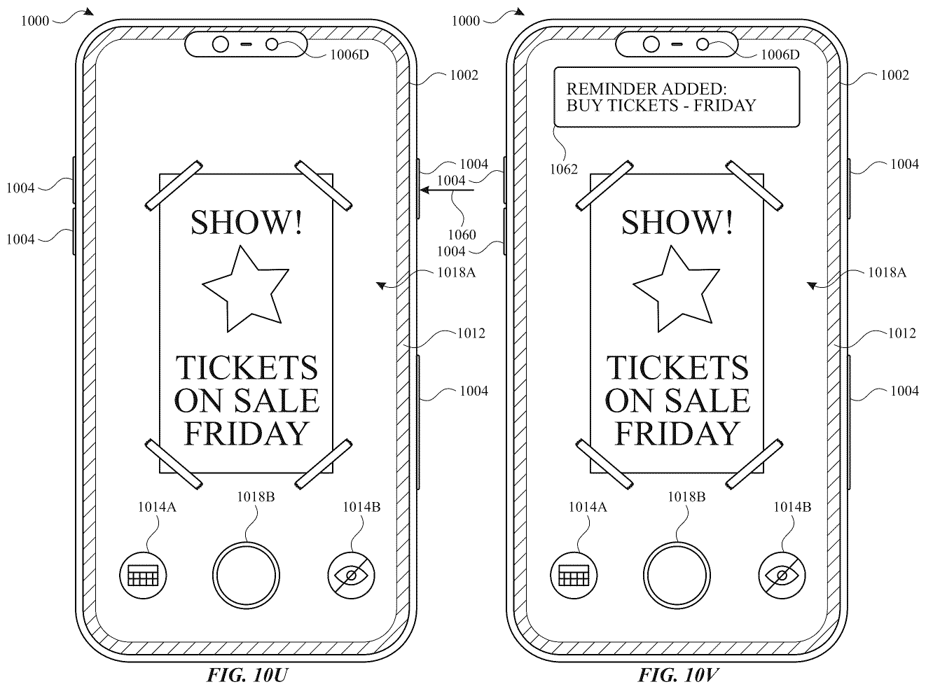

For example, system 900 is implemented as part of a digital assistant system (e.g., digital assistant system 700, e.g., in conjunction with foundation system 800) for use in interpreting and operationalizing user intents from an input. For example, system 900 is used when performing processes such as described below with respect to FIGS. 10A-10V.

As illustrated in FIG. 9, system 900 includes digital assistant module 904, application module 910, and display module 912. Application module 910 is an interface (e.g., an API layer) linking system 900 to one or more software applications (e.g., first- and/or third-party applications) installed on and/or otherwise accessible to the computer system implementing system 900. In particular, digital assistant module 904 receives information from the software applications and/or causes the software applications to perform tasks via application module 910. For example, digital assistant module 904 receives information about application functionality, results of actions performed by the applications, information from application-specific knowledge bases, and/or other application-specific context, such as user preferences and usage history, and provides the software applications with instructions and/or parameters for performing actions. Digital assistant module 904 receives information from display module 912 about what system 900 is displaying and/or provides display outputs via display module 912.

Camera feed 906 includes a live (or near-live) feed of data received from (e.g., captured by) one or more cameras in communication with system 900 (e.g., the cameras of system 1000, described in further detail below). For example, camera feed 906 captures the visible environment in which a user is operating a device implementing system 900 (e.g., system 1000). As described in further detail with respect to FIGS. 10A-14, system 900 displays a representation of camera feed 906 via display module 912. For example, display module 912 displays a viewfinder user interface that displays the live (or near-live) camera data, allowing the user to view the portion of the visible environment being captured by the one or more cameras for use by system 900.

Digital assistant module 904 receives prompt 902, an initial and/or user-provided prompt. For example, system 900 receives prompt 902 from one or more user inputs detected using one or more input devices and/or sensors in communication with system 900, such as touch-sensitive surfaces, hardware buttons, microphones, cameras, and/or peripheral input devices, as described in further detail with respect to FIGS. 10A-10V. In some embodiments, prompt 902 is a textual or tokenized representation of a natural-language input, such as a transcription of a spoken user input or a natural-language text input typed or written by the user.

In response to receiving prompt 902, digital assistant module 904 generates output 908 based on visual context information obtained from camera feed 906. In some embodiments, the visual context information includes portions of camera data captured near-in-time to receiving prompt 902, such as one or more frames and/or portions of frames from camera feed 906. For example, output 908 is based on the portions of camera data that were displayed via display module 912 shortly before, during, and/or shortly after detecting the user input of prompt 902. In some embodiments, the visual context information includes information identified and/or extracted from camera feed 906. For example, digital assistant module 904 processes the portions of camera data using one or more image and/or video analysis techniques (e.g., machine vision and/or other machine learning techniques) to classify, identify, and/or describe objects, symbols, patterns, and/or other visible features of the user's environment captured by the one or more cameras in camera feed 906. In some embodiments, digital assistant module 904 includes a digital assistant agent for processing the camera data to extract visual context (e.g., a visual intelligence agent with a machine vision model) and/or uses another service to process the camera data to extract visual context, such as another application installed on the computer system implementing system 900 and/or a remote (e.g., server- or cloud-based) image analysis system.

In some embodiments, system 900 obtains at least a portion of the visual context information from camera feed 906 in response to receiving prompt 902. In some embodiments, system 900 obtains the visual context information from camera feed 906 preemptively (e.g., prior to and/or independently of receiving prompt 902). For example, digital assistant module 904 analyzes camera feed 906 for updated visual context information continuously (e.g., as new data is captured by the one or more cameras), periodically (e.g., once every 0.5 seconds, 2 seconds, 10 seconds, 30 seconds, and/or 60 seconds), and/or in response to detecting certain conditions, such as motion sensor data indicating that the user has moved the one or more cameras (e.g., changing the field-of-view of camera feed 906). In some embodiments, the visual context information used for output 908 is obtained in multiple stages and/or iteratively, for example, identifying some of the visual context preemptively, in response to receiving prompt 902, while pre-processing prompt 902, and/or while generating output 908 (e.g., further processing the data of camera feed 906 as part of performing one task and using the further processing results as visual context for another task of output 908). In some embodiments, in addition to the visual context information derived from camera feed 906, digital assistant module 904 obtains and uses other forms of contextual information for generating output 908 in response to prompt 902, including other sensor data, device context (e.g., including context from application module 910 and/or display module 912), user data, interaction history, and/or other knowledge bases.

In some embodiments, digital assistant module 904 provides prompt 902 and the visual context information to a digital assistant agent to pre-process prompt 902 for input to one or more other agents in order to generate portions of output 908. For example, the digital assistant agent includes an LLM or other intelligence model trained to rewrite natural-language prompts using context information and/or to annotate prompts by selecting relevant context information (e.g., a query re-writer and/or query decorator). In some embodiments, instead of or in addition to pre-processing prompt 902 using the visual context information, digital assistant module 904 provides prompt 902 and the visual context information (e.g., including any selected frames and/or portions of frames of camera feed 906) directly to one or more other agents to generate portions of output 908.

In some embodiments, the digital assistant agent analyzes prompt 902 and/or the visual context information to identify one or more tasks, and optionally, parameters for the tasks, to perform in response to and/or as part of generating the response to prompt 902 (e.g., sub-tasks that return portions of the response and/or inputs for further sub-tasks). For example, the tasks are selected from a set of application intents, which digital assistant module 904 passes (e.g., via application module 910) to the applications along with the necessary parameters (e.g., identified from and/or including the visual context) to cause performance of the selected tasks based on prompt 902 and the visual context information.

In some embodiments, digital assistant module 904 provides prompt 902 and the visual context information (e.g., and/or the version of prompt 902 annotated with/rewritten based on the visual context information) to a digital assistant agent (e.g., or more than one digital assistant agent) to generate portions of output 908. For example, the digital assistant agent includes an LLM or another intelligent agent trained for generating natural-language outputs, visual content, response plans (e.g., including identifying one or more tasks and/or parameters for performing the tasks), and/or other generative content based on prompts and/or contextual information. In some embodiments, the digital assistant agent includes a multimodal LLM configured to use image/video processing (e.g., performing algorithmic and/or machine learning-based analysis of visual content) to both understand and/or act on (e.g., determine a task response and/or output generative content for) provided visual context (e.g., with or without a user-provided prompt and/or other forms of context information provided by digital assistant module 904). In some embodiments, the digital assistant agents for generating portions of output 908 include agents integrated into digital assistant module 904, agents integrated into other applications, and/or external agents, such as server-based AI models or services.

As described in further detail with respect to FIGS. 10A-14, generating output 908 includes causing performance of one or more tasks and/or providing one or more outputs to the user based on the visual context information. For example, digital assistant module 904 causes performance of the one or more tasks by providing the identified application intents and associated intent parameters to one or more applications (e.g., via application module 910) to cause the applications to perform the corresponding tasks using the identified parameters. For example, the one or more outputs to the user include one or more visual, audio, and/or tactile outputs that indicate information about the visual context, provide results of the one or more tasks, and/or output the generative content based on prompt 902 and the visual context.

Additional details and examples of receiving a prompt and generating a response to the prompt based on visual context from a camera feed are described herein with respect to FIGS. 10A-14.

FIGS. 10A-10V illustrate system 1000 for generating a response to a prompt based on visual context from a camera feed, in accordance with some embodiments. System 1000 is implemented, for example, using one or more electronic devices (e.g., a mobile device, a personal computer, a wearable electronic device, and/or a peripheral device) that is in communication with one or more display generation components (e.g., display 1002) and implements a digital assistant (e.g., digital assistant system 700, including foundation system 800 and/or system 900). In some examples, system 1000 is implemented using a client-server system (e.g., system 100), and the functions of system 1000 are divided up in any manner between the server (e.g., DA server 106) and a client device (e.g., 104, 200, 400, and/or 600). In other examples, the functions of system 1000 are divided up between the server and multiple client devices. Thus, while some functions of system 1000 are described herein as being performed by particular devices of a client-server system, it will be appreciated that system 1000 is not so limited. In other examples, system 1000 is implemented using only a client device (e.g., 104, 200, 400, and/or 600) or only multiple client devices. Some functions of system 1000 are, optionally, combined, the order of some functions is, optionally, changed, and some functions are, optionally, omitted. In some examples, additional functions may be performed in combination with the described functions of system 1000.

FIGS. 10A-10B illustrate back (e.g., FIG. 10A) and front (e.g., FIG. 10B) views of system 1000 (e.g., a mobile phone device) that includes touch-sensitive display 1002, a set of hardware buttons 1004, and a set of cameras including first camera 1006A, second camera 1006B, third camera 1006C, and fourth camera 1006D. In some embodiments, the set of hardware buttons may include different numbers of buttons, different arrangements of buttons, different types of buttons (e.g., mechanically-depressible and/or solid-state buttons), and/or compound buttons (e.g., one or more independently-operable buttons combined into a compound form or housing). In some embodiments, the set of cameras may include different numbers of cameras, different arrangements of cameras, and/or different types of cameras. For example, the different types of cameras may include one or more wide-angle lenses, one or more telephoto lenses, and/or one or more macro lenses. For example, the different types of cameras may vary in geometry (e.g., physical or equivalent focal lengths, such as 5 mm, 13 mm, 22 mm, 24 mm, 28 mm, 50 mm, 77 mm, 100 mm, and/or 300 mm, or f-stops of f/1.2, f/1.78, f/2.2, f/2.8, f/3.4, and/or f/8.4), resolution (e.g., 8 MP, 12 MP, 24 MP, 48 MP, and/or 72 MP), pixel size (e.g., 100 nm, 0.5 μm, 1.0 μm, 2.44 μm, 5 μm), and/or presence of other hardware features (e.g., dual or quad pixels, dual pixel autofocus capabilities, and/or optical image stabilization capabilities). In some embodiments, system 1000 includes one or more sensors (e.g., microphones, light sensors, depth sensors, motion sensors, and/or audio sensors) and/or one or more other output devices, such as speakers and/or haptic generator.

The right panel of FIG. 10B illustrates user 1010 using system 1000 (e.g., a device implementing system 100) in an environment (e.g., a physical environment and/or mixed-reality environment) that includes a potted plant, several snack items, and a paper note. For example, at FIG. 10B, user 1010 is holding system 1000 with the forward cameras 1006A, 1006B, and 1006C pointed away from user 1010 (e.g., towards the plant) and rear camera 1006D pointed towards user 1010.

At FIG. 10B, system 1000 detects one or more inputs, such as input 1008A and/or input 1008B, invoking a digital assistant session. As illustrated in FIG. 10C, input 1008A is a speech input including a digital assistant trigger phrase (e.g., “Hey assistant”) and/or a natural-language input associated with a request to invoke the digital assistant system of system 1000. Input 1008B includes one or more hardware button inputs, detected by the set of hardware buttons 1004, that are associated with a request to invoke the digital assistant system of system 1000. For example, inputs detected by particular hardware buttons of the set of hardware buttons 1004 and/or with particular characteristics (e.g., intensity, duration, movement, and/or input pattern) are associated with a request to invoke the digital assistant system. In some embodiments, other kinds of inputs are associated with requests to invoke the digital assistant system, such as certain inputs directed to the touch-sensitive surface of display 1002 and/or movement inputs (e.g., raising system 1000 with a certain speed or by a certain amount). As illustrated in FIG. 10B, the inputs invoking the digital assistant session (e.g., inputs 1008A and/or 1008B) are detected while system 1000 displays a home screen user interface (e.g., a home page for an operating system of the electronic device). In some embodiments, the inputs invoking the digital assistant session are detected while system 1000 displays another user interface, such as a lock screen interface or an application user interface (e.g., for an application installed on the electronic device).

In response to detecting the inputs invoking the digital assistant session (e.g., input 1008A and/or input 1008B), system 1000 displays a user interface for a digital assistant session. While displaying the user interface for the digital assistant session, user 1010 can input prompts to the digital assistant system and the digital assistant system will respond to the prompts as described herein (e.g., including using the systems and methods described with respect to FIGS. 7A-9, above).

As illustrated in FIG. 10C, the user interface for the digital assistant session overlays the home screen user interface (e.g., such that portions of the home screen user interface remain visible on display 1002) and includes digital assistant indicator 1012 (e.g., an edge glow effect signifying the digital assistant session) and control objects 1014A-1014D for interacting with the digital assistant. Keyboard object 1014A is a selectable user interface object (e.g., software button) for displaying a virtual (e.g., software) keyboard, a text input field, controls for inputting textual prompts to the digital assistant session. Vision mode object 1014B is a selectable user interface object (e.g., software button) for displaying a visual intelligence experience for the digital assistant session, as discussed in further detail below.

Prompt suggestions 1014C and 1014D indicate subjects and/or tasks recommended by the digital assistant system, which user 1010 can select to automatically input an associated prompt to the digital assistant session. For example, selecting prompt suggestion 1014C inputs a prompt to the digital assistant system to provide news updates, and selecting prompt suggestion 1014D inputs a prompt to the digital assistant system to provide a weather forecast. Prompt suggestions 1014C and 1014D are determined (e.g., chosen for suggestion by system 1000) using contextual information. For example, based on context information indicating that user 1010 typically checks the news and the weather around the current time of day, system 1000 provides prompt suggestions 1014C and 1014D, indicating that the digital assistant system can assist with those tasks and allowing user 1010 to quickly input the associated prompts.

At FIG. 10C, system 1000 detects one or more inputs, such as input 1016A, input 1016B, and/or input 1016C. As illustrated in FIG. 10C, input 1016A is a touch input directed to vision mode object 1014B, the dedicated software button for the visual intelligence experience. Input 1016B is a hardware button input with characteristics and/or directed to a particular hardware button associated with the visual intelligence experience (e.g., as described in further detail below, with respect to FIGS. 10T-10V). Input 1016C is a speech input including the prompt “Look at this.” In some embodiments, system 1000 determines that the prompt included in input 1016C corresponds to a request for the visual intelligence experience (e.g., “Look at this” is interpreted as a prompt or voice command requesting the visual intelligence experience). In some embodiments, system 1000 determines that the prompt included in 1016C should be interpreted using visual context (e.g., “Look at this” is analyzed to determine that the prompt is related to the visible environment, and thus that visual context should be used for responding to the prompt). For example, system 1000 pre-processes input 1016C using semantic analysis and/or NLU techniques (e.g., using an LLM and/or another intelligent agent) to determine a user intent to “show” system 1000 visual context via the one or more cameras and to interact with system 1000 based on the visual context.

As illustrated in FIGS. 10D-10E, in response to input 1016A, 1016B, and/or 1016C, system 1000 launches a visual intelligence experience for the digital assistant session, displaying viewfinder 1018A and viewfinder control object 1018B. Viewfinder 1018A displays a representation of a feed of data captured by one or more of cameras 1006A, 1006B, 1006C, and 1006D (e.g., a camera feed, such as camera feed 906), providing a live (or near-live) stream of the field-of-view of the cameras (e.g., pass-through video). In particular, at FIGS. 10D-10E, viewfinder 1018A displays a representation of a feed of data from one or more of the forward (e.g., environment-facing) cameras (e.g., 1006A, 1006B, and/or 1006C). In some embodiments, system 1000 determines whether to initially display viewfinder 1018A in response to input 1016A, 1016B, and/or 1016C with a camera feed from the rear (e.g., user-facing) camera 1006D or one or more of the forward cameras (1006A, 1006B, and/or 1006C) based on contextual information, such as motion data (e.g., determining that user 1010 is moving or holding system 1000 in a manner indicating that user 1010 is aiming to capture visual context using the forward cameras as opposed to the rear cameras) and/or the contents of input 1016C (e.g., determining that “Look at this” indicates an intent to capture visual context from the environment visible to the user as opposed to visual context from a “selfie” view).

Viewfinder control object 1018B provides a touch control for interacting with viewfinder 1018A, including switching between a live mode and a paused mode, as further described with respect to FIG. 10F-10H, below. Additionally, as illustrated in FIGS. 10D-10E, system 1000 updates the appearance of vision mode object 1014B, indicating that selecting vision mode object 1014B again will exit the visual intelligence experience for the digital assistant session (e.g., closing viewfinder 1018A and removing viewfinder control object 1018B).

FIG. 10D illustrates a partial-screen visual intelligence experience, where a portion of the home screen user interface remains visible below the overlay of viewfinder 1018A, and FIG. 10E illustrates a full-screen visual intelligence experience, where viewfinder 1018A occupies all or most of the area of display 1002. As illustrated in FIGS. 10E-10F, in some embodiments, viewfinder 1018A and viewfinder control object 1018B are displayed as part of the digital assistant session with digital assistant indicator 1012, keyboard object 1014A, and vision mode object 1014B.

In some embodiments, as an alternative to selecting vision mode object 1014B to launch the visual intelligence experience for the digital assistant, system 1000 automatically launches the visual intelligence experience in response to detecting an input invoking a digital assistant session (e.g., such as input 1008A and/or input 1008B) while displaying a camera application that includes a viewfinder representing a field-of-view of the cameras that will be captured when taking a photo or starting to record video. In some embodiments, when the digital assistant is invoked from within a camera application, system 1000 displays digital assistant indicator 1012 overlaying the camera user interface and uses the camera application viewfinder (e.g., instead of viewfinder 1018A) for the systems and embodiments described herein.

In the visual intelligence experience (e.g., while displaying viewfinder 1018A), the digital assistant system integrates visual context derived from the camera feed, including using the visual context to respond to user prompts (e.g., as described above with respect to FIG. 9).

As illustrated in FIGS. 10D-10E, viewfinder 1018A initially includes a view of the potted plant (e.g., user 1010 is aiming the cameras at the potted plant). System 1000 analyzes the portion of the camera feed represented in 1018A (e.g., the current camera feed data) to extract visual context (e.g., as described with respect to FIG. 9), using image analysis techniques, such as machine vision and/or other machine learning techniques (e.g., implemented on system 1000 or using a remote service accessible to system 1000), to identify (e.g., recognize) objects, types (e.g., classes) of objects, types of visual information (e.g., text, symbols, and/or patterns), environmental features (e.g., landmarks, buildings, pathways, and/or weather conditions), and/or other information about the visible environment captured by the one or more cameras and included in viewfinder 1018A.

For example, at FIGS. 10D-10E, system 1000 identifies that viewfinder 1018A is “looking at” a potted ficus tree in an indoor setting. In some embodiments, the visual context can be determined with different levels of detail. For example, system 1000 may determine more general visual context (e.g., identifying that viewfinder 1018A is looking at a plant), more specific visual context (e.g., identifying that viewfinder 1018A is looking at a ficus plant of the species Ficus benjamina), more detailed visual context (e.g., identifying that viewfinder 1018A is looking at a ficus plant in a red clay pot sitting on an oak table in the user's kitchen), and so forth. For example, system 1000 determines that the potted ficus tree is losing leaves, for instance, based on visual context of the few leaves attached to the tree and/or fallen leaves in the pot.

As illustrated in FIGS. 10D-10E, based on the visual context (e.g., potted ficus tree, indoor setting), system 1000 displays prompt suggestions 1014E and 1014F (e.g., replacing prompt suggestions 1014C and 1014D). Similarly to prompt suggestions 1014C and 1014D, prompt suggestions 1014E and 1014F are determined using contextual information. However, in the visual intelligence experience, prompt suggestions 1014E and 1014F are specifically determined using visual context derived from the camera feed. For example, prompt suggestion 1014E corresponds to a prompt for additional information about ficus trees and prompt suggestion 1014F corresponds to a prompt for providing interior decoration advice.

As illustrated in FIG. 10E, in some embodiments, system 1000 outputs a response to input 1016C (“Look at this”), providing spoken output 1020, “I see a small, potted ficus tree” (e.g., a synthesized speech utterance output via one or more speakers or other audio output devices), based on the determined visual context.

In some embodiments, system 1000 uses a multimodal LLM (e.g., as described above with respect to FIG. 9) to both understand and act on the visual context of viewfinder 1018A. For example, the multimodal LLM processes the camera data to generate prompt suggestion 1014E, prompt suggestion 1014F, and/or spoken output 1020.

As illustrated in FIG. 10E, while viewfinder 1018A is displaying the view of the potted ficus tree, system 1000 receives input 1022, a speech input including the natural-language prompt “What's wrong with it?” For example, system 1000 uses speech processing techniques to determine a textual and/or tokenized representation of the prompt. Alternatively, in some embodiments, user 1010 selects keyboard object 1014A to display a virtual keyboard (e.g., as part of the digital assistant user interface near and/or partially overlaying viewfinder 1018A) and uses the virtual keyboard to enter the prompt “What's wrong with it” via text (e.g., typing).

As described with respect to FIG. 9, in some embodiments, system 1000 pre-processes input 1022 based on the visual context of viewfinder 1018A when input 1022 is received, annotating and/or re-writing to refine the prompt (e.g., the textual/tokenized representation of the prompt) for further processing. For example, the digital assistant system annotates the prompt to identify “it” as the ficus tree and/or re-writes the prompt as “What's wrong with this ficus tree?” or “What is causing this ficus tree to lose leaves?” (e.g., if the visual context is analyzed to recognize the more detailed information, such as described above). In some embodiments, instead of or in addition to pre-processing the prompt using the visual context, system 1000 selects portions of the camera data to use as visual context, for instance, selecting the frame of camera data shown in viewfinder 1018A when input 1022 was received. For example, the digital assistant system identifies portions of camera data (e.g., received within a certain time of receiving input 1022) that include the ficus tree to provide to another service (e.g., the plant care application) for further processing.

Based on the prompt (e.g., the textual/tokenized representation of the prompt, the annotations, and/or the re-written prompt) and the visual context of viewfinder 1018A when input 1022 is received, system 1000 generates a response to input 1022 (e.g., as described with respect to FIG. 9). In particular, based on the prompt and the visual context information, system 1000 identifies an application intent for performing a “houseplant diagnosis” task using a plant care application (e.g., a software application installed on system 1000) and causes the plant care application to perform the task and return information about the ficus tree to be included in the response to input 1022.

Based on the prompt and the visual context of viewfinder 1018A, system 1000 additionally identifies any necessary and/or appropriate parameters to provide the application for performing the task. For example, if the plant care application includes a chatbot (e.g., a specialized generative AI model for responding to natural-language prompts about plants) and an image analyzer (e.g., a specialized machine vision AI model for analyzing pictures of plants), system 1000 provides the plant care application with the prompt (e.g., the textual/tokenized representation of the prompt, the annotations, and/or the re-written prompt) and the frame of camera data shown in viewfinder 1018A when input 1022 was received (e.g., or just the portion of the frame that includes the ficus tree) to the plant care application to analyze and diagnose what is wrong with the ficus tree. As another example, if the plant care application includes a standard text search interface for houseplant diagnosis, system 1000 provides the plant care application with searchable information derived from the visual context and/or other context, such as the search query “potted ficus losing leaves.”

In some embodiments, prior to providing visual context information (e.g., actual portions of camera data captured by the cameras) to the plant care application, system 1000 outputs a request to user 1010 to confirm a privacy setting. For example, system 1000 asks the user for permission to provide the frame of camera data shown in viewfinder 1018A to the plant care application, and only passes the image data if permission is granted (e.g., using the textual search query “potted ficus losing leaves” instead, or cancelling the task, if permission is denied).

As illustrated in FIG. 10F, system 1000 provides the information to the user via spoken output 1024A (e.g., “Loss of foliage can be caused by under-watering. Potted ficus should usually be watered 1-2 times per week.”) and display output 1024B (e.g., an informational panel including additional information from the plant care application). Display output 1024B is displayed within the digital assistant user interface, for instance, overlaying viewfinder 1018A. Additionally, system 1000 displays prompt suggestion 1014G, a follow-up prompt recommended based on the response to input 1022 corresponding to a prompt to set up a watering reminder for the ficus tree.

In some embodiments, at least a portion of the contents of spoken output 1024A and display output 1024B are outputs of the houseplant diagnosis task performed by the plant care application. For example, the plant care application returns the text of spoken output 1024A (e.g., to be synthesized into speech by the digital assistant system) and/or the text, icons, and/or user interface specifications of display output 1024B. In some embodiments, system 1000 further processes the outputs of the houseplant diagnosis task to generate spoken output 1024A and/or display output 1024B (e.g., using an LLM or other intelligence model to generate the outputs from the raw information output by the plant care application).

At FIG. 10F, system 1000 continues to display viewfinder 1018A in a live feed mode, updating viewfinder 1018A with live- or near-live camera data captured by cameras 1006A, 1006B, and/or 1006C. In response to detecting input 1026 directed to viewfinder control object 1018B, at FIG. 10G, system 1000 displays viewfinder 1018A in a freeze-frame (e.g., pause) mode (e.g., a pause mode where viewfinder 1018A is not updated to with the live- or near-live camera data). As illustrated in FIG. 10G, while in the freeze-frame mode, system 1000 updates the appearance of viewfinder 1018A to emphasize the appearance of the ficus tree, for instance, applying subject indicator 1018C (e.g., an edge glow, highlight, and/or other visual emphasis) to the ficus tree and/or darkening the background. Additionally, system 1000 updates the appearance of viewfinder control object 1018B, indicating that selecting viewfinder control object 1018B again will return viewfinder 1018A to the live feed mode.

Alternatively, in some embodiments, system 1000 automatically switches viewfinder 1018A to the freeze-frame mode in response to input 1022 (e.g., without input 1026). For example, upon determining that input 1022 relates to the ficus tree displayed in viewfinder 1018A, system 1000 automatically pauses the viewfinder on the freeze frame of the ficus tree (e.g., before, during, or after providing spoken output 1024A and/or display output 1024B to the user).

At FIG. 10G, system 1000 receives input 1028, a speech input including the natural-language prompt “remind me about that.” Because input 1028 is received while viewfinder 1018A is still displaying the ficus tree, system 1000 processes and generates a response to input 1028 based on the prompt, current visual context information, and other contextual information, as described above. In particular, the response to input 1028 is based at least in part on the maintained visual context of the ficus tree, as well as the new context of the response to input 1022 (e.g., the information received from the plant care application and provided to the user as spoken output 1024A and display output 1024B). Accordingly, switching viewfinder 1018A to the freeze-frame mode, either in response to input 1026 selecting the viewfinder control object 1018B or automatically in response to input 1022, provides user 1010 with the opportunity to follow up with additional inputs and/or prompts related to the ficus tree, without needing to keep cameras 1006A, 1006B, and 1006C trained on the ficus tree in the environment.

In response to input 1028, system 1000 performs the task of creating a reminder based on the current context of viewfinder 1018A and the digital assistant session. For example, system 1000 identifies an application intent for creating a reminder using a reminders application based on the natural-language prompt and identifies parameters for the reminder based on the visual context information and the response to input 1022 (e.g., the results provided by the plant care application), including identifying watering the ficus tree as the subject of the reminder and twice a week as the timing for the reminder. As illustrated in FIG. 10H, system 1000 provides display output 1030A (e.g., a notification banner confirming a reminder to water the ficus on Wednesdays and Saturdays has been created) and spoken output 1030B (e.g., “Ok, I've set up a biweekly reminder”) indicating that the task of creating a reminder has been successfully completed.

Alternatively, system 1000 performs the task of creating the watering reminder for the ficus tree and provides display output 1030A and speech output 1030B in response to an input selecting prompt suggestion 1014G, such as input 1025A and/or input 1025B illustrated in FIGS. 10F-10G. For example, inputs 1025A and/or 1025B include touch inputs directed to prompt suggestion 1014G via a touch-sensitive surface of display 1002 and/or gaze inputs directed to prompt suggestion 1014G within viewfinder 1018A (e.g., detected using camera 1006D and/or other gaze detection sensors and/or devices). Accordingly, user 1010 can input prompts to system 1000 by selecting the displayed prompt suggestions, and system 1000 generates the response to the selected prompt suggestion based on the contextual information used to recommend the prompt and/or the visual context of viewfinder 1018A when the prompt suggestion is selected.

In response to detecting input 1030 directed to viewfinder control object 1018B as illustrated in FIG. 10G, at FIG. 10H, system 1000 switches viewfinder 1018A back to the live feed mode, updating viewfinder 1018A with the live- or near-live camera data to represent the current field-of-view of the cameras. Alternatively, in some embodiments, system 1000 automatically switches viewfinder 1018A back to the live feed mode, for instance, after a period of time elapses without receiving further follow-up inputs from user 1010.

As illustrated in FIGS. 10H-10, while in the live feed mode, user 1010 changes the field-of-view of the cameras to capture a new portion of the environment including three snack items and a written note. As illustrated in FIG. 10I, while in the live feed mode, system 1000 modifies the appearance of viewfinder 1018A to visually emphasize one or more of the objects (e.g., the snacks and/or note). For example, similarly to highlighting the ficus tree in the freeze frame mode, system 1000 applies subject indicators 1018C (e.g., edge glow, fill effects, labels, and/or other visual elements/effects) to the drink can, the bag, and the tin to indicate that system 1000 has recognized those content items in viewfinder 1018A and that the user can interact with them. In some embodiments, the user can tap different regions of viewfinder 1018A to select different portions of visual content in order to direct system 1000 to “look at” particular objects or features. For example, in response to an input directed to the drink can in viewfinder 1018A, system 1000 applies subject indicator 1018C to the region with the drink can and generates responses to subsequent prompts (e.g., prompts detected while the drink can is highlighted) based on the visual context from the selected region (e.g., using the drink can as the primary visual context).

At FIG. 10I, system 1000 detects input 1032, a speech input including the natural language prompt “remind me about that,” and generates a response to input 1032, including performing the task of creating a reminder and providing display output 1034A and speech output 1034B confirming the reminder has been created. As illustrated in FIG. 10I, although the prompts of input 1028 and input 1030 are the same, because viewfinder 1018A includes a different portion of the environment (e.g., different visual content) when input 1030 is detected, system 1000 generates a different response to input 1030. In particular, system 1000 analyzes the visual contents of viewfinder 1018A when input 1030 is detected and identifies the three snack items and the written note (e.g., and identifies that the ficus tree is no longer visible in viewfinder 1018A). Additionally, system 1000 analyzes the written note to extract the text, “return library books” (e.g., using optical character recognition and/or other machine vision techniques). Accordingly, system 1000 uses the current visual context information to identify returning library books as the subject of the reminder. In some embodiments, system 1000 uses other contextual information to identify other parameters for performing the task, such as using information provided by the user's library card account, information about the library's location, and/or information about the user's commute (e.g., historical location information) to proactively determine when to deliver the reminder.

As illustrated in FIG. 10I, in addition to creating the reminder in the reminders application, system 1000 provides one or more outputs (e.g., 1034A and/or 1034B) confirming the completion of the task. Display output 1034A provides an alert banner indicating that the reminder has been created, and speech output 1034B provides additional confirmation, stating “Ok, I'll remind you before you leave tomorrow.” In some embodiments, system 1000 updates the appearance of viewfinder 1018A to increase the visual emphasis of the portion of viewfinder 1018A including the note in comparison to the visual emphasis on the other portions of viewfinder 1018A (e.g., including decreasing the prominence of and/or removing subject indicators 1018C from the snacks), indicating that the note was used as visual context for the response to input 1032.

At FIG. 10I, while displaying viewfinder 1018A for the visual intelligence experience, system 1000 detects input 1036 directed to keyboard object 1014A. In response to input 1036, at FIG. 10J, system 1000 displays user interface 1038, including a virtual keyboard and text entry field. As illustrated in FIG. 10J, user interface 1038 is displayed concurrently with viewfinder 1018A, providing controls for entering text inputs to the digital assistant session while maintaining visibility of the portion of the environment being captured by the cameras. At FIG. 10J, system 1000 detects input 1040A, a text prompt reading “Which of these is the healthiest?” input via user interface 1038. In some embodiments, system 1000 closes user interface 1038 (e.g., as illustrated in FIG. 10K) in response to a user input requesting to close the keyboard and/or automatically, for instance, in response to input 1040A being submitted. Alternatively, the user can continue to input speech inputs while user interface 1038 is displayed, such as input 1040B (e.g., the speech input “Which of these is the healthiest?”).

Based on the prompt and the visual context of viewfinder 1018A, at FIG. 10K, system 1000 generates a response to input 1040A (e.g., and/or input 1040B). For example, system 1000 determines (e.g., extracts) information about the three snack items from the camera data (e.g., from the appearances of the objects, including images and text on the labels) using image and/or video processing techniques, characterizing the items as a green tea drink, a single-serving bag of baked potato chips, and a tin of mixed nuts. As discussed above, the information about the three snack items can be determined with different levels of specificity and/or detail (e.g., identifying the items as a drink, chips, and nuts; identifying the items by their specific brands/product names; and/or identifying the items using other names, categories, and/or characteristics).

In some embodiments, system 1000 provides the determined visual context information to another service (e.g., a nutrition application, an LLM, and/or another generative service) to perform a task (e.g., searching, providing additional information about, and/or generating a comparison of the three snack items) that generates portions of the response to input 1040A. For example, system 1000 provides the information about the three snack items to a nutrition application (e.g., via application module 910) as parameters of a search or comparison application intent (e.g., task) to cause the nutrition application to provide search results and/or comparison data for the three recognized snacks. In some embodiments, the determined visual context information (e.g., information about the three snack items) is used to re-write/annotate the prompt for further processing by another service (e.g., a nutrition application, an LLM, and/or another generative service). For example, system 1000 rewrites the prompt of input 1040A to “Which of these [green tea drink, baked potato chips, mixed nuts] is the healthiest?,” then provides the rewritten prompt to an LLM to generate the text of speech output 1042.

In some embodiments, alternatively or in addition to determining the information about the three snack items from the camera data to provide to other services (e.g., the nutrition application and/or LLM), if user 1010 grants permission to share camera data (e.g., as discussed above), system 1000 extracts portions of the camera data to provide directly to the other services to generate portions of the response to input 1040A. For example, system 1000 provides the prompt (e.g., and/or the annotated/rewritten prompt), a portion of the camera data that was displayed in viewfinder 1018A when input 1040A is received, and/or any additional relevant context information to a generative AI service that generates the text of speech output 1042.

In some embodiments, the response to input 1040A is further based on additional context information identified by system 1000, such as information from a health application about user 1010's preferred diet, past interactions with the digital assistant regarding nutrition, the time of day, user 1010's gym schedule, and the like. As illustrated in FIG. 10K, system 1000 provides speech output 1042, which identifies that, of the three snack items captured in viewfinder 1018A, “The mixed nuts will help meet your protein goals.”

At FIG. 10K, system 1000 additionally displays prompt suggestion 1044, corresponding to a prompt to add the mixed nuts to a grocery list (e.g., in a Notes application). For example, prompt suggestion 1044 is recommended based on the visual context extracted from viewfinder 1018A and/or the response to input 1040A. As illustrated in FIGS. 10J-10K, system 1000 displays user interface 1038 (e.g., the keyboard user interface), receives input 1040A, and generates output 1042 while displaying viewfinder 1018A in the live feed mode. However, in some embodiments, system 1000 displays user interface 1038 and receives text inputs such as 1040A while displaying viewfinder 1018A in the freeze-frame mode (e.g., the user can select viewfinder control object 1018B to pause the feed prior to selecting keyboard object 1014A). Additionally, in some embodiments, system 1000 automatically switches viewfinder 1018A to the freeze-frame mode in response to receiving input 1040A, while generating the response, and/or while outputting speech output 1042, as described with respect to FIG. 10G.

At FIG. 10K, system 1000 receives input 1046, a speech input including the natural-language prompt “Now compare these two.” In response to detecting input 1046, system 1000 processes input 1046 to determine that the prompt relates to a set of two items and determines (e.g., by analyzing the contents of viewfinder 1018A and/or using the previously-determined visual context and/or generated results) that viewfinder 1018A includes more than two items.

In some embodiments, system 1000 uses additional context information to determine which two items are referred to in input 1046, such as user input 1047 illustrated in FIG. 10K. For example, input 1047 includes a gaze input (e.g., information about where user 1010 is looking detected using camera 1006D and/or other gaze detection sensors and/or devices) sweeping from the green tea drink to the bag of chips. As another example, input 1047 includes one or more touch inputs (e.g., inputs detected via a touch-sensitive surface of display 1002), such as taps directed to each of the green tea drink and the bag of chips in viewfinder 1018A and/or a gesture sweeping over, circling, and/or otherwise indicating the green tea drink and the bag of chips in viewfinder 1018A. Accordingly, based on input 1047 and/or analyzing the previous inputs and responses from the digital assistant session (e.g., indicating that a response about the mixed nuts has already been output), system 1000 determines that input 1046 is a request to compare just the green tea drink and the bag of chips in viewfinder 1018A, and provides a response as described with respect to FIG. 10P. In some embodiments, system 1000 updates the visual emphasis being applied to viewfinder 1018A (e.g., as described with respect to FIGS. 10G and 10I), for instance, applying subject indicators 1018C to the green tea drink and the bag of chips in viewfinder 1018A to indicate system 1000's current understanding of “these two.”

Alternatively, based on the determination that the prompt relates to a set of two items, system 1000 requests that user 1010 assist in visually disambiguating the intended items by focusing viewfinder 1018A on one at a time as illustrated in FIGS. 10L-10O. At FIG. 10L, system 1000 displays viewfinder guidance 1048A, an instruction to use viewfinder 1018A to capture the first item of “these two” referenced in the prompt.

As illustrated in FIG. 10M, once system 1000 determines that viewfinder 1018A includes the first intended item to compare, system 1000 displays a flash or shutter animation over viewfinder 1018A and temporarily switches viewfinder 1018A to the freeze-frame mode, indicating that system 1000 has registered the pictured visual context for the first item. For example, system 1000 determines that viewfinder 1018A includes the first item by analyzing the camera data (e.g., determining that the green tea drink is centered in the frame, isolated from other potential objects, and/or clearly captured in sufficient detail) and/or other contextual information, such as analyzing motion sensor data to determine when user 1010 has stopped moving the cameras.

As the prompt relates to a set of two items, system 1000 automatically returns viewfinder 1018A to the live feed mode, as illustrated in FIG. 10N. System 1000 additionally outputs viewfinder guidance 1048B (e.g., “Move to the next item”) and speech output 1048C (e.g., “Ok, next one?”), instructing user 1010 to guide viewfinder 1018A to the next item for comparison. While user 1010 guides viewfinder 1018A to the next item (e.g., moving the cameras to focus on the bag of chips to compare to the green tea drink), system 1000 continues to update viewfinder 1018A in the live feed mode.

At FIG. 10O, once system 1000 determines that viewfinder 1018A includes the second intended item to compare (e.g., as described with respect to FIG. 10M), system 1000 displays the flash/shutter animation over viewfinder 1018A and switches viewfinder 1018A to the freeze-frame mode, indicating that the bag of chips has been registered as visual context. As the prompt included in input 1046 specified that the set of items to compare includes two items, viewfinder 1018A remains in the freeze-frame mode at FIG. 10P, for instance, displaying the bag of chips with subject indicator 1018C. However, in some embodiments, if the prompt specifies a larger set and/or is more ambiguous (e.g., about the number and/or type of items to use as visual context), system 1000 automatically freezes and un-freezes viewfinder 1018A additional times while capturing additional visual context. In some embodiments, user 1010 can also manually control capturing discrete portions of visual context, for instance, selecting viewfinder control object 1018A in the live feed mode to register the current field-of-view as visual context and switch to the freeze-frame mode, then selecting viewfinder control object 1018A in the freeze-frame mode to return to the live feed mode to guide system 1000 to the next field-of-view to use as context.

At FIG. 10P, system 1000 generates a response to input 1046 based on the prompt and both the visual context registered at FIG. 10M (e.g., when viewfinder 1018A included the green tea drink) and the visual context registered at FIG. 10O (e.g., when viewfinder 1018A included the bag of chips). For example, system 1000 generates the response as described above, annotating/rewriting the prompt based on the visual context of the two items and/or providing the visual context of the two items to an application or service to generate a comparison between the green tea drink and the bag of chips. In some embodiments, the response to input 1046 is based on additional context information, such as the previous interactions with the digital assistant session (e.g., input 1040A, indicating that the prompt is likely seeking another nutritional comparison). As illustrated in FIG. 10P, system 1000 provides spoken output 1048D, “Unsweetened green tea has many health benefits,” responding to input 1046.

At FIG. 10Q, system 1000 detects input 1050, a speech input including the natural-language prompt “Which earrings should I wear?” As illustrated in FIG. 10Q, viewfinder 1018A displays a representation of a feed of data captured by camera 1006D, the rear (e.g., user-facing) camera. In some embodiments, system 1000 switches the camera direction of viewfinder 1018A automatically. For example, upon determining that the prompt relates to user 1010's appearance and/or using motion sensor data to determine that user 1010 has moved system 1000 into a “selfie” position, system 1000 proactively updates viewfinder 1018A to capture visual context information using camera 1006D. In some embodiments, system 1000 switches the camera direction of viewfinder 1018A (e.g., between the front cameras 1006A, 1006B, and/or 1006C and the rear camera 1006D) in response to a user input requesting the change, such as selecting a displayed user interface object and/or providing a button press input corresponding to switching camera direction. In some embodiments, system 1000 automatically selects between initially displaying the feed from the forward cameras or initially displaying the feed from the rear camera when launching the visual intelligence experience for the digital assistant session (e.g., as described with respect to FIGS. 10C-10E), for instance, based on the detected position of the cameras, a received prompt, and/or other contextual information, such as the previous context of the digital assistant session.

Similarly to input 1046 as described above, system 100 determines that the prompt of input 1050 relates to multiple items (e.g., “these earrings”) and determines that, at FIG. 10Q, viewfinder 1018A includes the first pair of earrings. For example, system 1000 processes the visual contents of viewfinder 1018A (e.g., and/or other available context, such as motion sensor data) to detect the earrings and/or to determine that the user has stopped to pose. Accordingly, at FIG. 10R, system 1000 displays picture-in-picture 1052, a freeze frame of the contents of viewfinder 1018A displayed overlaying a portion of viewfinder 1018A, such that both the live camera feed and the freeze frame are visible at the same time. In some embodiments, system 1000 also performs the steps described with respect to FIGS. 10M and 10O, for instance, displaying a flash/shutter animation and/or temporarily switching viewfinder 1018A to the freeze-frame mode before displaying picture-in-picture 1052 and automatically returning viewfinder 1018A to the live feed mode. As illustrated in FIG. 10R, system 1000 additionally outputs viewfinder guidance 1054A, a spoken output instructing the user to show system 1000 the next pair using viewfinder 1018A, and tactile output 1054B, a haptic output indicating that system 1000 has registered the visual context represented in the freeze frame displayed in picture-in-picture 1052.

At FIG. 10S, once system 1000 determines that viewfinder 1018A includes the second pair of earrings (e.g., as described above), system 1000 generates a response to input 1050 based on both the visual context displayed in picture-in-picture 1052 (e.g., the first pair of earrings) and the visual context displayed in viewfinder 1018A in FIG. 10S (e.g., the second pair of earrings). For example, as described above, system 1000 analyzes the different freeze frames to extract visual context information, such as information characterizing the first pair of earrings as 2-3 cm diameter gold hoops, information characterizing the second pair of earrings as 5-7 cm long colorful drop earrings, and/or information about the user's outfit and hairstyle, which is used to annotate/rewrite the prompt and/or used for further processing. As another example, as described above, system 1000 provides the prompt (e.g., and/or the annotated/rewritten prompt) and different freeze frames to an agent for generating portions of the response. As illustrated in FIG. 10S, system 1000 provides output 1055, a spoken output, “The hoop earrings work best with a high neckline.”

As described with respect to FIGS. 10M-10O, in some embodiments, system 1000 repeats the process described with respect to FIGS. 10Q-10R to capture additional portions of visual context prior to generating the response to input 1050. For example, once system 1000 determines that viewfinder 1018A includes the second pair of earrings, system 1000 updates picture-in-picture 1052 to display a freeze frame of the second pair of earrings (e.g., replacing the freeze frame of the first pair of earrings) or displaying a second picture-in-picture element with the freeze frame concurrently with picture-in-picture 1052 so representations of both portions of visual context are visible. In some embodiments, system 1000 outputs additional viewfinder guidance, instructing the user to provide additional portions of visual context for responding to the prompt and/or providing the user with an option to indicate that all of the intended visual context has been registered. Accordingly, user 1010 can use viewfinder 1018A to show system 1000 multiple discrete portions of visual context while using picture-in-picture 1052 to keep track of previously-registered visual context.

FIG. 10T illustrates user interface 1056 (e.g., a setting user interface) for associating one or more of hardware buttons 1004 with a custom prompt for the visual intelligence experience. For example, as described in further detail with respect to FIGS. 10U-10V, when a custom prompt is associated with one of the hardware buttons 1004, the user can press (e.g., or provide another input via) the hardware button to input the custom prompt to system 1000 to generate a response based on current visual context, providing an alternative to speaking the prompt, typing the prompt, and/or selecting the prompt from a prompt suggestion displayed in viewfinder 1018A. As illustrated in FIG. 10T, system 1000 detects an input, such as input 1058A, input 1058B, and/or input 1058C, requesting to associate the prompt “remind me” with one or more of hardware buttons 1004. For example, user interface 1056 includes a virtual keyboard and text input field, and input 1058A includes inputs typing and selecting to save the prompt “remind me.” As another example, user interface 1056 includes suggested custom prompts, such as prompts provided by the user in previous digital assistant and/or visual intelligence experience sessions and/or prompts recommended based on context information, such as other past interactions, user preferences, and/or trending topics, and input 1058B includes an input selecting “remind me” from the suggested custom prompts. As another example, the user can provide a speech input such as input 1058C via user interface 1056 to associate the associated natural-language prompt with the hardware button. In some embodiments, custom prompts can be associated with hardware buttons 1004 in other ways, such as providing the input “Associate the prompt ‘remind me’ with the top-right button” to the digital assistant.

At FIG. 10U, after associating the prompt “remind me” with at least one hardware button of hardware buttons 1004 (e.g., with the top right button), system 1000 detects input 1060, a press input (e.g., and/or another particular type of hardware button input) directed to the customized hardware button 1004. As illustrated in FIG. 10U, system 1000 detects input 1060 during a digital assistant session with the visual intelligence experience enabled (e.g., while displaying viewfinder 1018A). Accordingly, system 1000 interprets input 1060 as an input of the custom prompt “remind me” and generates a response to input 1060 based on the custom prompt and the visual context represented in viewfinder 1018A when input 1060 is detected.

As illustrated in FIG. 10V, the response to input 1060 includes performing the task of creating a reminder based on the event information (e.g., ticket sale date) written on the poster captured in viewfinder 1018A and providing output 1062, a banner confirming creation of the reminder. For example, system 1000 analyzes the text of the visual context to identify a subject parameter value (e.g., “buy tickets”) and a date parameter value (e.g., the upcoming Friday) and provides the identified parameter values to the reminders application to use in creating the reminder as prompted by input 1060.

In some embodiments, system 1000 interprets input 1060 as an input of the custom prompt “remind me” only when the visual intelligence experience is active and viewfinder 1018A is already displayed. In some embodiments, system 1000 interprets input 1060 as an input of the custom prompt “remind me” as long as a digital assistant session is active, and, in addition to responding to the prompt, launches the visual intelligence experience and displays viewfinder 1018A for the user to show system 1000 the visual context to use for creating the reminder. In some embodiments, system 1000 interprets input 1060 as an input of the custom prompt “remind me” even if a digital assistant session is not active, for instance, automatically launching the digital assistant session and visual intelligence experience in response to respond to the prompt.

FIG. 11 illustrates process 1100 for operating a digital assistant that integrates visual context with application task performance, according to various examples. Process 1100 is performed, for example, using one or more computer systems and/or electronic devices (e.g., 1000) implementing a digital assistant (e.g., including 700, 800, and/or 900). In some examples, process 1100 is performed using a client-server system (e.g., system 100), and the blocks of process 1100 are divided up in any manner between the server (e.g., DA server 106) and a client device. In other examples, the blocks of process 1100 are divided up between the server and multiple client devices (e.g., a mobile phone and a smart watch). Thus, while portions of process 1100 are described herein as being performed by particular devices of a client-server system, it will be appreciated that process 1100 is not so limited. In other examples, process 1100 is performed using only a client device (e.g., user device 104) or only multiple client devices. In process 1100, some blocks are, optionally, combined, the order of some blocks is, optionally, changed, and some blocks are, optionally, omitted. In some examples, additional steps may be performed in combination with the process 1100.

Process 1100 is performed at an electronic device (e.g., 1000) with (e.g., in communication with) a display generation component (e.g., 1002), one or more cameras (e.g., 1006A, 1006B, 1006C, and/or 1006D), one or more processors, and memory. In some embodiments, the electronic device includes one or more input devices and/or sensors, such as one or more hardware buttons (e.g., 1004), a touch-sensitive surface (e.g., of the display generation component and/or the hardware buttons), one or more microphones or other audio sensors, and/or one or more motion sensors. Operating a digital assistant that integrates visual context with application task performance as described herein reduces the number of inputs needed to perform tasks and provides improved visual feedback on a state of the device to a user, which reduces the power usage and improves the battery life of computer systems by enabling the user to use the devices more quickly and efficiently. For example, digital assistants implementing process 1100 provide seamless task performance based on visual context without needing to manually input context information and/or navigate between different user interfaces, while also providing the user with improved feedback on the contextual information used for response generation.

The electronic device displays (1102), via the display generation component, a representation of a feed of camera data from the one or more cameras (e.g., 1018A) (e.g., a user interface that includes a live- or near-live representation of a field-of-view of the one or more cameras; e.g., a viewfinder user interface). In some embodiments, the feed of camera data represented in the viewfinder user interface can be paused (e.g., remaining on a single frame of camera data) and resumed (e.g., displaying frames of camera data as they are captured as a live- or near-live camera feed) (e.g., as further described with respect to process 1200, below). For example, while the representation of the feed of camera data (e.g., 1018A) is in a “live” mode, the electronic device displays a live or near-live representation (e.g., stream) of the field-of-view of the one or more cameras (e.g., pass-through video), such that as the field-of-view of the one or more cameras and/or the portion of the environment captured therein changes, the changes are reflected in the displayed representation (e.g., as described with respect to FIGS. 10H-10L). While the representation of the feed of camera data (e.g., 1018A) is in a “paused” or “freeze frame” mode, changes to the field-of-view of the one or more cameras (e.g., the portion of the environment that is, or would be, captured) are not reflected in the displayed representation, which instead displays a static frame (e.g., as described with respect to FIGS. 10G, 10M, and/or 10O-10P).

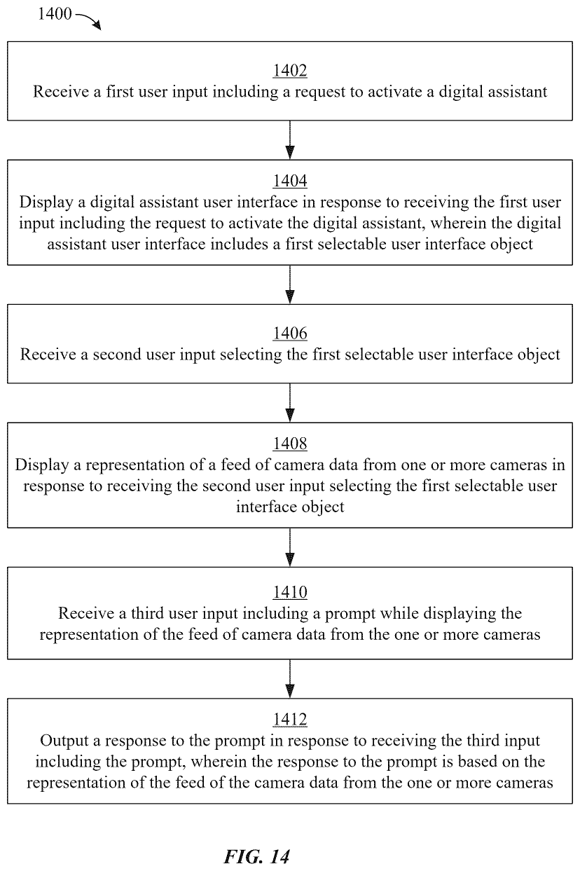

In some embodiments, the representation of the feed of camera data from the one or more cameras is included in a user interface for a digital assistant session (e.g., as described with respect to FIGS. 10C-10E). In some embodiments, the representation of the feed of camera data from the one or more cameras is included in a media capture user interface of a camera application. In some embodiments, the camera application is a different application than the application that executes the task. For example, from within the camera application, a user can invoke a digital assistant session (e.g., as described with respect to FIGS. 10A-10B and 14) and prompt the digital assistant to respond based on visual context viewed in the camera application.

In some embodiments, while displaying, via the display generation component, a respective user interface (e.g., as illustrated in FIGS. 10B-10C), the electronic device receives a respective input requesting the representation of the feed of the camera data from the one or more cameras (e.g., 1016A, 1016B, and/or 1016C). In some embodiments, in response to receiving the respective input, the electronic device displays the representation of the feed of camera data from the one or more cameras while maintaining displaying at least a portion of the respective user interface (e.g., as illustrated in FIG. 10D). For example, the viewfinder user interface is displayed as an overlay of the user interface that was being displayed when the viewfinder was invoked.

While displaying the representation of the feed of the camera data from the one or more cameras, the electronic device detects (1104) a user input (e.g., 1022, 1025A, 1025B, 1028, 1032, 1040A, 1040B, 1046, 1050, and/or 1060) (e.g., a written or spoken prompt, an input selecting an option from the user interface, and/or a button press input; in some embodiments, a digital assistant input). In some embodiments, the user input is a natural-language user input, such as a speech input detected using one or more microphones and/or a written input. For example, a user can input written natural-language inputs by typing using a virtual (e.g., 1038) or physical keyboard, writing longhand using a stylus or touch-sensitive surface, and/or inputting one or more images (e.g., via viewfinder 1018A) of text. In some embodiments, the natural-language user input is pre-processed, for instance, using text-to-speech, optical character recognition, gesture-based character recognition, and/or natural-language processing techniques. In some embodiments, the user input is an input selecting a displayed user interface element (e.g., 1014E, 1014F, 1014G, and/or 1044). In some embodiments, the user input is a button press (e.g., 1060) detected by a hardware button (e.g., as further described with respect to process 1300).

The electronic device determines (1106), based on the camera data from the one or more cameras (in some embodiments, and based on the user input), first visual context information (e.g., as described with respect to FIGS. 9, 10D-10E, and/or 10J-10K). In some embodiments, at least a portion of the first visual context is determined preemptively (e.g., prior to detecting the user input). For example, the electronic device periodically determines (e.g., updates) overall visual context information from the camera data, using image and/or video analysis techniques to track up-to-date information about the field-of-view of the environment displayed in the viewfinder. In some embodiments, at least a portion of the first visual context is determined in response to detecting the user input. For example, the device selects visual context information related to the user input from the overall visual context and/or determines visual context from camera feed data shortly before, during, or after the user input is detected (e.g., the field of view of the one or more cameras represented in the viewfinder when the input is received) and/or determines visual context as part of generating the response to the user input.

In some embodiments, the first visual context is determined using image and/or video analysis techniques (e.g., machine vision and/or other machine learning techniques) to process the field-of-view of the one or more cameras represented in the viewfinder, for instance, identifying (e.g., recognizing) certain objects, types (e.g., classes) of objects, types of visual information (e.g., text, symbols, and/or patterns), environmental features (e.g., landmarks, buildings, pathways, and/or weather conditions), and/or other information about the visible environment captured by the one or more cameras. For example, the visual context determined using image and/or video analysis techniques can be determined with varying levels of specificity and/or detail, for instance, identifying the plant illustrated in FIGS. 10D-10E as a “plant,” a “house plant,” a “potted ficus,” “Ficus benjamina,” “the ficus plant on the kitchen table,” and so forth. In some embodiments, determining the first visual context includes selecting portions of the camera feed data to provide to an external service, such as an application other than the digital assistant and/or a remote service, such as a server-based tool. In some embodiments, the image and/or video analysis is performed by the electronic device and/or a remote computer system. For example, the electronic device performs image and/or video analysis for identifying certain specific types of visual context (e.g., people, animals, plants, places, text, personal effects, and/or other common types of visual context) and/or identifying visual context with a particular level of specificity and/or detail. For example, the remote computer system can be used to perform image and/or video analysis for determining other types of visual context and/or visual context with a different (e.g., higher) level of specificity and/or detail.

In response to detecting the user input, the electronic device provides (1108) a representation of the user input (in some embodiments, a transcription; in some embodiments, a re-written query) and the first visual context information to a digital assistant agent. In some embodiments, first visual context information is provided in addition to other relevant contextual information, such as device context (e.g., connected devices, usage history, user preferences, device capabilities, application context, and/or display context) and/or sensor data (e.g., location data, movement data, biometric data, and/or audio data).

In some embodiments, in response to detecting the user input, the electronic device generates (in some embodiments, using a second digital assistant agent, such as an LLM trained for query interpretation) the representation of the user input based on the first visual context information (e.g., interpreting the user input using the visual context information). In some embodiments, generating the representation of the user input includes disambiguating at least one portion of the user input based on the first visual context information. In some embodiments, generating the representation of the user input includes annotating and/or rewriting the representation of the user input using the first visual context information. In some embodiments, generating the representation of the user input based on the first visual context information includes converting the user input into a rewritten query based on the first visual context information, wherein the representation of the user input includes the rewritten query. In some embodiments, the rewritten query is generated using a respective digital assistant agent, such as an LLM specialized for contextual query rewriting. For example, in response to a spoken user input “What is this?,” the digital assistant agent generates a re-written query “What is this plant?” based on visual context indicating that the viewfinder includes a plant.

In some embodiments, the digital assistant agent includes a large-language model (LLM) (e.g., as described with respect to FIG. 9). In some embodiments, the digital assistant agent includes one or more generative AI models. For example, the digital assistant agent includes an LLM trained for prompt rewriting (e.g., receiving a representation of a user input and rewriting it based on context information, such as the first visual context information). As another example, the digital assistant agent includes a generative AI model for generating a text-based response (e.g., generative text and/or synthesized speech), a visual response (e.g., generative images, video, and/or user interface elements), and/or a response plan (e.g., generative instructions for performing tasks) to the prompt based on context information such as the first visual context information.

The electronic device generates (1110), using the digital assistant agent, a response (e.g., 1014G, 1020, 1024A, 1024B, 1030A, 1030B, 1034A, 1034B, 1042, 1044, 1048D, 1054C, and/or 1062) based on (e.g., at least) the representation of the user input and the first visual context information (e.g., as described with respect to FIGS. 10E-10I, 10K, 10P, and/or 10V). In some embodiments, the digital assistant agent additionally bases the response on the other relevant contextual information. For example, generating the response includes performing (e.g., causing performance of) one or more actions, such as creating a reminder in a reminders application, adding an event to a calendar application, saving contact information to a contacts application, saving a song to a media library, transcribing text into a document, and/or other actions that can be performed by the digital assistant system, applications, and/or other services available to the electronic device; providing one or more audio outputs, such as synthesized speech outputs, sound effects, and/or audio alert sounds; displaying one or more visual outputs, such as displayed text, images, symbols, user interface elements, animations, and/or visual effects; and/or providing other types of outputs, such as tactile (e.g., haptic) outputs. In some embodiments, generating the response includes providing one or more outputs, such as an audio, visual, and/or tactile outputs. In some embodiments, the one or more outputs include an output providing capture guidance, for instance, directing the user to capture additional visual information.

Generating (1110) the response includes selecting (1112) an application intent (e.g., a user request to perform an action/task and/or to provide a particular output; e.g., an intent object) corresponding to the user input. For example, the application intent corresponds to a task that can be performed by an application (e.g., as described with respect to application module 910) that fulfills or partially fulfills a user request, such as an intent for creating a reminder in a reminders application (e.g., corresponding to an input such as “Remind me about this”), an intent for adding contact information to a contacts application (e.g., corresponding to an input such as “Save this” or “Add this to my contacts”), and/or an intent for retrieving information from an application (e.g., corresponding to an input such as “Tell me about this,” “What can I do with this?,” “Compare these,” and so forth). In some embodiments, the application intent is selected based on one or more of the representation of the user input, the first visual context information, and/or the other relevant contextual information.

In some embodiments, selecting the application intent corresponding the user input includes, in accordance with a determination that the first visual context information includes a first type of visual context information, selecting a first candidate intent (e.g., of a set of available application intents, which represent actions the digital assistant can cause applications to perform (e.g., via application module 910)) as the application intent; and in accordance with a determination that the first visual context information includes a second type of visual context information different from the first type of visual context information, selecting a second candidate intent (e.g., of the set of available application intents), different from the first candidate intent, as the application intent (e.g., the application intent is selected based on the visual context). For example, if the visual context information indicates that the camera feed captured textual content in a foreign language, the digital assistant agent selects a translation application intent (e.g., for causing a translation application to perform a translation task), and if the visual context information indicates that the camera feed captured a potted plant, the digital assistant agent selects a gardening application intent. For example, if there are multiple possible intents corresponding to the user input (e.g., “What's wrong with this?” could be requesting houseplant diagnosis, grammatical assistance, help building a piece of furniture, or troubleshooting a cake recipe), the visual context can be used to select the most likely intent (e.g., selecting the houseplant diagnosis intent if viewfinder 1018A includes a plant, selecting the grammatical assistance intent if viewfinder 1018A includes text, and so forth). As another example, the visual context can be used to preemptively rank or narrow down the set of available application intents (e.g., all available application actions) based on relevance to the current visual context.

In some embodiments, generating (1110) the response based on the representation of the user input and the first visual context information includes determining, based on the first visual context information, a set of one or more parameter (e.g., slot) values for performing the task (e.g., parameters of the selected application intent). For example, in response to the input “Tell me about this,” the device identifies one or more objects in the viewfinder and uses an application to search for and/or provide additional information about the one or more objects. For example, in response to the input “Translate this,” the device identifies foreign language text from the viewfinder and provides the foreign language text to a translation application to translate. In some embodiments, determining the set of one or more parameter values for performing the task includes determining a portion of the first visual context information and/or the camera data from the one or more cameras to provide to the application to process further. For example, in response to the input “What is this?,” if the first visual context information indicates that the viewfinder includes one or more plants, the device determines the portion of the camera data to provide to a gardening application to identify the plants.

In some embodiments, the set of one or more parameter values includes a plurality of parameter values. In some embodiments, the set of one or more parameter values includes parameter values for multiple different slots (e.g., as described with respect to FIG. 10V). For example, in response to the input “Add this to her contact” detected while the viewfinder includes a phone number written on a printed photograph, the visual context can be used to identify the contact information to be added (e.g., identifying and extracting the text of the phone number) and the contact to which it should be added (e.g., identifying the person pictured in the printed photograph). In some embodiments, the set of one or more parameter values includes multiple parameter values for a single slot, such as a list or set of snacks to compare, multiple household items to keep track of, multiple plants to identify, and so forth (e.g., as described with respect to FIGS. 10J-10S).

In some embodiments, determining the set of one or more parameter values for performing the task includes determining a first parameter value based on a first portion of the first visual context information, wherein the first portion of the visual context information corresponds to a first image captured in the feed of camera data from the one or more cameras; and determining a second parameter value based on a second portion of the first visual context information, wherein the second portion of the visual context information corresponds to a second image captured in the feed of camera data from the one or more cameras, and the first image and the second image were captured by the one or more cameras at different times. For example, a user can sequentially “show” the viewfinder different pieces of visual context, panning the camera across items to compare (e.g., as described with respect to FIGS. 10L-10O), holding different items up to the camera (e.g., as described with respect to FIGS. 10Q-10S), and/or pointing to different items.

In some embodiments, determining the set of one or more parameter values for performing the task includes determining at least one parameter value based on the first visual context information and additional context information. For example, as described with respect to FIG. 10H, the subject and timing parameter values for creating a reminder are determined based on the visual context (e.g., the ficus tree identified in viewfinder 1018A), the conversational context of the digital assistant (e.g., the previous output, which includes information indicating that ficus plants should be watered twice a week), and/or other contextual information, such as the current date, current humidity conditions (e.g., obtained from a weather application), and/or the user's work schedule (e.g., obtained from a calendar application).

In some embodiments, the additional context information includes gaze information indicating that a gaze of a user is directed to first content included in the feed of the camera data from the one or more cameras, wherein the first content corresponds to the at least one parameter value (e.g., as described with respect to FIG. 10K). For example, in response to the input “What is this?,” if the user is looking at a plant that is detected in the viewfinder, the digital assistant uses a gardening application to search for the plant, and if the user is looking at a food item, the digital assistant uses a cooking or nutrition application to search for the food item.

Generating (1110) the response providing (1114) the application intent to an application, wherein providing the application intent to the application causes the application to execute a task. In some embodiments, the one or more outputs include an output based on a result of the task executed by the application. In some embodiments, the one or more outputs include one or more suggestion outputs, for instance, providing follow-up query suggestions based on the first visual context information and/or the result of the task.

In some embodiments, in response to detecting the user input, the electronic device outputs, based on the user input, a capture guidance indication (e.g., as described with respect to FIGS. 10L-10S) (e.g., an instruction, request, or hint to a user to assist with capturing visual context using the one or more cameras), wherein the first visual context information is based at least in part on camera data from the one or more cameras captured after outputting the capture guidance indication. For example, the digital assistant can ask the user to “show” the digital assistant particular visual context (e.g., different items, features, and/or points of view) for the digital assistant to use in generating a response. For example, the capture guidance indication may include guidance for capturing a sequence of visual context (e.g., the sequential items discussed with respect to FIGS. 10L-10S), guidance for improving the current visual context (e.g., instructing the user to move closer, zoom in, steady the cameras, and/or increase lighting), and/or suggestions of visual context that may be helpful for generating the response (e.g., instructing the user to look for features useful for plant identification, to show both the front and back of a package, and/or to provide additional visual examples).

In some embodiments, while displaying the representation of the feed of the camera data from the one or more cameras (e.g., 1018A), the electronic device displays, via the display generation component, a set of one or more prompt user interface objects associated with one or more prompts (e.g., 1014E, 1014F, 1014G, and/or 1044). In some embodiments, displaying the set of one or more prompt user interface objects includes determining, based on the camera data from the one or more cameras, current visual context information. In some embodiments, the current visual context information includes, overlaps with, and/or is the same as the visual context information used to respond to the user input. In some embodiments, in accordance with a determination that the current visual context information satisfies a first set of one or more suggestion criteria (e.g., if the current visual context information indicates that a first type of visual content is visible in the viewfinder), the electronic device displays a first prompt user interface object associated with a first prompt, and in accordance with a determination that the current visual context information satisfies a second set of one or more suggestion criteria (e.g., if the current visual context information indicates that a second type of visual content is visible in the viewfinder), displaying a second prompt user interface object, associated with a second prompt, that is different from the first prompt user interface object. For example, the electronic device displays prompt suggestion 1014F for providing interior decoration advice if the current visual context information includes visual context related to interior decoration (e.g., the viewfinder shows a room in the user's house, an aisle in a furniture store, and/or a home décor magazine), and displays prompt suggestion 1044 for adding an item to a grocery list if the current visual context information includes visual context related to food or cooking (e.g., the viewfinder shows a food item, a recipe in a cookbook, and/or the interior of the user's fridge).

In some embodiments, the user input includes an input selecting a respective prompt user interface object of the set of one or more prompt user interface objects, and the representation of the user input includes a respective prompt associated with the respective prompt user interface object (e.g., as described with respect to FIGS. 10G-10H). For example, alternatively to typing and/or speaking a prompt, a user can select a suggestion provided by the electronic device to input an associated prompt.

In some embodiments, determining the first visual context information includes: in accordance with a determination that a set of one or more view criteria is satisfied, determining the first visual context information based on first camera data from a first camera of the one or more cameras; and in accordance with a determination that the set of one or more view criteria is not satisfied, determining the first visual context information based on second camera data from a second camera of the one or more cameras that is different from the first camera of the one or more cameras. In some embodiments, the first and second camera face different directions, have different hardware specifications (e.g., lenses, resolutions, aperture sizes, etc.), and/or are positioned differently with respect to the electronic device and/or each other. For example, if the view criteria are met, camera data captured with a user-facing (e.g., selfie) camera is used to determine the visual context (in some embodiments, without capturing and/or using data from an environment-facing camera), and if the view criteria are not met, camera data captured with an environment-facing camera is used to determine the visual context (in some embodiments, without capturing and/or using data from the user-facing camera).

In some embodiments, the set of one or more view criteria includes a criterion that is satisfied based on the user input. For example, the user input is analyzed (e.g., using NLP techniques) to determine which of the cameras' fields-of-view will provide visual context relevant to a prompt or request. For example, as described with respect to FIG. 10Q, the input “Which earrings should I wear?” satisfies a set of view criteria for using fourth camera 1006D (e.g., the rear/selfie camera) because the input relates to an item worn by the user (e.g., indicating that fourth camera 1006D should be used to capture visual context for the response).

In some embodiments, the set of one or more view criteria includes a criterion that is satisfied based on a set of current contextual information. For example, the set of current contextual information includes visual context (e.g., derived from the one or more cameras), historical context (e.g., previous digital assistant prompts, responses, and/or actions), sensor data (e.g., motion data, depth sensor data, audio data, light sensor data, biometric data, or the like), and/or other contextual information. For example, the current contextual information is analyzed to determine which of the cameras' fields-of-view will provide relevant visual context. For example, as described with respect to FIG. 10Q, detecting movement of system 1000 indicating that the user is aiming to capture visual context using fourth camera 1006D (e.g., the user is holding system 1000 up for a selfie shot) satisfies a set of view criteria for using the fourth camera 1006D.

The operations described above with reference to FIG. 11 are optionally implemented by components depicted in FIGS. 1-4G, 6A-6B, 7A-7C, 8, 9, and 10A-10V. For example, the operations of process 1100 may be implemented using digital assistant system 700, foundation system 800, system 900, system 1000, and/or processes 1200, 1300, and/or 1400. It would be clear to a person having ordinary skill in the art how other processes are implemented based on the components depicted in FIGS. 1-4G, 6A-6B, 7A-7C, 8, 9, and 10A-10V.

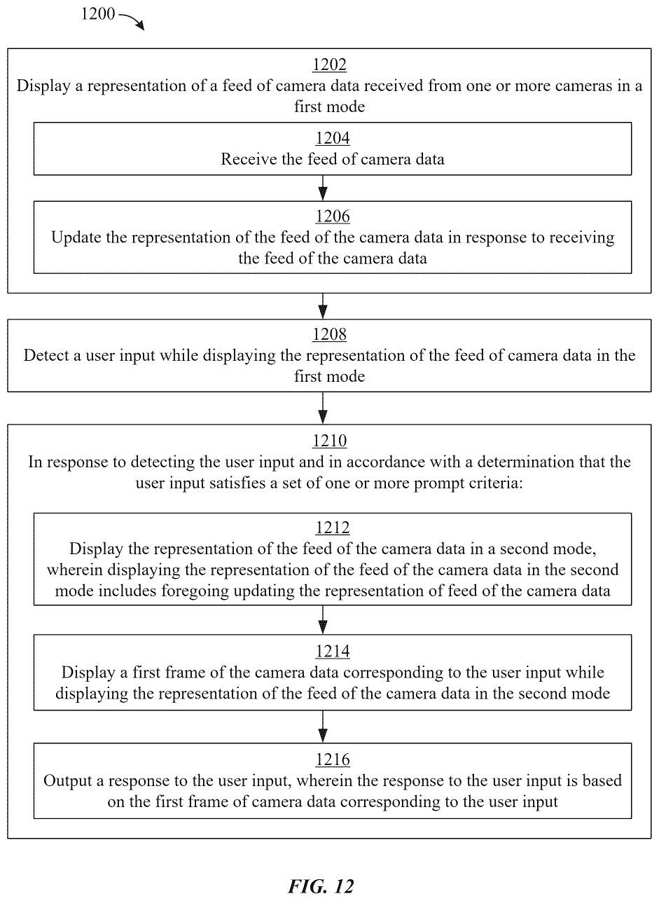

FIG. 12 illustrates process 1200 for controlling a user interface for integrating visual context with a digital assistant, according to various examples. Process 1100 is performed, for example, using one or more computer systems and/or electronic devices (e.g., 1000) implementing a digital assistant (e.g., including 700, 800, and/or 900). In some examples, process 1200 is performed using a client-server system (e.g., system 100), and the blocks of process 1200 are divided up in any manner between the server (e.g., DA server 106) and a client device. In other examples, the blocks of process 1200 are divided up between the server and multiple client devices (e.g., a mobile phone and a smart watch). Thus, while portions of process 1200 are described herein as being performed by particular devices of a client-server system, it will be appreciated that process 1200 is not so limited. In other examples, process 1200 is performed using only a client device (e.g., user device 104) or only multiple client devices. In process 1200, some blocks are, optionally, combined, the order of some blocks is, optionally, changed, and some blocks are, optionally, omitted. In some examples, additional steps may be performed in combination with the process 1200.

Process 1200 is performed at an electronic device (e.g., 1000) (e.g., in communication with) a display generation component (e.g., 1002), one or more cameras (e.g., 1006A, 1006B, 1006C, and/or 1006D), one or more processors, and memory. In some embodiments, the electronic device includes one or more input devices and/or sensors, such as one or more hardware buttons (e.g., 1004), a touch-sensitive surface (e.g., of the display generation component and/or the hardware buttons), one or more microphones or other audio sensors, and/or one or more motion sensors. Controlling a user interface for integrating visual context with a digital assistant as described herein reduces the number of inputs needed to perform tasks and provides improved visual feedback on a state of the device to a user, which reduces the power usage and improves the battery life of computer systems by enabling the user to use the devices more quickly and efficiently. For example, digital assistants implementing process 1100 provide useful and relevant responses based on visual context without needing to manually input context information and/or navigate between different user interfaces, while also providing the user with improved feedback on the visual context information used for generating the responses, improving ease of control and user understanding of the interface.

The electronic device displays (1002), via the display generation component, a representation a feed of camera data received from the one or more cameras (e.g., 1018A) (e.g., a user interface including a representation of a field-of-view of the one or more cameras; e.g., a camera viewfinder user interface) in a first mode (e.g., a live or near-live mode). Displaying (1002) the representation of the feed of camera data in the first mode includes receiving (1204), via the one or more cameras, the feed of the camera data, and, in response to receiving the feed of the camera data, updating (1206) the representation of the feed of the camera data (e.g., as described with respect to FIGS. 10H-10L). For example, as frames of the camera data are received from the one or more cameras, the electronic device successively represents the frames in the viewfinder user interface (e.g., advancing the camera feed). For example, while the representation of the feed of camera data (e.g., 1018A) is in a “live” mode, the electronic device displays a live or near-live representation (e.g., stream) of the field-of-view of the one or more cameras (e.g., pass-through video), such that as the field-of-view of the one or more cameras and/or the portion of the environment captured therein changes, the changes are reflected in the displayed representation (e.g., as illustrated in FIGS. 10H-10L).

While displaying the representation of the feed of camera data in the first mode (e.g., while providing a live- or near-live representation of the field-of-view of the one or more cameras), the electronic device detects (1208) a user input (e.g., 1022, 1025A, 1025B, 1026, 1032, 1036, 1040A, 1040B, 1046, 1050, and/or 1060) (e.g., a written or spoken prompt, an input selecting an option from the user interface, and/or a button press input; in some embodiments, a digital assistant input).

In response to detecting the user input and in accordance with a determination that the user input satisfies a set of one or more prompt criteria (1210), the electronic device displays (1212) the representation of the feed of the camera data in a second mode (e.g., a pause or freeze-frame mode), wherein displaying the representation of the feed of the camera data in the second mode includes foregoing updating the representation of feed of the camera data (e.g., as illustrated in FIGS. 10G, 10M, and/or 10O) (e.g., pausing the feed of camera data on the first frame). For example, while the representation of the feed of camera data (e.g., 1018A) is in a “paused” or “freeze frame” mode, changes to the field-of-view of the one or more cameras (e.g., the portion of the environment that is, or would be, captured) are not reflected in the displayed representation, which instead displays a static frame (e.g., as described with respect to FIGS. 10G, 10M, and/or 10O-10P). In some embodiments, the prompt criteria are satisfied when the user input includes a prompt related to the feed of camera data (e.g., as described with respect to FIGS. 10F-10G) (e.g., a prompt related to visual and/or environmental information, e.g., “Look at this,” “What is this plant?” or “Where am I?”). In some embodiments, the prompt criteria are satisfied when the user input is directed to a digital assistant (e.g., an input invoking and/or controlling a digital assistant, e.g., “Hey Assistant,” “Assistant, look at this,” selecting a suggested prompt “What is this plant?,” and/or pressing a hardware button associated with a digital assistant prompt). In some embodiments, the prompt criteria are satisfied when the user input includes a selection (e.g., 1026) of a pause user interface object (e.g., 1018B) displayed with the representation of the feed of the camera data (e.g., as described with respect to FIGS. 10F-10G). In some embodiments, the prompt criteria are satisfied when the user input includes a selection of another user interface object for interacting with the representation of the feed of the camera data, such as a selection of an option for inputting text prompts (e.g., 1014A), an option for a suggested prompt (e.g., 1014E, 1014F, 1014G, and/or 1044), and/or a hardware button for inputting a prompt.

In some embodiments, the set of one or more prompt criteria includes a criterion that is satisfied when the user input includes a prompt that is related to the feed of the camera data (e.g., as described with respect to FIGS. 10F-10G). In some embodiments, the computer system uses natural-language processing techniques to determine whether user inputs including natural-language prompts (e.g., a text or speech prompt) are related to the feed of the camera data, e.g., determining whether the prompt relates to recent or current visual context; includes words such as “look,” “here,” “this,” “these,” and/or other contextual references; and/or requires disambiguation using the visual context. In some embodiments, the user input includes a prompt that is related to the feed of the camera data when the user input includes inputs directed to the viewfinder user interface, such as selection of a suggested prompt and/or entry of text via an input field of the viewfinder user interface.

In some embodiments, the set of one or more prompt criteria includes a criterion that is satisfied when the user input is directed to a digital assistant of the electronic device. For example, the user input is directed to a digital assistant if the user input includes a digital assistant trigger (e.g., a particular utterance, hardware button input, touch input, gesture input, gaze input, and/or other input associated with initiating a digital assistant session) and/or if the user input is received while a digital assistant session is active on the electronic device (e.g., if the user previously provided a digital assistant trigger; in some embodiments, if a digital assistant user interface and/or user interface object is displayed when the user input is received).

In some embodiments, displaying the representation of the feed of the camera data in the second mode includes displaying an animation that temporarily changes an appearance of the representation of the feed of camera data from the one or more cameras (e.g., as described with respect to FIGS. 10M and/or 10O) (e.g., without updating the representation of the feed of camera data to advance to a subsequent frame). In some embodiments, the animation includes a flash or shutter animation (e.g., temporarily obscuring the viewfinder).

In response to detecting the user input and in accordance with a determination that the user input satisfies a set of one or more prompt criteria (1210), while displaying the representation of the feed of the camera data in the second mode, the electronic device displays (1214), via the display generation component, a first frame of the camera data (e.g., a freeze frame) corresponding to the user input (e.g., as illustrated in FIGS. 10G, 10M, and/or 10O-10P) (e.g., a frame of camera data received near in time to the user input, e.g., before, during, or after detecting the user input).

In some embodiments, while displaying the first frame of the camera data (in some embodiments, and while displaying the representation of the feed of the camera data in the second mode, e.g., while the viewfinder is paused), the electronic device displays, via the display generation component, an indication of first visual content (e.g., one or more items) included (e.g., visible) in the first frame of the camera data (e.g., as described with respect to FIGS. 10G and/or 10P). In some embodiments, the electronic device visually emphasizes one or more recognized content items within the viewfinder. For example, portions of the viewfinder including recognized content items are displayed with border effects, fill effects, tags, and/or labels, and/or the portions of the viewfinder that do not include recognized content items are darkened, dimmed, and/or faded to make the recognized content items stand out.

In some embodiments, the indication of the first visual content included in the first frame of the camera data includes an animation that changes an appearance of the first visual content included in the first frame of the camera data. In some embodiments, the indication of the first visual content included in the first frame of the camera data includes a visual element (e.g., a label, badge, icon, border, fill effect, and/or selectable user interface object) displayed at a location corresponding to (e.g., at, near, overlaying, on the same side as, and/or otherwise corresponding to) a respective location of the first visual content within the first frame of the camera data. For example, portions of the viewfinder including recognized content items are displayed with an animated edge glow, such as a soft, light border displayed around the edges of the item in the viewfinder that pulses, cycles, and/or shifts to produce an animated lighting effect. For example, portions of the viewfinder including recognized content items are displayed with a shimmer fill effect, such as an animation of a lighting effect shifting across the “surface” of the recognized content item within the viewfinder.

In response to detecting the user input and in accordance with a determination that the user input satisfies a set of one or more prompt criteria (1210), the electronic device outputs (1216) a response to the user input (e.g., 1024A, 1024B, 1030A, 1030B, and/or 1048D) (e.g., one or more audio, visual, and/or tactile outputs), wherein the response to the user input is based on the first frame of camera data corresponding to the user input (in some embodiments, and/or other contextual information, including frames of camera data from the feed that are not being displayed). In some embodiments, the device determines visual context information from the first frame of camera data using image analysis techniques, for instance, identifying objects and/or other environmental features present in the paused camera feed. In some embodiments, the response includes an output based on a result of a task executed by an application using the first visual context. In some embodiments, the response includes an output providing capture guidance, for instance, directing the user to capture additional visual information. In some embodiments, the response includes one or more suggestion outputs, for instance, providing query suggestions based on the freeze frame.

In some embodiments, in accordance with a determination that the user input satisfies a second set of one or more prompt criteria and after displaying the first frame of the camera data corresponding to the user input (in some embodiments, and while displaying the representation of the feed of the camera data in the second mode, e.g., while the camera feed is paused), the electronic device displays, via the display generation component, a second frame of the camera data corresponding to the user input (e.g., as described with respect to FIGS. 10K-10S). For example, the device displays multiple freeze frames (e.g., in series and/or simultaneously, for instance, as picture-in-picture freeze frames) relevant to responding to a single prompt. In some embodiments, the second frame is another frame of camera data received near in time to the user input, e.g., before, during, or after detecting the user input. In some embodiments, the second frame is captured by the one or more cameras in response to the user input. In some embodiments, while displaying the representation of the feed of the camera data in the second mode and after displaying the second frame, the electronic device displays one or more additional frames of camera data corresponding to the user input. In some embodiments, the electronic device determines, based on the second frame of the camera data corresponding to the user input, second visual context information, wherein the response to the user input is further based on the second visual context information (e.g., as described with respect to FIGS. 10P and/or 10S). In some embodiments, the response to the user input is further based on the one or more additional frames of camera data corresponding to the user input.

In some embodiments, the second set of one or more prompt criteria includes a criterion that is satisfied when the user input relates to a set of two or more items (e.g., a list or set of snacks to compare, multiple household items to keep track of, multiple plants to identify, and so forth). For example, the criterion is satisfied if the user input refers to multiple items (e.g., “them,” “these,” “these plants,” “these two snacks,” “these four pairs of earrings,” etc.). In some embodiments, the second set of one or more prompt criteria includes a criterion that is satisfied when the electronic device determines that the first frame of camera data does not include a portion of visual context related to the user input (e.g., when the system determines that additional or different visual information may be useful or necessary to respond to the user input). For example, the criterion is satisfied if the electronic device identifies that additional visual information, such as another visual example and/or another point of view or angle of a subject, is needed or would be useful to supplement the visual information provided by the first frame.

In some embodiments, in accordance with the determination that the user input satisfies the second set of one or more prompt criteria and at a respective time after displaying the first frame of the camera data corresponding to the user input, the electronic device displays the representation of the feed of the camera data in the first (e.g., live or near-live) mode (e.g., as described with respect to FIG. 10N) (e.g., resuming the live- or near-live camera feed view, e.g., un-pausing the viewfinder), wherein the second frame of the camera data is received, via the one or more cameras, after the respective time (e.g., as described with respect to FIG. 10O) (e.g., the second frame is captured after resuming/un-pausing the camera feed). For example, the computer system resumes the live- or near-live camera feed in between freeze frames to capture individual freeze frames in series. In some embodiments, the computer system automatically displays the representation of the feed of the camera data in the first mode (e.g., advances the camera feed) after displaying a freeze frame, e.g., after a predetermined period of time and/or after the freeze frame has been analyzed to determine visual context. In some embodiments, the electronic device does not switch back to the first (e.g., live or near-live) mode. For example, the user can pan across multiple items and/or capture images for a period of time prior to pausing, and the electronic device extracts the first frame, the second frame, and/or any additional freeze frames from the camera data captured prior to pausing.

In some embodiments, in accordance with the determination that the user input satisfies the second set of one or more prompt criteria and after displaying the first frame of the camera data corresponding to the user input (e.g., shortly before, at, and/or after the respective time), the electronic device outputs a capture guidance indication (e.g., 1048A and/or 1048B), wherein the second frame of the camera data corresponding to the user input is captured, via the one or more cameras, after outputting the capture guidance indication. For example, in addition to resuming/un-pausing the camera feed, the computer system provides an audio, display, and/or tactile indication to instruct and/or guide the user to capture the second frame of visual context. For example, the output includes a voice output such as “Ok, next one?” or “Show me the next snack,” a tactile output such as a haptic vibration, and/or a displayed capture guidance indication, such as a text badge reading “next.”

In some embodiments, the second set of one or more prompt criteria includes a criterion that is satisfied when the user input relates to two or more items (e.g., as described with respect to FIG. 10K) (e.g., multiple intents and/or intent parameters). For example, a user input corresponding to an intent to compare items (e.g., “What's the healthiest snack?” or “Which of these is better?”), an intent to compile a list or set of items (e.g., “Add these to my grocery list” or “Keep track of these”), an intent to perform an operation with respect to a plurality of items (e.g., “Translate these” or “Set up reminders for everything”), and/or a compound intent to perform different operations with respect to different items (e.g., “Add this to my calendar and set up a watering schedule for my plants”). In some embodiments, the computer system uses natural-language processing techniques to determine whether user inputs including natural-language prompts (e.g., a text or speech prompt) are related to two or more items. In some embodiments, the computer system uses visual context determined from the feed of camera data (e.g., the first visual context information) to determine whether the input is related to two or more items, e.g., identifying multiple relevant items from recent or current camera data.

In some embodiments, outputting the response to the user input is performed while displaying (e.g., continuing to display) the representation of the feed of the camera data in the second mode (e.g., while the viewfinder is paused) and displaying (e.g., continuing to display) the first frame of the camera data (e.g., as described with respect to FIGS. 10G and/or 10P). For example, while responding to the user input, the viewfinder remains paused on the visual content used to generate the response. In some embodiments, while outputting the response to the user input, the electronic device displays the representation of the feed of the camera data in the first mode (e.g., as described with respect to FIG. 10H) (e.g., resuming the live- or near-live camera feed view, e.g., un-pausing the viewfinder). For example, while responding to the user input, the electronic device automatically un-freezes the viewfinder.

In some embodiments, while outputting the response to the user input and displaying the representation of the feed of the camera data in the first mode, the electronic device displays (e.g., continues to display) the first frame of the camera data (e.g., as described with respect to FIG. 10S). In some embodiments, when reverting to displaying the representation of the feed of the camera data in the first mode (e.g., un-pausing the viewfinder), the electronic device updates the appearance of the first frame of the camera data, for example, rescaling and/or moving the first frame of the camera data to appear as a picture-in-picture view of the freeze frame overlaying the live- or near-live viewfinder.

In some embodiments, while displaying the first frame of the camera data, the electronic device detects a second user input (e.g., 1028A and/or 1028B), and in response to detecting the user input, the electronic device outputs a second response to the second user input, wherein the second response to the second user input is based on the first frame of camera data (e.g., as described with respect to FIGS. 10G-10H). For example, while the viewfinder is paused on a freeze frame, the user can provide follow up prompts to interact further with the visual context represented in the freeze frame, asking additional questions (e.g., “Tell me more about ficus plants”), requesting follow-up tasks (e.g., “Remind me about that”), and/or interacting with a different portion of the visual context represented in the freeze frame (e.g., “Now tell me where to find similar pots”).

The operations described above with reference to FIG. 12 are optionally implemented by components depicted in FIGS. 1-4G, 6A-6B, 7A-7C, 8, 9, and/or 10A-10V. For example, the operations of process 1200 may be implemented using digital assistant system 700, foundation system 800, system 900, system 1000, and/or processes 1100, 1200, and/or 1300. It would be clear to a person having ordinary skill in the art how other processes are implemented based on the components depicted in FIGS. 1-4G, 6A-6B, 7A-7C, 8, 9, and/or 10A-10V.

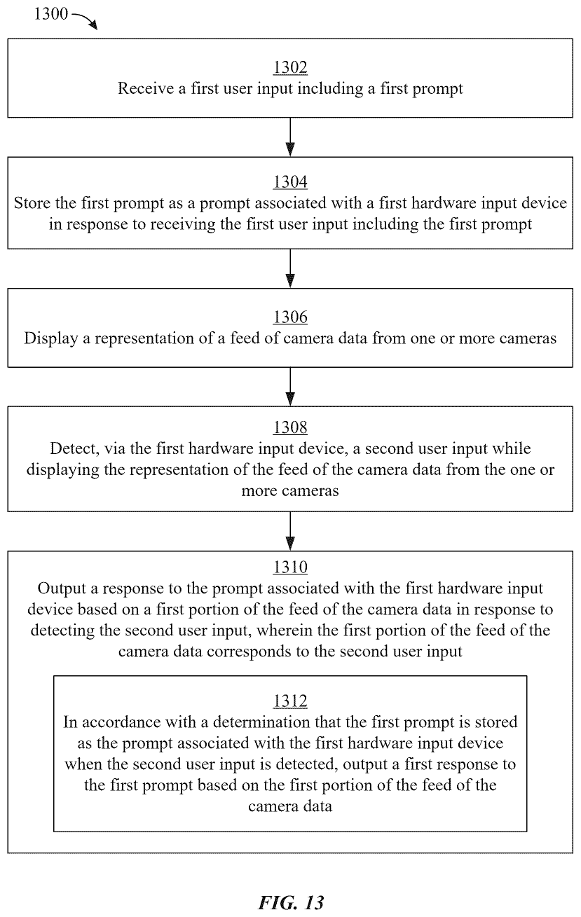

FIG. 13 illustrates process 1300 for controlling a digital assistant that integrates visual context using hardware button inputs, according to various examples. Process 1300 is performed, for example, using one or more computer systems and/or electronic devices (e.g., 1000) implementing a digital assistant (e.g., including 700, 800, and/or 900). In some examples, process 1300 is performed using a client-server system (e.g., system 100), and the blocks of process 1300 are divided up in any manner between the server (e.g., DA server 106) and a client device. In other examples, the blocks of process 1100 are divided up between the server and multiple client devices (e.g., a mobile phone and a smart watch). Thus, while portions of process 1300 are described herein as being performed by particular devices of a client-server system, it will be appreciated that process 1300 is not so limited. In other examples, process 1300 is performed using only a client device (e.g., user device 104) or only multiple client devices. In process 1300, some blocks are, optionally, combined, the order of some blocks is, optionally, changed, and some blocks are, optionally, omitted. In some examples, additional steps may be performed in combination with the process 1300.

Process 1300 is performed at an electronic device (e.g., 1000) with (e.g., in communication with) a display generation component (e.g., 1002), one or more cameras (e.g., 1006A, 1006B, 1006C, and/or 1006D), one or more hardware input devices (e.g., 1004), one or more processors, and memory. In some embodiments, the electronic device includes one or more other input devices and/or sensors, such as a touch-sensitive surface (e.g., of the display generation component), one or more microphones or other audio sensors, and/or one or more motion sensors. Controlling a digital assistant that integrates visual context using hardware button inputs as described herein reduces the number of inputs needed to perform tasks and provides improved control of digital assistant systems without cluttering the display, which reduces the power usage and improves the battery life of computer systems by enabling the user to use the devices more quickly and efficiently. For example, digital assistants implementing process 1300 provide useful and relevant responses in response to button presses without needing to display additional controls or requiring the user to manually input prompts and/or context information.

The electronic device (e.g., 1000) receives (1302) a first user input (e.g., 1016C, 1022, 1028, 1032, 1046, 1050, 1058A, 1058B, and/or 1058C) including (e.g., specifying and/or defining) a first prompt (e.g., as described with respect to FIG. 10T). In response to receiving the first user input including the first prompt, the electronic device stores (1304) the first prompt as a prompt associated with a first hardware input device (e.g., a hardware button) of the one or more hardware input devices (e.g., as described with respect to FIG. 10T). In some embodiments, the first user input is received via a user interface for selecting, defining, and/or otherwise specifying custom prompts to associate with a hardware button (e.g., a setup user interface), such as described with respect to FIG. 10T. In some embodiments, the first user input is received via another user interface, such as the viewfinder user interface and/or a digital assistant user interface. For example, while displaying the viewfinder user interface (1018A) and/or a digital assistant session (e.g., as described with respect to FIG. 10B), the electronic device provides an option to “save” prompts provided during the digital assistant session to use later via the first hardware button.

In some embodiments, the first user input includes a first natural-language input (e.g., natural-language speech and/or text) specifying the first prompt. In some embodiments, storing the first prompt includes determining a representation of the first natural-language input, e.g., transcribing, tokenizing, rewriting, and/or marking up/annotating the language of the first natural-language input to store as the prompt associated with the hardware button. For example, a user can speak, type, or write a fully customized prompt to associate with the hardware button, from simple questions and commands (e.g., “Remind me,” “Look at this,” “What is this?”) to more complex natural-language queries (e.g., “Look at this and add bulleted notes about it to my digital journal,” “Generate visual identity information for this object and begin tracking its location using camera data,” “Identify all pictured ingredients and generate a recipe for them that doesn't involve going to the store,” and so forth). In some embodiments, the first user input includes a selection of a candidate prompt and/or action (e.g., task) provided (e.g., suggested) by the electronic device and/or the digital assistant system. For example, selecting a button, menu item, and/or other user interface object for the suggested action of creating a new calendar event in a calendar application (e.g., an “add to calendar” suggestion) stores a corresponding natural-language prompt that can be provided to a digital assistant agent (e.g., as described with respect to process 1100) to trigger the action.

The electronic device displays (1306), via the display generation component, a representation of a feed of camera data from the one or more cameras (e.g., 1018A) (e.g., a user interface including a live- or near-live representation of a field-of-view of the one or more cameras; e.g., a camera viewfinder user interface). In some embodiments, the viewfinder user interface can be paused (e.g., remaining on a single frame of camera data) and resumed (e.g., displaying frames of camera data as they are captured as a live- or near-live camera feed), as described above with respect to FIGS. 10A-10V and processes 1100 and 1200.

While displaying the representation of the feed of the camera data from the one or more cameras (e.g., as described with respect to FIG. 10U), the electronic device detects (1308), via the first hardware input device, a second user input (e.g., 1060) (e.g., a button press input; in some embodiments, a press input with certain characteristics, such as a light press, a long press, and/or a double-press).

In response to detecting the second user input, the electronic device outputs (1310) a response (e.g., 1014G, 1020, 1024A, 1024B, 1030A, 1030B, 1034A, 1034B, 1042, 1044, 1048D, 1054C, and/or 1062) to the prompt associated with the first hardware input device based on a first portion of the feed of the camera data, wherein the first portion of the feed of the camera data corresponds to the second user input (e.g., as described with respect to FIG. 10V) (e.g., one or more frames of camera data received near in time to the second user input, e.g., before, during, or after detecting the button press). For example, when a prompt is associated with the first hardware input device, a press input of the first hardware input device inputs the associated prompt in the same way that speaking, writing, typing, and/or selecting a prompt suggestion associated with the prompt would input the prompt (e.g., a button press can act as a substitute for other types of inputs). In some embodiments, if the user has not previously set up a custom prompt to associate with the first hardware input device, the first hardware input device is associated with a default prompt, such as “Look at this.”

Outputting (1310) the response to the prompt associated with the first hardware input device includes, in accordance with a determination that the first prompt is stored as the prompt associated with the first hardware input device when the second user input is detected (e.g., if the first prompt was associated with the hardware button prior to detecting the button press), outputting (1312) a first response to the first prompt (e.g., one or more audio, visual, and/or tactile outputs) based on the first portion of the feed of the camera data (e.g., as described with respect to FIGS. 10U-10V). In some embodiments, the first response to the first prompt is determined based on the portion of the camera data using image analysis techniques, for instance, identifying objects and/or other environmental features present in the field-of-view of the one or more cameras when the user presses the hardware button. In some embodiments, the one or more outputs include an output based on a result of a task executed by an application using the visual context of the portion of the camera data. In some embodiments, the one or more outputs include an output providing capture guidance, for instance, directing the user to capture additional visual information. In some embodiments, the one or more outputs include one or more suggestion outputs, for instance, providing query suggestions based on the portion of the camera data. In some embodiments, in accordance with a determination that another prompt is stored as the prompt associated with the first hardware input device when the second user input is detected, the device outputs a response to the other prompt based on the first portion of the camera data.

In some embodiments, the first portion of the feed of the camera data includes a set of camera data that was captured within a threshold period of time (e.g., 0.05 s, 0.2 s, 0.5 s, 1 s, and/or 3 s) of detecting the second user input (e.g., shortly before, during, and/or after detecting the button press). For example, pressing the button provides a response to the previously-stored prompt based on the currently-visible environment.

In some embodiments, outputting the first response to the first prompt based on the first portion of the camera data from the one or more cameras includes determining an intent (e.g., a user request to perform an action/task and/or to provide a particular output; in some embodiments, an intent object, such as an application intent) associated with the first prompt (e.g., as described with respect to process 1100). In some embodiments, the intent associated with the first prompt is determined using NLP techniques. In some embodiments, the intent associated with the first prompt is determined using a digital assistant agent (e.g., a plan generator). In some embodiments, the intent associated with the first prompt is determined prior to outputting the first response, e.g., the intent is predetermined and stored with the first prompt. For example, the intent to create a new reminder in a reminders application is stored along with the custom prompt “Remind me” in association with the first hardware input device. In some embodiments, the intent associated with the first prompt is determined based on the first portion of the camera data from the one or more cameras, e.g., the intent is at least partially determined at the time the user invokes the custom prompt with the first hardware input device. For example, the electronic device determines whether the custom prompt “Add this” is associated with an intent to add a calendar event, an intent to add a contact item, an intent to add text to a note, and/or another corresponding intent based on whether the viewfinder is “looking at” event information, contact information, text, and/or another form of visual context when the button press is detected.

In some embodiments, outputting the first response to the first prompt based on the first portion of the camera data from the one or more cameras includes causing performance of a task associated with the intent based on the first portion of the camera data from the one or more cameras. In some embodiments, the intent associated with the first prompt includes an application intent, and causing performance of the task associated with the intent based on the first portion of the camera data from the one or more cameras includes providing the application intent (e.g., intent object) to an application (e.g., as discussed with respect to process 1100). In some embodiments, causing performance of the task associated with the intent includes providing the application with the first portion of the camera data from the one or more cameras and/or visual context information derived from the first portion of the camera data from the one or more cameras. For example, as discussed with respect to process 1100, the electronic device identifies parameter values from the first portion of the camera data from the one or more cameras and/or visual context information derived from the first portion of the camera data from the one or more cameras to cause the application to perform the task using the identified parameter values, such as creating a reminder with a subject and timing based on the current visual context, adding a calendar event with title, location, and/or time information based on the current visual context, and/or comparing multiple items shown in the viewfinder.

In some embodiments, the intent associated with the first prompt includes an information intent (e.g., a knowledge-seeking intent), and causing performance of the task associated with the intent based on the first portion of the camera data from the one or more cameras includes obtaining information based on the first portion of the camera data from the one or more cameras (e.g., identifying and/or searching for visual content detected in the first portion of the camera data), wherein the first response to the first prompt includes the obtained information. For example, the task includes performing further image and/or video processing on the first portion of the camera data from the one or more cameras (e.g., identifying and/or refining an identification of a content item in the viewfinder), retrieving additional information based on the image and/or video processing results (e.g., searching for the recognized content item and/or obtaining additional context information related to the recognized content item), and/or generating content based on the processing results and/or additional information.

In some embodiments, outputting the first response to the first prompt includes determining, based on the portion of the camera data that corresponds to the second user input, a set of one or more parameter values for the first response. In some embodiments, outputting the first response to the first prompt includes causing performance of a first task using at least one of the one or more parameter values. For example, as illustrated in FIGS. 10U-10V, the electronic device determines the subject and timing of the new reminder to create based on the text pictured in viewfinder 1018A when button press input 1060 is detected, and accordingly creates a reminder with the subject “Buy tickets” for the upcoming Friday.

In some embodiments, in response to detecting the second user input, the electronic device provides the first prompt and the portion of the camera data that corresponds to the second user input to a digital assistant agent and generates, using the digital assistant agent, at least a portion of the first response to the first prompt (e.g., as described with respect to FIG. 9 and process 1100). In some embodiments, the digital assistant agent uses the current camera data to re-write and/or annotate the custom prompt, for example, re-writing “Remind me” to “Remind me to buy tickets this Friday” based on the visual context illustrated at FIG. 10U, “Remind me to return my library books” based on the visual context illustrated at FIG. 10I, “Remind me to water the ficus plant” based on the visual context illustrated in FIG. 10G, and so forth. In some embodiments, the digital assistant agent uses the current camera data as context for a generative response to the prompt. For example, for the custom prompt “Take notes on this,” the current camera data is provided to a digital assistant agent to analyze and generate descriptive text (e.g., using machine vision, an LLM, and/or a generative AI model).

In some embodiments, the electronic device receives a respective user input including (e.g., specifying and/or defining) a second prompt that is different from the first prompt and, in response to receiving the respective user input including the second prompt, stores the second prompt as the prompt associated with the first hardware input device (e.g., hardware button) of the one or more hardware input devices. In some embodiments, the respective user input is received via a setup user interface for custom prompts, as illustrated in FIG. 10T. In some embodiments, outputting the response to the prompt associated with the first hardware input device includes, in accordance with a determination that the second prompt is stored as the prompt associated with the first hardware input device when the second user input is detected, outputting a second response to the second prompt based on the first portion of the camera data from the one or more cameras. For example, the user can associate different, customized prompts with the hardware button, such that pressing the button provides different responses to visual context depending on the currently-associated customized prompt. For example, if the user associates the custom prompt “Compare these” with the first hardware button, pressing the first hardware button prompts the electronic device to respond as described with respect to FIGS. 10J-10S based on the current visual context represented in the viewfinder.

In some embodiments, after outputting the response to the prompt associated with the first hardware input, the electronic device detects, via the first hardware input device, a third user input (e.g., another button press). In some embodiments, in response to detecting the third user input, outputting a respective response to the prompt associated with the first hardware input device (e.g., the currently-stored prompt) based on a second portion of the camera data from the one or more cameras that is different from the first portion of the camera data from the one or more cameras (in some embodiments, the second portion of the camera data is detected after the first portion of the camera data), wherein the second portion of the camera data from the one or more cameras corresponds to the third user input (e.g., one or more frames of camera data received near in time to the second user input, e.g., before, during, or after detecting the button press). For example, the user can prompt the device using repeated button presses to cause the electronic device to provide different and/or updated responses to the same prompt based on the current visual context (e.g., setting different reminders, comparing different sets of items, retrieving different information, and so forth).

In some embodiments, while the viewfinder user interface including the feed of the camera data from the one or more cameras is not displayed (e.g., as illustrated in FIGS. 10B-10C), the electronic device detects, via the first hardware input device, a fourth user input (e.g., 1008B and/or 1016B) (e.g., a button press), and, in response to detecting the fourth user input, the electronic device displays, via the display generation component, the representation of the feed of camera data from the one or more cameras (e.g., 1018A). For example, pressing the button while the viewfinder user interface is displayed inputs the associated prompt, and pressing the button while the viewfinder user interface is not displayed opens the viewfinder user interface. For example, rather than merely launching a digital assistant session as described with respect to FIGS. 10B-10C, the electronic device launches the digital assistant session with viewfinder 1018A (e.g., as illustrated in FIGS. 10D-10E) in response to button press input 1008B (e.g., without requiring the user to manually select vision mode object 1014B).

In some embodiments, in response to detecting the fourth user input, outputting a respective response to the prompt associated with the first hardware input device based on a third portion of the camera data from the one or more cameras, wherein the third portion of the camera data from the one or more cameras corresponds to the fourth user input (e.g., one or more frames of camera data received near in time to the second user input, e.g., before, during, or after detecting the button press). For example, rather than rather than merely launching a digital assistant session as described with respect to FIGS. 10B-10C, the electronic device launches the digital assistant session with viewfinder 1018A (e.g., as illustrated in FIGS. 10D-10E) and automatically inputs the current custom prompt in response to button press input 1008B, providing a response based on the camera data when the button is pressed. For example, rather than merely displaying viewfinder 1018A in response to button press input 1016B as described with respect to FIGS. 10C-10E, the electronic device launches viewfinder 1018A and automatically provides a response to the current custom prompt based on the displayed visual context (e.g., without requiring the user to wait until viewfinder 1018A is open to start interacting with visual context in the environment).

The operations described above with reference to FIG. 13 are optionally implemented by components depicted in FIGS. 1-4G, 6A-6B, 7A-7C, 8, 9, and 10A-10V. For example, the operations of process 1100 may be implemented using digital assistant system 700, foundation system 800, system 900, system 1000, and/or processes 1100, 1200, and/or 1400. It would be clear to a person having ordinary skill in the art how other processes are implemented based on the components depicted in FIGS. 1-4G, 6A-6B, 7A-7C, 8, 9, and 10A-10V.

FIG. 14 illustrates process 1400 for controlling a user interface for a digital assistant that integrates visual context, according to various examples. Process 1400 is performed, for example, using one or more computer systems and/or electronic devices (e.g., 1000) implementing a digital assistant (e.g., including 700, 800, and/or 900). In some examples, process 1400 is performed using a client-server system (e.g., system 100), and the blocks of process 1400 are divided up in any manner between the server (e.g., DA server 106) and a client device. In other examples, the blocks of process 1400 are divided up between the server and multiple client devices (e.g., a mobile phone and a smart watch). Thus, while portions of process 1400 are described herein as being performed by particular devices of a client-server system, it will be appreciated that process 1400 is not so limited. In other examples, process 1100 is performed using only a client device (e.g., user device 104) or only multiple client devices. In process 1100, some blocks are, optionally, combined, the order of some blocks is, optionally, changed, and some blocks are, optionally, omitted. In some examples, additional steps may be performed in combination with the process 1400.

Process 1400 is performed at an electronic device (e.g., 1000) with (e.g., in communication with) a display generation component (e.g., 1002), one or more cameras (e.g., 1006A, 1006B, 1006C, and/or 1006D), one or more processors, and memory. In some embodiments, the electronic device includes one or more input devices and/or sensors, such as one or more hardware buttons (e.g., 1004), a touch-sensitive surface (e.g., of the display generation component and/or the hardware buttons), one or more microphones or other audio sensors, and/or one or more motion sensors. Controlling a user interface for a digital assistant that integrates visual context as described herein reduces the number of inputs needed to perform tasks and provides improved visual feedback to the user about a state of the electronic device, which reduces the power usage and improves the battery life of computer systems by enabling the user to use the devices more quickly and efficiently. For example, digital assistants implementing process 1400 provide users with an intuitive and efficient way to provide visual context to use in generating responses, which reduces the time and number of inputs needed to obtain relevant and useful responses.

The electronic device (e.g., 1000) receives (1402) a first user input (e.g., 1008A and/or 1008B) (e.g., a touch input, a hardware button input, a speech input, a gesture input, a gaze input, and/or a typed input) including a request to activate a digital assistant (e.g., as described with respect to FIG. 10B).

In some embodiments, the electronic device includes one or more hardware input devices, and the first user input including the request to activate the digital assistant includes a first press input (e.g., 1008B) directed to a first hardware input device of the one or more hardware input devices (1004). In some embodiments, the first user input includes a particular type of button press, such as a button press of a particular duration (e.g., a long or short button press), a particular intensity (e.g., a light or hard press), a particular pattern (e.g., a double press, a triple press, a short press followed by a long press, and/or another combination of multiple presses), and/or a button press directed to a specific button (e.g., a button associated with the digital assistant). For example, the hardware input device can be pressed to invoke the digital assistant user interface. In some embodiments, the first press input is a particular type of input, such as a long press and/or a full/hard press.

In some embodiments, the first user input including the request to activate the digital assistant includes a spoken user input (e.g., 1008A) (e.g., a natural-language input; in some embodiments, a speech input including a digital assistant trigger). For example, the first user input includes a speech input, such as a speech input including a trigger word or phrase for the digital assistant (e.g., “Hey Assistant,” “Assistant,” “Ok Assistant,” and/or another preset and/or custom trigger) and/or a natural-language request corresponding to the digital assistant (e.g., a request that the digital assistant determines it can assist the user with and/or a request that the digital assistant determines relates to the current device context).

In response to receiving the first user input including the request to activate the digital assistant, the electronic device displays (1404), via the display generation component, a digital assistant user interface (e.g., as illustrated in FIG. 10C), wherein the digital assistant user interface includes a first selectable user interface object (e.g., 1014B) (e.g., a software button/affordance for invoking a viewfinder for providing visual input to the digital assistant). In some embodiments, the digital assistant user interface includes a second selectable user interface object (e.g., 1014A) that, when selected, displays a keyboard for providing text inputs to the digital assistant. For example, the first and second user interface objects for invoking the visual and textual input modes are displayed in different corners of the digital assistant user interface.

The electronic device receives (1406) a second user input (e.g., 1016A, 1016B, and/or 1016C) selecting the first selectable user interface object (e.g., 1014B). In some embodiments, the display generation component includes a touch-sensitive surface, and the second user input selecting the first selectable user interface object (e.g., 1014B) is received via the touch-sensitive surface (e.g., the second user input includes a touch input directed to the first selectable user interface object on the touch-sensitive display). For example, the second user input includes a touch input directed to the first selectable user interface object on a touch-sensitive surface of the display, such as described with respect to input 1016A in FIG. 10C. For example, the second user input includes an input associated with the visual mode for the digital assistant user interface, such as a press of a button associated with prompt (e.g., as described with respect to process 1300) and/or a speech input including a prompt related to visual context (e.g., as described with respect to input 1016C).

In response to receiving the second user input selecting the first selectable user interface object, the electronic device displays (1408), via the display generation component, a representation of a feed of camera data from the one or more cameras (e.g., 1018A) (e.g., a viewfinder user interface including a live- or near-live representation of a field-of-view of the one or more cameras).

In some embodiments, while displaying the representation of the feed of the camera data from the one or more cameras (e.g., 1018A), the electronic device displays a third selectable user interface object (e.g., 1014B). In some embodiments, the third selectable user interface object is the same as the first selectable user interface object (e.g., positioned at the same place on the display and/or within the user interface). For example, the electronic device continues to display the first selectable user interface object after launching the viewfinder. In some embodiments, the third selectable user interface object has a different appearance than the first selectable user interface object. For example, as described with respect to FIGS. 10D-10E, the appearance of the vision mode object 1014B is updated to a new appearance when viewfinder 1018A is displayed. In some embodiments, the electronic device receives a fifth user input selecting the third selectable user interface object and, in response to receiving the fifth user input selecting the third selectable user interface object, ceases displaying the representation of the feed of the camera data from the one or more cameras. For example, selecting vision mode object 1014B in FIGS. 10D-10S and/or 10U-10V would close viewfinder 1018A, returning to the digital assistant session without the viewfinder enabled (e.g., as illustrated in FIG. 10C) and/or ending the digital assistant session and returning to a previously-displayed user interface (e.g., as illustrated in FIG. 10B).

In some embodiments, the second user input (e.g., 1016A, 1016B, and/or 1016C) selecting the first selectable user interface object is received while displaying, via the display generation component, a respective user interface (e.g., as illustrated in FIG. 10C) (e.g., in addition to the digital assistant user interface; in some embodiments, the digital assistant user interface at least partially overlays the respective user interface). In some embodiments, while displaying the representation of the feed of the camera data from the one or more cameras, the electronic device maintains displaying at least a first portion of the respective user interface (e.g., as illustrated in FIG. 10D) (e.g., the viewfinder user interface is a partial-screen or compact viewfinder, e.g., partially overlaying the respective user interface).

In some embodiments, the second user input (e.g., 1016A, 1016B, and/or 1016C) selecting the first selectable user interface object (e.g., 1014B) is received while displaying, via the display generation component, a respective user interface (e.g., as illustrated in FIG. 10C) (e.g., in addition to the digital assistant user interface; in some embodiments, the digital assistant user interface at least partially overlays the respective user interface). In some embodiments, while displaying the representation of the feed of the camera data from the one or more cameras, the electronic device forgoes (e.g., ceases) displaying the respective user interface (e.g., as illustrated in FIG. 10E) (e.g., the viewfinder user interface is a full-screen or expanded viewfinder).

In some embodiments, in response to receiving the second user input (e.g., 1016A, 1016B, and/or 1016C) selecting the first selectable user interface object (e.g., 1014B), the electronic device maintains (e.g., continues) displaying a set of one or more elements of the digital assistant user interface (e.g., 1014A, 1014B, and/or 1012) (e.g., displaying one or more elements of the digital assistant user interface concurrently with the representation of the feed of the camera data from the one or more cameras). For example, as illustrated in FIGS. 10D-10E, one or more digital assistant indicators (e.g., a digital assistant icon and/or effect, such as an edge glow animation) and/or user interface objects (e.g., a keyboard button, a chat button, a search button, and/or prompt suggestion buttons) remain displayed while the viewfinder user interface is open.

In some embodiments, in response to receiving the second user input (e.g., 1016A, 1016B, and/or 1016C) selecting the first selectable user interface object (e.g., 1014B) (e.g., while displaying the representation of the feed of the camera data from the one or more cameras), the electronic device updates a subset of the set of one or more elements of the digital assistant user interface. For example, the device changes the appearance of the first selectable user interface object (e.g., 1014B) (e.g., visually indicating that the first selectable user interface object has been selected and/or changing the first selectable user interface object into a close or cancel button). For example, the device updates prompt suggestion buttons based on visual context from the representation of the feed of the camera data from the one or more cameras, replacing prompt suggestions 1014C and 1014D with prompt suggestions 1014E and 1014F, as illustrated in FIGS. 10C-10E.

While displaying the representation of the feed of the camera data from the one or more cameras, the electronic device receives (1410) a third user input (e.g., 1022, 1025A, 1025B, 1028, 1032, 1040A, 1040B, 1046, 1050, and/or 1060) (e.g., a touch input, a hardware button input, a speech input, a typed input, a gaze input, an air gesture, and/or another type of input) including a prompt (e.g., as described with respect to FIGS. 10D-10S and/or 10U-10V).

In some embodiments, the third user input including the prompt includes a second press input directed to a second hardware input device of the one or more hardware input devices (e.g., as described with respect to FIGS. 10U-10V and process 1300) (in some embodiments, the second hardware input device is the same as the first hardware input device). For example, the prompt is associated with the hardware input device as described with respect to FIGS. 10T-10V, such that the hardware input device can be pressed to input the prompt. In some embodiments, the second press input is a particular type of input, such as a short press and/or a full/hard press.

In response to receiving the third user input including the prompt, the electronic device outputs (1412) (e.g., using the digital assistant) a response to the prompt (e.g., 1014G, 1020, 1024A, 1024B, 1030A, 1030B, 1034A, 1034B, 1042, 1044, 1048D, 1054C, and/or 1062) (e.g., an audio, visual, and/or tactile output; e.g., including verbal and/or nonverbal content), wherein the response to the prompt is based on the representation of the feed of the camera data from the one or more cameras (e.g., as described with respect to FIGS. 10E-10I, 10K, 10P, and/or 10V and processes 1100, 1200, and/or 1300).

In some embodiments, the digital assistant user interface includes a second selectable user interface object (e.g., 1014A), different from the first selectable user interface object (e.g., 1014B). In some embodiments, the electronic device receives a fourth user input (e.g., 1036) selecting the second selectable user interface object, and, in response to receiving the fourth user input selecting the second selectable user interface object, the electronic device displays, via the display generation component, a text input user interface (e.g., 1038) (e.g., a text input field and/or virtual keyboard for the digital assistant). In some embodiments, while displaying the text input user interface, the electronic device receives, via the text input user interface, a first text input (e.g., 1040A), and, in response to receiving the first text input, the computer system outputs (e.g., using the digital assistant) a first response to the first text input (e.g., 1042) (in some embodiments, the first text input is the third user input, and the response to the first text input is the response to the prompt). For example, the user can provide natural-language prompts to the digital assistant session by typing or writing into the text input user interface.

In some embodiments, displaying the digital assistant user interface includes displaying the first selectable user interface object at a first side of the digital assistant user interface and displaying the second selectable user interface object at a second side of the digital assistant user interface, wherein the second side is a different side than the first side. For example, as illustrated in FIG. 10C, keyboard object 1014A is displayed in the lower left corner of the digital assistant session overlay and vision mode object 1014B is displayed in the lower right corner of the digital assistant session overlay.

In some embodiments, while displaying the representation of the feed of the camera data from the one or more cameras (e.g., after receiving the second user input selecting the first selectable user interface object), the electronic device maintains displaying (e.g., continuing to display) the second selectable user interface object (e.g., as illustrated in FIGS. 10D-10E). In some embodiments, in response to an input selecting the second selectable user interface object (e.g., the fourth input) while displaying the representation of the feed of the camera data from the one or more cameras, the electronic device displays the text input user interface concurrently with the representation of the feed of the camera data from the one or more cameras (e.g., the text input field and/or virtual keyboard are displayed along with the viewfinder). In some embodiments, in response to an input selecting the first selectable user interface object (e.g., the second user input) while displaying the text input user interface, the electronic device displays the representation of the feed of the camera data from the one or more cameras concurrently with the text input user interface (e.g., as illustrated in FIG. 10J).

In some embodiments, outputting the first response to the first text input includes, in accordance with a determination that the first text input is received while displaying the representation of the feed of the camera data from the one or more cameras (e.g., 1018A) (e.g., while concurrently displaying the text input user interface and the viewfinder user interface), determining, based on the representation of the feed of the camera data from the one or more cameras, first visual context information, wherein the first response to the first text input is based on the first visual context information (e.g., as described with respect to FIGS. 10J-10K).

In some embodiments, in accordance with a determination that the first text input is received while the electronic device is not displaying the representation of the feed of the camera data from the one or more cameras (e.g., 1018A), the first response to the first text input is based on a set of context information that does not include visual context information captured using the one or more cameras. For example, the text input user interface (e.g., 1038) can be used to input natural-language prompts to the digital assistant whether or not the visual intelligence experience is enabled/active, and the digital assistant responds using visual context only when viewfinder 1018A is displayed.

In some embodiments, while displaying the digital assistant user interface, the electronic device receives a respective user input including a respective prompt, and, in response to receiving the respective user input including the respective prompt, outputs a respective response to the respective prompt. In some embodiments, outputting the respective response to the respective prompt includes, in accordance with a determination that the respective user input is received while displaying the representation of the feed of the camera data from the one or more cameras (e.g., 1018A), determining the respective response to the respective prompt using a first set of context information, wherein the first set of context information includes visual context information based on the representation of the feed of the camera data from the one or more cameras (e.g., as described with respect to FIGS. 10D-10S and/or 10U-10V). In some embodiments, the respective user input is the third user input including the prompt and the respective response to the respective prompt is the response to the prompt. In some embodiments, outputting the respective response to the respective prompt includes, in accordance with a determination that the respective user input is received while displaying the representation of the feed of the camera data from the one or more cameras, determining the respective response to the respective prompt using a second set of context information, wherein the second set of context information does not include the visual context information based on the representation of the feed of the camera data from the one or more cameras. For example, the digital assistant responds to prompts using visual context when the viewfinder user interface is displayed, and response to prompts using other contextual information (e.g., user preferences, device context, application context, location information, weather information, sensor data, and/or any other non-camera data) when the viewfinder user interface is not displayed. In some embodiments, the digital assistant uses many of the same techniques and/or services (e.g., digital assistant module 904, output module 908, application module 910, and/or display module 912) to generate responses to prompts whether or not the visual intelligence experience is enabled, but only uses visual context for generating responses to prompts when the visual intelligence experience is enabled.

In some embodiments, while displaying the representation of the feed of the camera data from the one or more cameras and in accordance with a determination that the representation of the feed of the camera data satisfies a set of criteria, the electronic device displays, via the display generation component, a first set of one or more visual content indicators (e.g., 1014E, 1014F, 1014G, 1018C, and/or 1044) (e.g., labels, badges, annotations, borders, filters, animations, and/or other visual elements or effects). For example, based on the results of identifying visual context (e.g., pre-processing the camera feed data using image and/or video processing techniques) and/or the results of a response (e.g., output) generated based on visual context (e.g., processing the camera feed data in response to a prompt), the electronic device displays subject indicators (e.g., 1018C) to visually emphasize recognized content in viewfinder 1018A, indicators labeling the recognized content (e.g., 1014E), and/or indicators of suggestions (e.g., suggested prompts and/or actions) corresponding to the recognized content (e.g., 1014F and/or 1044).

In some embodiments, one or more of the visual content indicators are displayed at a location corresponding to the location of related visual content within the representation of the feed of the camera data from the one or more cameras (e.g., the portion of the viewfinder in which particular visual content is recognized). For example, as discussed with respect to subject indicator 1018C, the visual content indicators include borders, highlights, edge glows, and/or fill effects applied to viewfinder 1018A to modify the appearance of the related visual content (e.g., visually emphasizing recognized and/or selected portions of viewfinder 1018A). For example, labels, icons, and/or selectable user interface objects (e.g., 1014E, 1014F, 1014G, and/or 1044) can be displayed at particular locations on the display and/or distributed within and/or around viewfinder 1018A (e.g., displaying prompt suggestion 1044, which corresponds to a suggestion to add the mixed nuts to a grocery list, can be displayed near the mixed nuts within viewfinder 1018A).

In some embodiments, the set of criteria includes a criterion that is satisfied while the representation of the feed of camera data from the one or more cameras includes (e.g., currently includes) visual content of a first type, and the first set of one or more visual content indicators include a first visual content indicator identifying the visual content of the first type. In some embodiments, visual content of a first type includes visual content identified as belonging to a particular set of content types, category, and/or domain, such as people, animals, plants, places, text, personal effects, and/or other common, recognizable, and/or significant types of visual context. For example, the electronic device only provides prompt suggestions (e.g., 1014E, 1014F, 1014G, and/or 1044) and/or applies visual emphasis (e.g., 1018C) for certain types of content detected in viewfinder 1018A. In some embodiments, visual content of a first type includes visual content identified as relevant based on current context information. For example, the electronic device only provides prompt suggestions and/or applies visual emphasis for content that the user has explicitly selected in viewfinder 1018A (e.g., as discussed with respect to FIG. 10I), content related to a previous prompt, and/or content that the electronic device determines the user is likely to interact with (e.g., based on context indicating the user's personal items, favorite items, items the user has previously interacted with using the visual intelligence experience, and/or other contextual information).

In some embodiments, the visual content of the first type includes visual content associated with a respective prompt (e.g., as described with respect to FIGS. 10G, 10I, and/or 10K) (e.g., a user-inputted prompt, such as the prompt included in the third input, and/or a suggested prompt). For example, if a user inputs a broadly-applicable, open-ended, and/or ambiguous prompt (e.g., “Tell me about this” or “What's going on here?”), the device displays indications of applicable or potentially-relevant visual content in the viewfinder (e.g., subject indicators 1018C), such as highlighting one or more objects that the prompt could be applied to (e.g., objects that the digital assistant could use as context for the response).

In some embodiments, while displaying the first set of one or more visual content indicators (e.g., 1014E, 1014F, 1014G, 1018C, and/or 1044), detecting a change to contents of the representation of the feed of camera data from the one or more cameras (e.g., while the viewfinder is in the live feed mode). In some embodiments, in response to detecting the change to the contents of the representation of the feed of camera data from the one or more cameras and in accordance with a determination that the representation of the feed of the camera data satisfies the set of criteria, the electronic device displays, via the display generation component, a second set of one or more visual content indicators. In some embodiments, the second set of one or more visual content indicators overlap with, are the same as, and/or are different from the first set of indicators. For example, the device updates the currently-displayed indicators based on the current visual context, ceasing to display indicators that are no longer relevant to the updated visual context, updating indicators to better reflect the updated visual context, and/or displaying new indicators relevant to the updated visual context. In some embodiments, in response to detecting the change to the contents of the representation of the feed of camera data from the one or more cameras and in accordance with a determination that the representation of the feed of the camera data does not satisfy the set of criteria, ceasing displaying the first set of one or more visual content indicators (e.g., and foregoing displaying the second set of one or more visual content indicators). For example, as viewfinder 1018A updates in the live feed mode, the electronic device adds, removes, and/or changes the positions of subject indicators 1018C to reflect the current visual content and to spatially track the position of the corresponding content within viewfinder 1018A (e.g., moving the edge glow effect to remain “on” an object until the object is no longer visible in viewfinder 1018A). For example, as recognized visual content enters and/or exits viewfinder 1018A, the electronic device adds and/or removes prompt suggestions corresponding to the recognized visual content.

In some embodiments, the response to the prompt includes verbal (e.g., linguistic) content (e.g., 1020, 1024A, 1024B, 1030A, 1030B, 1034A, 1034B, 1042, 1048D, 1054C, and/or 1062) (e.g., template-based and/or generative response text). In some embodiments, at least a portion of the verbal content is delivered as an audio output (e.g., using synthesized speech, e.g., of the digital assistant system). In some embodiments, at least a portion of the verbal content is delivered as displayed text. In some embodiments, the verbal includes generative AI content, e.g., text and/or other speech generated using an LLM and/or another generative AI model of the digital assistant system and/or another local or remote system.

In some embodiments, outputting the response to the prompt includes displaying, via the display generation component, a visual response element (e.g., 1014G, 1024B, 1030A, 1034A, 1044, and/or 1062) (e.g., text, images, graphics, icons, animations, interactive user interface elements, and/or other visual content). In some embodiments, the visual response element includes generative AI content, e.g., text and/or other visual content generated using a generative AI model of the digital assistant system and/or another local or remote system. In some embodiments, outputting the response to the prompt includes outputting an audio response element (e.g., 1020, 1024B, 1030B, 1034B, 1042, 1048D, and/or 1054C) (e.g., speech, music, sound effects, and/or audio media playback). In some embodiments, the audio response element includes synthesized speech. In some embodiments, the audio response element includes generative AI content, e.g., speech synthesized from text generated using an LLM and/or another generative AI model of the digital assistant system and/or another local or remote system.

The operations described above with reference to FIG. 14 are optionally implemented by components depicted in FIGS. 1-4G, 6A-6B, 7A-7C, 8, 9, and 10A-10V. For example, the operations of process 1400 may be implemented using digital assistant system 700, foundation system 800, system 900, system 1000, and/or processes 1100, 1200, and/or 1300. It would be clear to a person having ordinary skill in the art how other processes are implemented based on the components depicted in FIGS. 1-4G, 6A-6B, and 7A-7C, 8, 9, and 10A-10V.

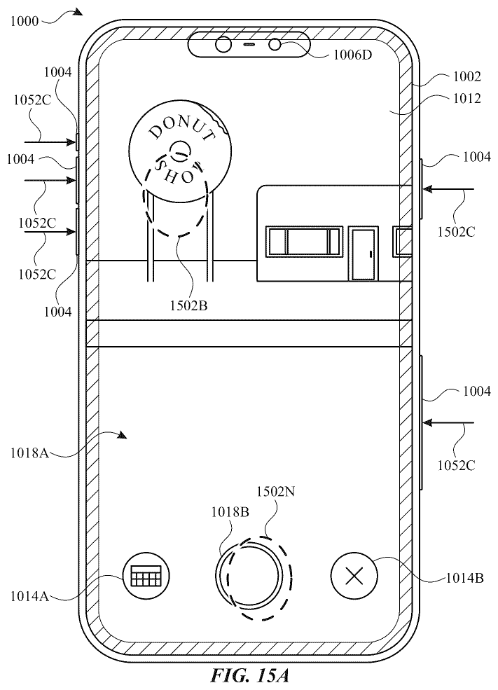

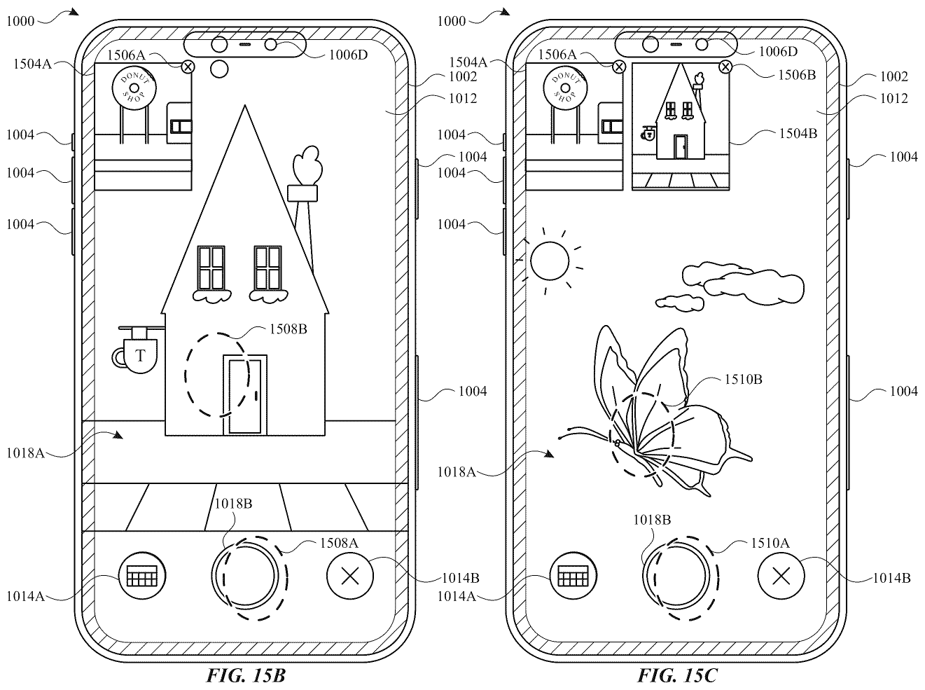

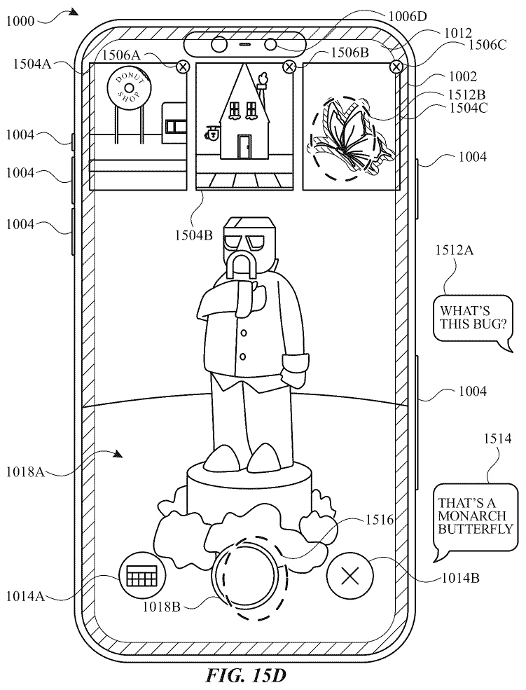

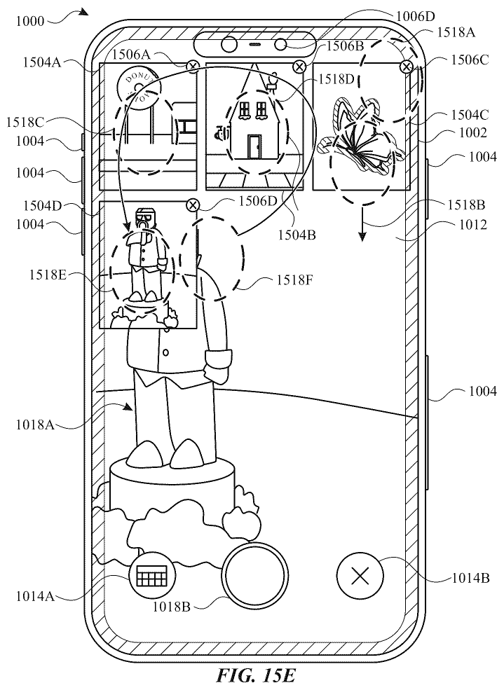

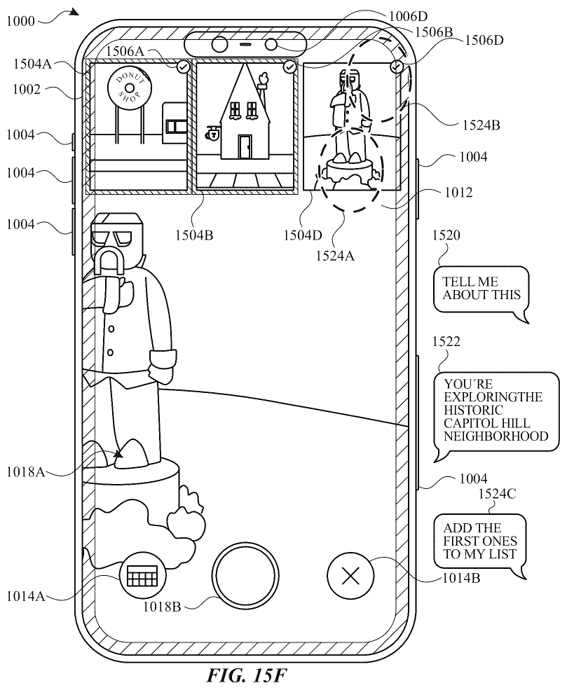

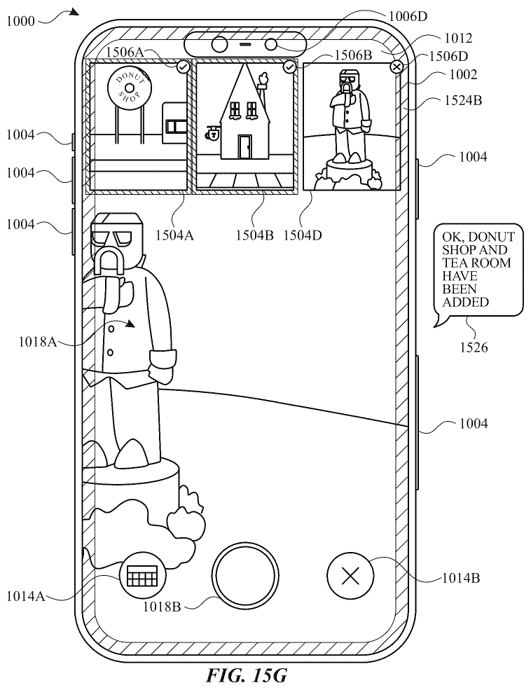

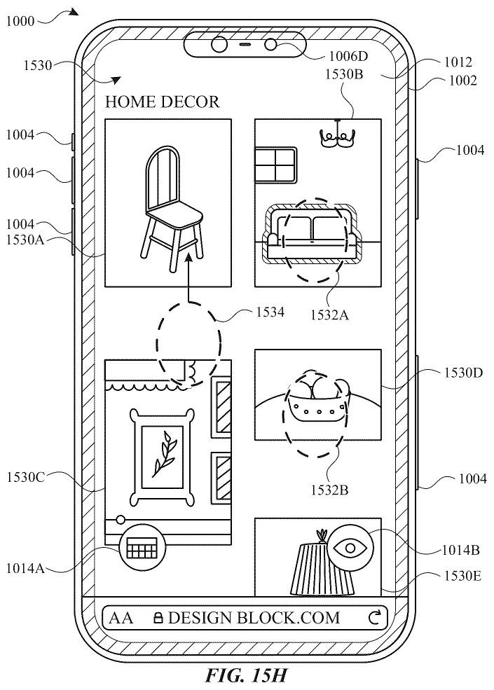

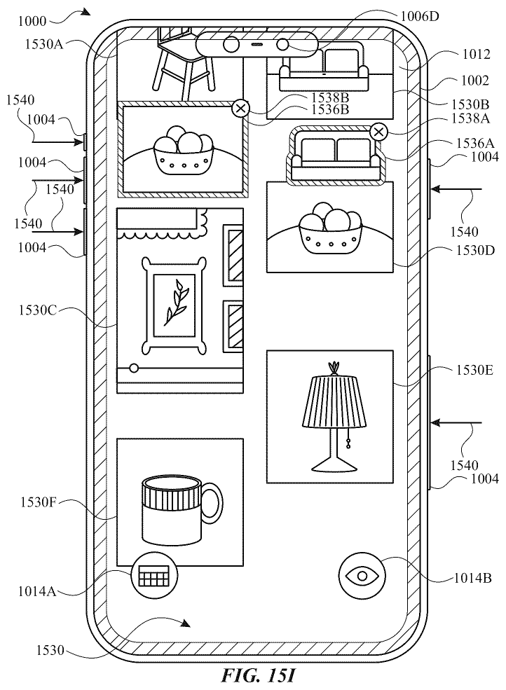

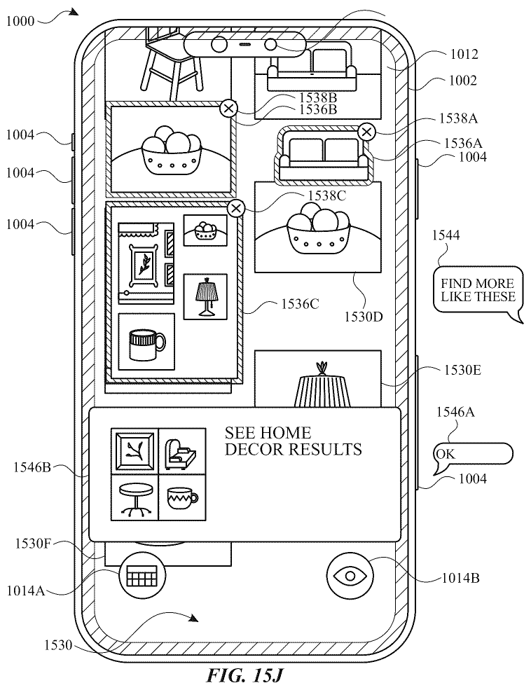

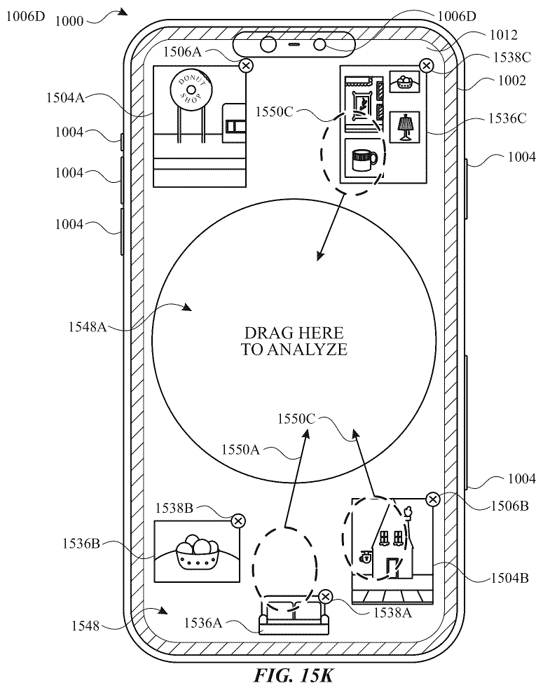

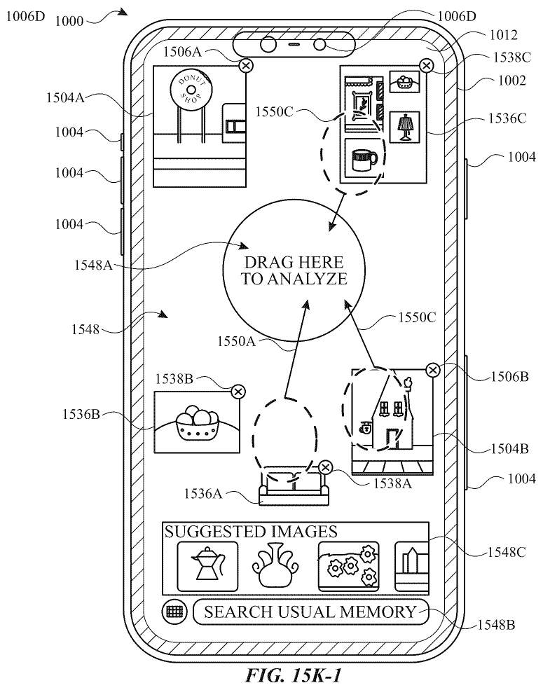

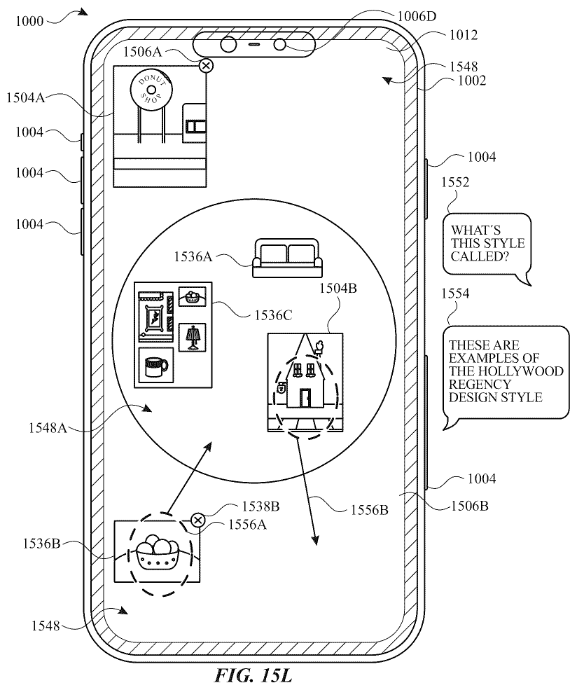

FIGS. 15A-15L illustrate user interfaces for interacting with collected items of visual context using system 1000, in accordance with some embodiments. As illustrated in FIG. 15A, system 1000 displays a visual intelligence experience for a digital assistant session including viewfinder 1018A, a representation of the feed of data captured by one or more of cameras 1006A, 1006B, 1006C, and 1006D displayed in the live feed mode, and viewfinder control object 1018B (e.g., as described with respect to FIGS. 10A-10V).

At FIG. 15A, system 1000 detects an input requesting to capture an item of visual context, such as input 1502A directed to viewfinder control object 1018B, input 1502B directed to a subject (e.g., the donut shop sign) within viewfinder 1018A, a button press input (1502C) on one or more of hardware buttons 1004, and/or another input (e.g., a spoken input requesting a capture and/or a movement corresponding to capturing an item of visual context, such as described with respect to FIGS. 10J-10S). For example, the input requesting to capture the item of visual context includes a touch input (e.g., an input directed to viewfinder control object 1018B and/or to the subject within viewfinder 1018A via a touch-sensitive surface of display 1002), an air gesture input (e.g., a gesture that is detected using optical sensor data independently of the user physically touching an input element that is part of the device and is based on detected motion of a portion of the user's body through the air, including motion of the user's body relative to an absolute, motion of the user's body relative to another portion of the user's body, and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body)), an input performed using a peripheral hardware input device (e.g., a mouse, stylus, keyboard, and/or other controller in communication with system 1000), an input performed using hardware buttons 1004, a spoken input, and/or a gaze input (e.g., detecting, using one or more sensors for detecting eye movement, that the user's gaze is directed to (e.g., or within a threshold distance from) viewfinder control object 1018B and/or to the subject within viewfinder 1018A on display 1002, for example, for at least a threshold dwell duration and/or while performing one or more other inputs, such as a particular air gesture).

In response to detecting the input (e.g., 1502A, 1502B, and/or 1502C), at FIG. 15B, system 1000 displays visual context item 1504A, a freeze-frame thumbnail of the contents of viewfinder 1018A (e.g., a view of a donut shop) when the inputs are detected (e.g., as described with respect to picture-in-picture 1052). As illustrated in FIG. 15B, system 1000 displays visual context item 1504A partially overlaying the upper region of viewfinder 1018A and displays selectable cancel object 1506A for visual context item 1504A (e.g., overlaying a corner of visual context item 1504A). In some embodiments, visual context item 1504A is displayed and/or arranged differently than illustrated in FIG. 15B. For example, in embodiments where viewfinder 1018A is displayed as a partial-screen viewfinder rather than a full-screen viewfinder (e.g., as illustrated in FIG. 10D), system 1000 may display visual context item 1504A partially or fully outside of the viewfinder region (e.g., without overlaying viewfinder 1018A). In some embodiments, system 1000 displays visual context items such as visual context item 1504A with cropped and/or cut-out representations of identified subjects rather than a thumbnail of the entire frame of viewfinder 1018A (e.g., as further described with respect to FIG. 15D).

As illustrated in FIG. 15B, viewfinder 1018A remains in the live feed mode while displaying visual context item 1504A, updating viewfinder 1018A based on the camera feed data as the field-of-view of cameras 1006A, 1006B, 1006C, and/or 1006D change. In some embodiments, system 1000 also performs the steps described with respect to FIGS. 10M and 10O, for instance, displaying a flash/shutter animation and/or temporarily switching viewfinder 1018A to the freeze-frame mode before displaying visual context item 1504A in the upper region and automatically returning viewfinder 1018A to the live feed mode.

At FIG. 15B, system 1000 detects another input requesting to capture an item of visual context, such as input 1508A directed to viewfinder control object 1018B and/or input 1508B directed to viewfinder 1018A. At FIG. 15C, in response to detecting the capture input(s), system 1000 displays visual context item 1504B, a freeze-frame thumbnail of the contents of viewfinder 1018A (e.g., a view of a tearoom restaurant) when the capture input(s) is detected, along with corresponding selectable cancel object 1506B. In particular, as illustrated in FIG. 15C, system 1000 displays visual context items 1504A (e.g., the donut shop) and 1504B (e.g., the tearoom) together, overlaying the upper region of viewfinder 1018A.

Likewise, at FIG. 15D, in response to detecting an input requesting to capture an item of visual context (e.g., 1510A and/or 1510B) at FIG. 15C, system 1000 displays visual context item 1504C (and corresponding selectable cancel object 1506C) together with visual context items 1504A and 1504B. In some embodiments, in response to detecting the input requesting to capture the item of visual context, system 1000 identifies a subject in viewfinder 1018A (e.g., in response and/or based on to detecting input 1510B directed to the butterfly represented in viewfinder 1018A) and temporarily updates the appearance of viewfinder 1018A to visually emphasize (e.g., as described with respect to FIG. 10G) the identified content, as illustrated by subject indicator 1511 in FIG. 15D. In some embodiments, system 1000 displays visual context item 1504C with a cropped and/or cut-out representation of the identified subject (e.g., the thumbnail/cut-out of the butterfly) rather than a full-frame photo (e.g., as illustrated in 1504A and 1504B).

Displaying visual context items 1504A, 1504B, and 1504C thus provides a “visual memory” for the visual intelligence experience, presenting the user with an interactive record of captured visual context items that can be used to generate responses to user prompts (e.g., as described with respect to FIGS. 10A-14). FIGS. 15D-15M provide examples of interacting with the visual memory within the visual intelligence experience, including editing the visual memory to use different sets or subsets of the gathered visual context items in response generation.

As illustrated in FIG. 15D, while displaying the visual memory including visual context items 1504A, 1504B, and 1504C, system 1000 detects input 1512A, a speech input including the natural-language prompt “What's this bug?” In response to input 1512A, system 1000 determines that the prompt relates to visual context item 1504C. For example, system 1000 uses natural-language processing techniques and image processing techniques to identify that visual context item 1504C includes an insect, and thus that input 1512A is a prompt to identify the pictured insect. As another example, system 1000 selects visual context item 1504C based on detecting input 1512B, a gaze input directed to the location of visual context item 1504C while input 1512A is detected (e.g., indicating that the user is looking at the picture of the insect while making the request). At FIG. 15D, based on the prompt and the visual context of visual context item 1504C, system 1000 generates a response to input 1512A including spoken output 1514, “That's a monarch butterfly.” Alternatively or in addition to providing spoken output 1514 identifying the insect pictured in visual context item 1504C, in some embodiments, system 1000 provides additional outputs and/or performs additional tasks, such as displaying an informational panel or follow-up prompt suggestion described with respect to FIGS. 10A-14.

At FIG. 15D, system 1000 detects another input requesting to capture an item of visual context, such as input 1516 directed to viewfinder control object 1018B. At FIG. 15E, in response to detecting capture input 1516, system 1000 displays visual context item 1504D, a freeze-frame thumbnail of the contents of viewfinder 1018A (e.g., a view of a public monument) when input 1516 is detected, along with corresponding selectable cancel object 1506D. In some embodiments, as visual context is captured and the corresponding visual context items are displayed within the visual intelligence experience, system 1000 may resize, rearrange, and/or provide additional user interface controls for the visual memory in order to keep viewfinder 1018A at least partially visible (e.g., arranging the visual context items in a scrollable menu or carousel that the user can scroll or swipe through once over a threshold number of visual context items are displayed and/or once over a threshold amount of viewfinder 1018A is overlaid by the visual memory).

At FIG. 15E, system 1000 detects one or more inputs selecting visual context items 1504A, 1504B, and 1504D from the visual memory. In some embodiments, the inputs selecting visual context items 1504A, 1504B, and 1504D from the visual memory include inputs 1518A and/or 1518B, which are inputs explicitly excluding visual context item 1504C (e.g., when captured, items in the visual memory may be “selected” by default (e.g., absent detecting a user intent to the contrary), such as discussed with respect to FIGS. 15D and 15J (below)). For example, input 1518A is a touch input directed to selectable cancel object 1506C and input 1518B is a swipe in a downwards direction across visual context item 1504C. In some embodiments, the inputs selecting visual context items 1504A, 1504B, and 1504D from the visual memory include inputs 1518C-1518F, which are inputs affirmatively selecting those items from the visual memory. For example, inputs 1518C, 1518D, and 1518E are touch and/or gaze inputs directed to the locations of visual context items 1504A, 1504B, and 1504D, respectively, on display 1002, and input 1518F is a gesture input circling (e.g., using a touch-sensitive surface of display 1002, a peripheral hardware input device such as a mouse or stylus, and/or one or more other sensors and/or input devices) the group of visual context items 1504A, 1504B, and 1504D.

In response to the inputs (e.g., 1518A, 1518B, 1518C, 1518D, 1518E, and/or 1518F) selecting visual context items 1504A, 1504B, and 1504D from the visual memory, at FIG. 15F, system 1000 updates the appearance of the visual memory to indicate the currently-selected visual context. As illustrated in FIG. 15F, system 1000 emphasizes the appearance of visual context items 1504A, 1504B, and 1504D by applying a border element and changes the appearance of selectable cancel objects 1506A, 1506B, and 1506D from a cancel icon to a checkmark icon. For example, system 1000 emphasizes the appearance of selected visual context items 1504A, 1504B, and 1504D in response to the one or more inputs affirmatively selecting those items (e.g., inputs 1518C-1518F). Additionally, as illustrated in FIG. 15F, system 1000 stops displaying visual context item 1504C (and corresponding selectable cancel object 1506C). For example, system 1000 dismisses visual context item 1504C in response to the one or more inputs excluding the item (e.g., inputs 1518A and/or 1518B).

At FIG. 15F, after selecting visual context items 1504A, 1504B, and 1504D from the visual memory, system 1000 detects input 1520, a speech input including the natural-language prompt “Tell me about this.” Based on the prompt and the selected visual context items 1504A, 1504B, and 1504D, system 1000 generates a response to input 1520 including spoken output 1522, “You're exploring the historic Capitol Hill neighborhood.” For example, system 1000 generates the response to input 1520 based on visual features identified (e.g., using image processing techniques) from each of visual context items 1504A, 1504B, and 1504D (e.g., synthesizing the visual context from each of the three selected items to generate a response describing their shared characteristics, in this case, the colloquial name for the geographic area). In some embodiments, in addition to the visual features of the selected visual context items, system 1000 may use additional context information associated with the selected visual context items, such as time, location, orientation, and/or movement information.

At FIG. 15F, after detecting and/or responding to input 1520 based on visual context items 1504A, 1504B, and 1504D, system 1000 detects one or more inputs deselecting visual context item 1504D (e.g., and/or re-selecting visual context items 1504A and 1504B). As described above, in some embodiments, the one or more inputs include inputs explicitly excluding (e.g., deselecting) visual context item 1504D, such as input 1524A directed to the location of visual context item 1504D and/or input 1524B directed to selectable cancel object 1506D (e.g., while selectable cancel object 1506D is displayed with the selected appearance including the check mark icon). In some embodiments, the one or more inputs include inputs affirmatively selecting visual context items 1504A and 1504B include input 1524C, a spoken input, “Add the first two to my restaurant list,” which system 1000 analyzes to determine an intent to affirmatively select visual context items 1504A and 1504B (e.g., as the first two items in the group and/or the two items including images of restaurants).

In response to detecting the one or more inputs deselecting visual context item 1504D, at FIG. 15G, system 1000 updates the appearance of visual context item 1504D to indicate that visual context item 1504D is no longer selected along with visual context items 1504A and 1504B. In particular, as illustrated in FIG. 15G, system 1000 removes the border element from visual context item 1504D and changes the appearance of selectable cancel object 1506D back to the cancel icon.

At FIG. 15G, based on the prompt of input 1524C (“Add the first two to my restaurant list”) and the selected visual context items 1504A and 1504B, system 1000 generates a response to input 1524C. For example, system 1000 identifies the restaurants represented in visual context items 1504A and 1504B, performs the action of adding the information to a note in a Notes application (e.g., the user's restaurant list), and provides spoken output 1526, “Ok, Donut Shop and Tea Room have been added.”

As illustrated in FIGS. 15A-15G, system 1000 allows users to gather and edit sets or subsets of visual context items via viewfinder 1018A (e.g., via one or more of cameras 1006A, 1006B, 1006C, and 1006D) to be used as visual memory (e.g., visual context) when responding to prompts. Similarly, as illustrated in FIGS. 15H-15J, system 1000 allows users to gather and edit sets or subsets of visual context items from other (e.g., non-camera feed) visual sources, such as user interfaces displayed via display 1002.

In particular, at FIG. 15H, system 1000 displays the user interface for the digital assistant session (e.g., as described with respect to FIG. 10C) overlaying user interface 1530, a user interface for a web browser page (e.g., or other application user interface) that displays images 1530A-1530E.

At FIG. 15H, system 1000 detects inputs requesting to capture items of visual context from user interface 1530, including input 1532A directed to image 1530B and input 1532B directed to image 1530D. In response to input 1532A and input 1532B, at FIG. 15I, system 1000 displays visual context item 1536A, a cut-out of a couch pictured in image 1530B, and visual context item 1536B, a thumbnail of image 1530D, along with corresponding selectable cancel objects 1538A and 1538B. In some embodiments, system 1000 determines whether to capture a cut-out or thumbnail in response to inputs 1532A and 1532B based on the inputs (e.g., capturing a cut-out in response to a long press input on image 1530B and capturing a thumbnail in response to a short tap on image 1530D) and/or based on the contents of the selected display content (e.g., capturing a cut-out of the couch from image 1530B based on analysis of the image to detect the couch as the main subject). As illustrated in FIG. 15I, system 1000 displays visual context items 1536A and 1536B partially overlaying the upper region of user interface 1530 and with border elements to visually emphasize the items against the background.

Referring back to FIG. 15H, system 1000 detects input 1534, an upwards swipe across user interface 1530. In response to input 1534, system 1000 scrolls user interface 1530, moving images 1530A-1530E up on display 1002 and displaying image 1530F. Accordingly, similarly to maintaining the live feed mode for viewfinder 1018A while capturing visual context items in FIGS. 15A-15G, system 1000 allows users to continue to interact with an underlying user interface while capturing visual context items from the user interface.

At FIG. 15I, system 1000 detects an input requesting to capture an item of visual context from user interface 1530, such as input 1540, a button press input. In response to input 1540, at FIG. 15J, system 1000 displays visual context item 1536C, a thumbnail screenshot of user interface 1530 as displayed when input 1540 is detected. As illustrated in FIG. 15J, visual context item 1536C is a screenshot of only the contents of user interface 1530, and does not include visual context items 1536A and 1536B and/or other overlay content.

As described with respect to FIGS. 15D-15G, users can select, deselect, and dismiss visual context items 1536A, 1536B, and 1536C from the displayed visual memory and prompt system 1000 to generate responses based on the selected sets or subsets of visual context items gathered from user interface 1530. As illustrated in FIG. 15I, while displaying visual context items 1536A, 1536B, and 1536C, system 1000 detects input 1544, a spoken request “Find more like these.” Based on the prompt of input 1544 and the gathered visual context items 1536A, 1536B, and 1536C, system 1000 generates a response to input 1544. For example, system 1000 performs a visual search based on the extracted visual characteristics of the three items and provides spoken output 1546A, “Ok,” and visual output 1546B, a user interface object representing the visual search results.

FIGS. 15K-15L illustrate user interface 1548, a dedicated user interface for interacting with visual context items in the visual memory. As illustrated in FIG. 15K, user interface 1548 includes visual context items 1504A, 1504B, 1536A, 1536B, and 1536C. For example, user interface 1548 may include visual context items gathered from and/or interacted with (e.g., selected and/or used for prompt generation) in the current or past digital assistant and/or visual intelligence experience sessions, including visual context items gathered using the one or more cameras (e.g., viewfinder 1018A) and/or from displayed user interfaces (e.g., as described in FIGS. 15H-15J). In some embodiments, as illustrated in FIG. 15K-1, user interface 1548 includes search bar 1548B and/or suggestion user interface object 1548C, which allow users to search and/or select additional visual context items to include in the visual memory. For example, search bar 1548B allows a user to perform text-based searches for visual content with particular characteristics from past visual context items (e.g., a visual memory history), the user's media library (e.g., including photos and videos captured and/or saved by the user), and/or the internet, while suggestion user interface object 1548C automatically surfaces potentially relevant visual context items for the user to review and/or select. Accordingly, in some embodiments, user interface 1548 allows a user to interact with a visual memory that includes visual context items explicitly collected by the user (e.g., as described with respect to FIGS. 15A-15J) as well as visual context items collected by other means and/or from other sources.

At FIG. 15K, system 1000 detects inputs 1550A, 1550B, and 1550C, which select visual context items 1536A, 1504B, and 1536C by dragging or swiping the respective visual context items from their initial positions into the area of active region 1548A, which is indicated on display 1002 by a displayed boundary with the text instruction “Drag here to analyze.” In response to detecting inputs 1550A-1550C, at FIG. 15L, system 1000 displays visual context items 1536A, 1504B, and 1536C inside the boundary of active region 1548A, indicating that visual context items 1536A, 1504B, and 1536C are selected, while visual context items 1504A and 1536B, which remain displayed outside of active region 1548A, are unselected. In some embodiments, system 1000 moves visual context items into active region 1548A based on other types of selection inputs, such as tap inputs directed to the visual context items displayed outside of active region 1548A and/or natural-language inputs indicating an intent to select one or more visual context items.

At FIG. 15L, while displaying visual context items 1536A, 1504B, and 1536C inside the boundary of active region 1548A, system 1000 detects input 1552, a spoken request including the prompt “What's this style called?” Based on the prompt and the visual context items in active region 1548A, system 1000 generates a response to input 1552 including spoken output 1554, “These are examples of the Hollywood Regency design style,” identifying the shared visual style of the selected visual context items.

As illustrated in FIG. 15L, users can continue to edit the subset of the visual memory used to generate responses by moving the visual context items into and out of active region 1548A. For example, input 1556A, dragging visual context item 1536B into the area of active region 1548A, adds visual context item 1536B to the selected set, and input 1556B, dragging visual context item 1504B out of the area of active region 1548A, removes visual context item 1504B from the selected set. In some embodiments, in response to input 1556B moving visual context item 1504B out of active region 1548A (e.g., and/or another type of input, such as a tap input on context item 1504B while in active region 1548A and/or a natural-language input indicating an intent to exclude visual context item 1504B), system 1000 displays the removed visual context item at the peripheries of user interface 1548, keeping the visual context item available in the visual memory even when deselected. In some embodiments, visual context items can also be dismissed from the visual memory altogether, for instance, by selecting the respective selectable cancel object and/or swiping down across the visual context item (e.g., while the visual context items is not displayed in active region 1548A and/or whether or not the visual context item is currently selected).

In some embodiments, an active region is used to indicate and/or edit selected visual context items while in a capture mode such as illustrated in FIGS. 15A-15J. For example, while displaying viewfinder 1018A and/or user interface 1530, system 1000 displays any currently-selected visual context items in the upper region of the digital assistant overlay and displays any unselected visual context items in the lower region (e.g., additionally or alternatively to the other visual indications described with respect to FIGS. 15F-15G), and users can move visual context items between the upper (e.g., active) region and the lower region to select and deselect the visual context items (respectively) (e.g., additionally or alternatively to the selection and exclusion inputs described with respect to FIG. 15E).

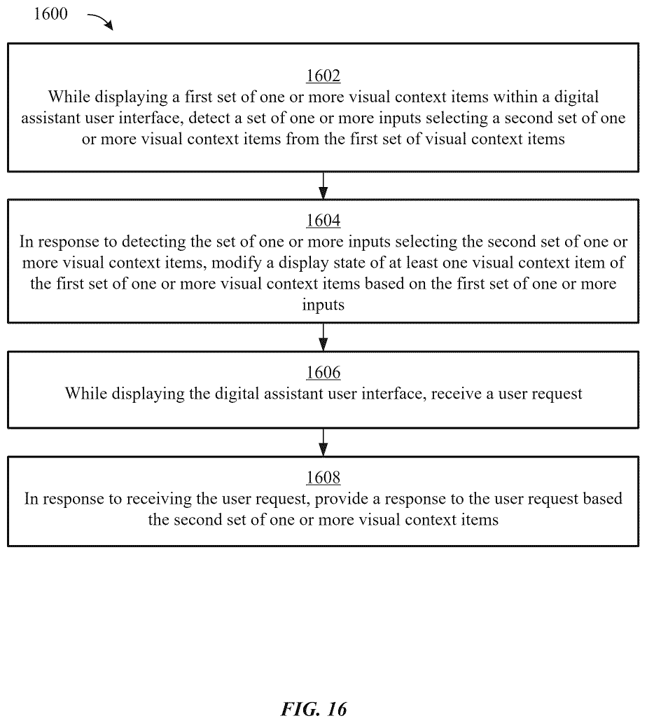

FIG. 16 illustrates process 1600 for controlling a visual memory used by a digital assistant for response generation, according to various examples. Process 1600 is performed, for example, using one or more computer systems and/or electronic devices (e.g., 1000) implementing a digital assistant (e.g., including 700, 800, and/or 900). In some examples, process 1600 is performed using a client-server system (e.g., system 100), and the blocks of process 1600 are divided up in any manner between the server (e.g., DA server 106) and a client device. In other examples, the blocks of process 1600 are divided up between the server and multiple client devices (e.g., a mobile phone and a smart watch). Thus, while portions of process 1600 are described herein as being performed by particular devices of a client-server system, it will be appreciated that process 1600 is not so limited. In other examples, process 1600 is performed using only a client device (e.g., user device 104) or only multiple client devices. In process 1600, some blocks are, optionally, combined, the order of some blocks is, optionally, changed, and some blocks are, optionally, omitted. In some examples, additional steps may be performed in combination with the process 1600.

Process 1600 is performed at an electronic device (e.g., 1000) with (e.g., in communication with) a display generation component (e.g., 1002), one or more input devices (e.g., one or more hardware buttons (e.g., 1004), a touch-sensitive surface (e.g., of the display generation component and/or the hardware buttons), one or more cameras (e.g., 1006A, 1006B, 1006C, and/or 1006D), one or more peripheral hardware input devices (e.g., a mouse, stylus, keyboard, and/or other controller in communication with the electronic device), one or more gaze tracking components, one or more microphones or other audio sensors, and/or one or more motion sensors), one or more processors, and memory. Controlling a visual memory for a digital assistant to use in response generation as described herein provides improved response generation, reduces the number of inputs needed for response generation, and provides improved visual feedback on a state of the device to a user, which reduces the power usage and improves the battery life of computer systems by enabling the user to use the devices more quickly and efficiently. For example, digital assistants implementing process 1600 provide seamless task performance based on visual context without the user needing to manually input context information and/or navigate between different user interfaces, while also providing the user with improved control over and feedback on which visual context information is used for response generation.

In some embodiments, the electronic device is in communication with one or more output devices in addition or alternatively to the display generation component, such one or more audio output devices and/or one or more tactile output devices, and content described herein as being “displayed” may include additional or alternative output content. For example, one or more visual content items described as being displayed may also be described to the user via a spoken output (e.g., simulated speech describing the visual memory that is or would be displayed).

While displaying, via the display generation component, a first set (in some embodiments, a plurality) of one or more visual context items (e.g., 1504A, 1504B, 1504C, 1504D, 1536A, 1536B, and/or 1536C) (e.g., the current visual memory context) within a digital assistant user interface (e.g., 1012 and/or 1548) (e.g., as illustrated in FIGS. 15B-15G and 15I-15L), the electronic device detects (1602) a set of one or more inputs (e.g., 1512A-1512B, 1518A-1518F, 1524A-1524C, 1550A-1550C, 1556A, and/or 1556B) selecting a second set of one or more visual context items from the first set of visual context items. In some embodiments, the one or more inputs selecting the second set of one or more visual context items includes one or more touch inputs, air gesture inputs, inputs performed using peripheral hardware input devices, hardware button inputs, spoken inputs, and/or gaze inputs indicating which visual context items are (and/or are not) to be included in the second set of one or more visual context items. For example, the set of one or more inputs includes a spoken input detected while the user's gaze is directed to the second set of one or more visual context items, a stylus input circling the second set of one or more visual context items, a set of tap inputs directed to each of the second set of one or more visual context items on a touch-sensitive display surface, and/or a set of air gesture inputs dismissing each visual context item not selected for the second set of visual context items (e.g., particular hand poses and/or motions detected while the user's gaze is directed to the visual context item to dismiss).

In some embodiments, while displaying the first set of one or more visual context items within the digital assistant user interface, the electronic device displays, via the display generation component, a representation of a feed of camera data from the one or more cameras (e.g., 1018A) (e.g., as described with respect to FIGS. 15B-15G). For example, the digital assistant user interface overlays the viewfinder, includes the viewfinder, and/or is displayed with the viewfinder. In some embodiments, displaying the representation of the feed of camera data from the one or more cameras includes: receiving, via one or more cameras in communication with the electronic device (e.g., 1006A, 1006B, 1006C, and/or 1006D), the feed of the camera data and, in response to receiving the feed of the camera data, updating the representation of the feed of the camera data (e.g., a viewfinder user interface including a live- or near-live representation of a field-of-view of the one or more cameras as described with respect to FIGS. 10D-10E). For example, as frames of the camera data are received from the one or more cameras, the frames are successively displayed in the viewfinder user interface (e.g., advancing the feed), providing a live- or near-live representation of the field-of-view of the one or more cameras. For example, the viewfinder remains in a “live” mode (e.g., the first mode described with respect to FIGS. 10D-10F) while displaying, editing, and responding to queries about the set of visual context items.

In some embodiments, the digital assistant user interface includes a capture user interface object (e.g., 1018B) (e.g., a software button). In some embodiments, while displaying the first set of one or more visual context items, the electronic device detects a respective user input directed to the capture user interface object (e.g., 1502A, 1508A, 1510A, and/or 1516) and in response to detecting the respective user input, the electronic device adds a respective visual context item to the first set of visual context items (e.g., as described with respect to FIGS. 15B-15E). For example, the user can gather new visual context items, which can be selected to add to the second set of visual context items used in responding to the user request. In some embodiments, while displaying a camera viewfinder, selecting the capture user interface object adds a visual context item including visual content from the camera viewfinder.

In response to detecting (1602) the set of one or more inputs selecting the second set of one or more visual context items, the electronic device modifies (1604) a display state of at least one visual context item of the first set of one or more visual context items based on the first set of one or more inputs (e.g., as illustrated in FIGS. 15F-15G and 15L). For example, one or more visual context items are dismissed (e.g., ceasing display of un-selected context items) and/or the appearance of the set of one or more visual context items is changed (e.g., moving, emphasizing, shading, etc.).

In some embodiments, the set of one or more inputs selecting the second set of one or more visual context items includes a respective input excluding (e.g., removing, dismissing, and/or deselecting) a respective visual context item of the first set of one or more visual context items from the second set of one or more visual context items (e.g., 1518A, 1518B, 1524A, 1524B, 1524C, and/or 1556B) (e.g., the respective visual context item is not included in the second set of one or more visual context items used to generate the response).

In some embodiments, modifying the display state of at least one visual context item of the first set of one or more visual context items includes, in response to detecting the respective input (e.g., the excluding input), ceasing displaying the respective visual context item (e.g., as described with respect to FIGS. 15E-15F).

In some embodiments, the respective input includes a respective movement input (e.g., 1518B and/or 1556B) (e.g., a touch gesture, air gesture, and/or other input with a movement component) directed to (e.g., moving across) the respective visual context item. In some embodiments, the movement input is a movement in a particular direction with respect to the respective visual context item. For example, an input swiping or dragging down through a visual context item (e.g., on a touch-sensitive surface of a display) dismisses the visual context item, and/or an input swiping or dragging a visual context item out of an “active” or “selected” region (e.g., 1548A) excludes the visual context item from the second set.

In some embodiments, prior to detecting the respective input, the electronic device displays the respective visual context item in an active context field (e.g., 1548A) of the digital assistant user interface (e.g., a user interface element that visually represents the current active/selected visual context items), wherein the respective input (e.g., 1556B) includes a respective movement input beginning at a location of the respective visual context item within the active context field and ending at a location outside of the active context field (e.g., a gesture swiping, dragging, pulling, and/or flicking the respective visual context item out of the region of the active context field).

In some embodiments, prior to detecting the respective input, the electronic device displays the respective visual context item with a respective cancel user interface object (e.g., 1506A, 1506B, 1506C, 1506D, 1538A, 1538B, and/or 1538C) (e.g., a software cancel button adjacent to, is near, and/or wholly or partially overlapping with the visual context item), wherein the respective input includes an input directed to the respective cancel user interface object (e.g., 1518A and/or 1524B). For example, each visual context item in the displayed set of visual context items is displayed with a software cancel button overlaying a corner (e.g., or another portion, such as the bottom center region) of the associated visual context item that can be selected to dismiss the associated visual context item from the selected set (e.g., the second set) and/or from the visual memory (e.g., the first set).

In some embodiments, the set of one or more inputs selecting the second set of one or more visual context items includes a gaze-based input (e.g., 1512B) (e.g., the second set of one or more visual context items is selected at least in part based on detecting the user's gaze). For example, the visual context items the user is looking at, has looked at, or looks at while providing another input (e.g., a speech, touch, button press, and/or air gesture input) are selected to include in the second set.

In some embodiments, modifying a display state of at least one visual context item of the first set of one or more visual context items based on the first set of one or more inputs includes moving (e.g., animating movement of) at least one visual context item within the digital assistant user interface (e.g., as illustrated in FIGS. 15F and 15L). In some embodiments, in response to an input selecting or excluding a visual context item to include in the second set, the selected/excluded visual context item is moved and/or the other visual context items are moved (e.g., one or more of the visual context items are rearranged to reflect the selecting/excluding of the visual context item).

In some embodiments, moving at least one visual context item within the digital assistant user interface includes, in response to detecting a respective input of the set of one or more inputs selecting a respective visual context item of the first set of visual context items (e.g., 1550A, 1550B, 1550C, and/or 1556A), moving the respective visual context item into an active context field (e.g., 1548A) of the digital assistant user interface (e.g., a user interface element that visually represents the current active/selected visual context items). For example, selected visual context items are moved into the active context field as they are selected.

In some embodiments, modifying a display state of at least one visual context item of the first set of one or more visual context items based on the first set of one or more inputs includes displaying the second set of one or more visual context items within the active context field of the digital assistant user interface (e.g., as illustrated in FIG. 15L) (e.g., including moving selected visual context items into the active context field and/or moving excluded visual context items out of the active context field). In some embodiments, if the second set of one or more visual context items does not include a respective visual context item of the first set of one or more visual context items, modifying a display state of at least one visual context item of the first set of one or more visual context items based on the first set of one or more inputs includes displaying the respective visual context items in a portion of the digital assistant user interface other than the active context field (e.g., including moving previously-selected visual context items out of the active context field as they are deselected).

While displaying the digital assistant user interface, the electronic device receives (1606) a user request (e.g., 1512A, 1520, 1524C, 1544, and/or 1552). In some embodiments, the user request is received as part of the set of one or more inputs, e.g., as part of a natural-language speech input such as “What's this bug,” “Add the first ones to my list,” or “Tell me about the bottom three.” In some embodiments, the user request is received after detecting the set of one or more inputs and after modifying the display state of the at least one visual context item. In some embodiments, the user request includes a natural-language input (e.g., a spoken and/or written user input, such as a natural-language prompt or query processed using a digital assistant system and/or language model). In some embodiments, the natural-language input includes a natural-language speech input. In some embodiments, the set of one or more inputs selecting the second set of one or more visual context items includes the natural-language input (e.g., as described with respect to 1512A and/or 1524C) (e.g., the user request specifies which of the displayed context items to use as context, such as “Tell me about the first three” or “Give me more detail on everything but the last one”).

In response to receiving (1606) the user request, the electronic device provides (1608) a response to the user request (e.g., 1514, 1522, 1526, 1546A, 1546B, and/or 1554) based the second set of one or more visual context items (e.g., the response is generated based at least in part on visual context information derived from the subset of visual context items using visual processing techniques). For example, the response includes one or more natural-language (e.g., spoken and/or textual) outputs, one or more display outputs, performance of one or more tasks, one or more audio outputs, and/or one or more tactile outputs. In some embodiments, providing the response to the user request based is further performed as described with respect to FIGS. 10A-14. In some embodiments, the response is based on other context information associated with the subset of visual context items, such as metadata captured in response to the user inputs along with the visual content. In some embodiments, the response is not based on one or more visual context items that are included in the first set but not in the second set (e.g., the response is not based on any visual context items that are not currently selected).

The operations described above with reference to FIG. 16 are optionally implemented by components depicted in FIGS. 1-4G, 6A-6B, 7A-7C, 8, 9, 10A-10V, and 15A-15L. For example, the operations of process 1600 may be implemented using digital assistant system 700, foundation system 800, system 900, system 1000, and/or processes 1100, 1200, 1300, and/or 1700. It would be clear to a person having ordinary skill in the art how other processes are implemented based on the components depicted in FIGS. 1-4G, 6A-6B, and 7A-7C, 8, 9, 10A-10V, and 15A-15L.

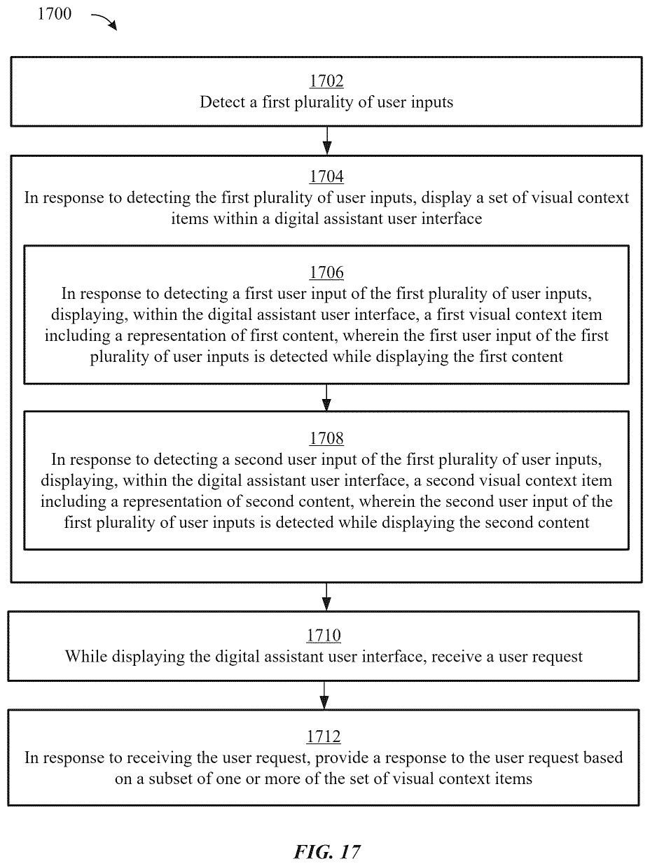

FIG. 17 illustrates process 1700 for collecting a plurality of visual context items used as a visual memory for response generation, according to various examples. Process 1700 is performed, for example, using one or more computer systems and/or electronic devices (e.g., 1000) implementing a digital assistant (e.g., including 700, 800, and/or 900). In some examples, process 1700 is performed using a client-server system (e.g., system 100), and the blocks of process 1700 are divided up in any manner between the server (e.g., DA server 106) and a client device. In other examples, the blocks of process 1700 are divided up between the server and multiple client devices (e.g., a mobile phone and a smart watch). Thus, while portions of process 1700 are described herein as being performed by particular devices of a client-server system, it will be appreciated that process 1700 is not so limited. In other examples, process 1700 is performed using only a client device (e.g., user device 104) or only multiple client devices. In process 1700, some blocks are, optionally, combined, the order of some blocks is, optionally, changed, and some blocks are, optionally, omitted. In some examples, additional steps may be performed in combination with the process 1700.

Process 1700 is performed at an electronic device (e.g., 1000) with (e.g., in communication with) a display generation component (e.g., 1002), one or more input devices (e.g., one or more hardware buttons (e.g., 1004), a touch-sensitive surface (e.g., of the display generation component and/or the hardware buttons), one or more cameras (e.g., 1006A, 1006B, 1006C, and/or 1006D), one or more peripheral hardware input devices (e.g., a mouse, stylus, keyboard, and/or other controller in communication with the electronic device), one or more gaze tracking components, one or more microphones or other audio sensors, and/or one or more motion sensors), one or more processors, and memory. Collecting a visual memory for use in response generation as described herein provides improved response generation, reduces the number of inputs needed for response generation, and provides improved visual feedback on a state of the device to a user, which reduces the power usage and improves the battery life of computer systems by enabling the user to use the devices more quickly and efficiently. For example, digital assistants implementing process 1600 provide seamless and complex task performance based on multiple items of visual context without the user needing to manually input context information and/or navigate between different user interfaces, while also providing the user with improved feedback on the multiple items of visual context information being used for response generation.

In some embodiments, the electronic device is in communication with one or more output devices in addition or alternatively to the display generation component, such one or more audio output devices and/or one or more tactile output devices, and content described herein as being “displayed” may include additional or alternative output content. For example, one or more visual content items described as being displayed may also be described to the user via a spoken output (e.g., simulated speech describing the visual memory that is or would be displayed).

The electronic device detects (1702), via the one or more input devices, a first plurality of user inputs (e.g., 1502A-1502C, 1508A-1508B, 1510A-1510B, 1516, 1532A-1532B, and/or 1540) (e.g., touch, gesture, air gesture, button press, gaze, speech, and/or text inputs selecting multiple pieces of visual context for use in a digital assistant session as a visual memory context). In some embodiments, the first plurality of inputs is detected while displaying a digital assistant user interface (e.g., 1012, 1014A, 1014B, and/or 1018B). In some embodiments, the first plurality of user inputs includes one or more touch inputs, air gesture inputs, inputs performed using peripheral hardware input devices, hardware button inputs, spoken inputs, and/or gaze inputs, such as tap inputs directed to a displayed capture user interface object (e.g., via a touch-sensitive display surface), button press inputs, air gestures (e.g., performed while the user's gaze is directed to the capture user interface object and/or a subject in a viewfinder), and/or other inputs indicating user requests to capture visual context items.

In response to detecting (1702) the first plurality of user inputs, the electronic device displays (1704), via the display generation component, a set of visual context items (e.g., 1504A, 1504B, 1504C, 1504D, 1536A, 1536B, and/or 1536C) (e.g., the current visual memory context) within a digital assistant user interface (e.g., as described with respect to FIGS. 15B-15G and/or 15I-15L). In some embodiments, the digital assistant user interface is displayed in response to a user input requesting a digital assistant session and/or a visual intelligence experience (e.g., as described with respect to FIGS. 10B-10E and 11).

Displaying (1704) the set of visual context items within the digital assistant user interface includes, in response to detecting a first user input of the first plurality of user inputs, displaying (1706), within the digital assistant user interface, a first visual context item including a representation of first content (e.g., a thumbnail, cut out, and/or other display element), wherein the first user input of the first plurality of user inputs is detected while displaying, via the display generation component, the first content (e.g., the first input selects currently-displayed visual content to use as an item of visual context in the digital assistant session); and in response to detecting a second user input of the first plurality of user inputs, displaying (1708), within the digital assistant user interface, a second visual context item including a representation of second content, wherein the second user input of the first plurality of user inputs is detected while displaying, via the display generation component, the second content (e.g., as described with respect to FIGS. 15B-15G and/or 15I-15J). In some embodiments, the visual context items include a representation of visual content that was not displayed at the time the respective input was detected (e.g., visual content that was overlaid by the digital assistant user interface and/or the other visual context items, as described with respect to FIGS. 15I-15J).

While displaying the digital assistant user interface (in some embodiments, and while displaying the set of visual context items), the electronic device receives (1710) a user request (e.g., 1512A, 1520, 1524C, 1544, and/or 1552). In some embodiments, the user request is received before, during, or after detecting the first plurality of user inputs and/or displaying the set of visual context items.

In response to receiving (1710) the user request (e.g., and while displaying the set of visual context items within the digital assistant user interface), the electronic device provides (1712) a response to the user request (e.g., 1514, 1522, 1526, 1546A, 1546B, and/or 1554) based on a subset of one or more of the set of visual context items (e.g., the response is based at least in part on visual context information derived from the subset of visual context items using visual processing techniques). For example, the response includes one or more natural-language (e.g., spoken and/or textual) outputs, one or more display outputs, performance of one or more tasks, one or more audio outputs, and/or one or more tactile outputs. In some embodiments, providing the response to the user request based is further performed as described with respect to FIGS. 10A-14. In some embodiments, the response is based on other context information associated with the subset of visual context items, such as metadata captured in response to the user inputs along with the visual content). In some embodiments, the subset includes some or all of the displayed plurality of visual context items. In some embodiments, the subset includes visual context items selected as described with respect to method 1600.

In some embodiments, while displaying the set of visual context items within the digital assistant user interface, the electronic device detects, via the one or more input devices, a dismissal input (e.g., 1518A, 1518B, 1524A, 1524B, 1524C, and/or 1556B) directed to a respective visual context item of the set of visual context items. In some embodiments, in response to detecting the dismissal input, the electronic device removes the respective visual context item from the set of visual context items, wherein removing the respective visual context item from the set of visual context items includes ceasing displaying the respective visual context item within the digital assistant user interface (e.g., as described with respect to FIGS. 15E-15F). In some embodiments, in response to detecting the dismissal input, the electronic device removes the respective visual context item from the subset of visual context items but not from the set of visual context items (e.g., as described with respect to method 1600), and continues displaying the respective visual context item within the digital assistant user interface (e.g., as illustrated in FIG. 15G). In some embodiments, if the user request is received after removing the respective visual context item from the set (e.g., while the respective visual context item is not displayed), the respective visual context item is not included in the subset (e.g., the response to the request is not based on the respective visual context item).

In some embodiments, the dismissal input includes a movement input (e.g., 1518B and/or 1556B) (e.g., a touch gesture, air gesture, and/or other input with a movement component) directed to (e.g., moving across) the respective visual context item. In some embodiments, the movement input is a movement in a particular direction with respect to the respective visual context item. For example, an input swiping or dragging down through a visual context item (e.g., on a touch-sensitive surface of a display) dismisses the visual context item.

In some embodiments, displaying the set of visual context items within the digital assistant user interface includes displaying the respective visual context item with a cancel user interface object (e.g., 1506A, 1506B, 1506C, 1506D, 1538A, 1538B, and/or 1538C) (e.g., a software cancel button), and the dismissal input includes an input directed to the cancel user interface object. For example, the cancel user interface object is adjacent to, is near, and/or wholly or partially overlapping with the visual context item. For example, each visual context item in the displayed set of visual context items is displayed with a software cancel button overlaying a corner of the associated visual context item that can be selected to dismiss the associated visual context item from the set.

In some embodiments, in response to receiving the user request, the electronic device selects the subset of one or more of the set of visual context items from the set of visual context items based on the user request (e.g., as described with respect to FIGS. 15D and/or 15F-15G) (e.g., based on the contents of the user request and/or information associated with the user request, such as conversation history, gaze or attention information, and/or other contest). For example, the user request specifies one or more of the displayed context items (e.g., “Tell me about the first three” or “Give me more details about the restaurants”).

In some embodiments, while displaying the set of visual context items within the digital assistant user interface (e.g., and prior to providing the response to the user request), the electronic device detects, via the one or more input devices, a set of one or more inputs (e.g., 1512A-1512B, 1518A-1518F, 1524A-1524C, 1550A-1550C, 1556A, and/or 1556B) directed to the set of visual context items (e.g., inputs selecting, deselecting, moving, dismissing, and/or otherwise interacting with one or more displayed visual context items), and in response to receiving the user request, selecting the subset of one or more of the set of visual context items from the set of visual context items based on the set of one or more inputs directed to the set of visual context items (e.g., as described with respect to method 1600) (e.g., the response is based on the subset of visual context items selected by the set of one or more inputs). In some embodiments, the inputs are detected prior to receiving the user request. In some embodiments, the inputs are detected during or after (e.g., shortly after) receiving the user request.

In some embodiments, in response to detecting, in the set of one or more inputs directed to the set of visual context items (e.g., 1512A-1512B, 1518A-1518F, 1524A-1524C, 1550A-1550C, 1556A, and/or 1556B), a selection input directed to a third visual context item of the set of visual context items, displaying the third visual context item in a respective region (e.g., a region representing the “active” or “selected” visual memory) of the digital assistant user interface (e.g., 1548A) (in some embodiments, moving the third visual context item into the respective region), wherein selecting the subset of one or more of the set of visual context items includes selecting the third visual context item (e.g., as described with respect to FIGS. 15K-15L) (e.g., based on the selection input; in some embodiments, in accordance with a determination that the third visual context item is displayed in the respective region). In some embodiments, in response to detecting the set of one or more inputs directed to the set of visual context items, the computer system displays the subset of one or more of the set of visual context items in the respective region of the digital assistant user interface (e.g., active or selected visual context items are spatially grouped within a specific region of the user interface). In some embodiments, the respective region includes a visual indication, such as a border, platter, bubble, or other graphical element distinguishing the respective region (e.g., the active region) from other portions of the digital assistant user interface (e.g., an inactive region). In some embodiments, the selection input includes an input swiping, dragging, or moving the third visual context item into the respective region.

In some embodiments, in response to detecting, in the set of one or more inputs directed to the set of visual context items, a dismissal input (e.g., 1556B) directed to a fourth visual context item of the set of visual context items, wherein the dismissal input is detected while displaying the fourth visual context item in the respective region, the electronic device ceases displaying the fourth visual context item in the respective region (e.g., as described with respect to FIG. 15L), wherein selecting the subset of one or more of the set of visual context items includes foregoing selecting the fourth visual context item (e.g., based on the dismissal input; In some embodiments, in accordance with a determination that the fourth visual context item is not displayed in the respective region). In some embodiments, the dismissal input includes an input swiping, dragging, or moving the fourth visual context item out of the respective region. For example, the user can gather and remove visual context items from the respective region to control the visual context being used for response generation.

In some embodiments, the first input of the first plurality of user inputs is detected while displaying, via the display generation component, a representation of a feed of camera data from the one or more cameras (e.g., 1018A) (e.g., a viewfinder user interface including a live- or near-live representation of a field-of-view of the one or more cameras, as described with respect to FIGS. 10A-15G). For example, the digital assistant user interface overlays the viewfinder, includes the viewfinder, and/or is displayed with the viewfinder. In some embodiments, the first content includes a first frame of the camera data (e.g., a freeze frame) corresponding to the first input (e.g., as described with respect to 1504A, 1504B, 1504C, and/or 1504D) (e.g., a frame of camera data received near in time to the user input, e.g., before, during, or after detecting the first input; e.g., as described with respect to FIGS. 10A-15G).

In some embodiments, while displaying, within the digital assistant user interface, the first visual context item (e.g., 1504A, 1504B, 1504C, and/or 1504D) and the representation of the feed of camera data from the one or more cameras (e.g., 1018A) (e.g., after detecting at least the first input of the first plurality of user inputs), the computer system receives, via the one or more cameras, the feed of the camera data, and in response to receiving the feed of the camera data, updates the representation of the feed of the camera data (e.g., as described with respect to FIGS. 15B-15G). For example, as frames of the camera data are received from the one or more cameras, the frames are successively displayed in the viewfinder user interface (e.g., advancing the feed), providing a live- or near-live representation of the field-of-view of the one or more cameras. For example, the viewfinder remains in a “live” mode (e.g., the first mode described with respect to method 1200) while detecting the first plurality of user inputs and displaying the corresponding set of visual context items in the digital assistant user interface.

In some embodiments, the first input of the first plurality of user inputs is detected while displaying, via the display generation component, a respective user interface that is different from the digital assistant user interface (e.g., 1018A and/or 1530) (e.g., the respective user interface is overlaid by, integrated into, and/or otherwise displayed at the same time as the digital assistant user interface). For example, the respective user interface is a viewfinder user interface, a camera user interface, and/or an application user interface. In some embodiments, the first content includes at least a portion of content displayed within the respective user interface when the first input is detected (e.g., as described with respect to FIGS. 15B-15J) (e.g., visual context extracted from the user interface being viewed along with the digital assistant user interface). For example, the first content includes a screenshot and/or an image extracted from the respective user interface. In some embodiments, the first content does not include at least a portion of the digital assistant user interface (e.g., the digital assistant user interface, including any displayed visual context items, are not included in a screenshot).

In some embodiments, the digital assistant user interface includes a capture user interface object (e.g., 1018B) (e.g., a software button), and the first plurality of user inputs includes an input directed to the capture user interface object (e.g., 1502A, 1508A, 1510A, and/or 1516). In some embodiments, the first plurality of user inputs includes an input directed to a hardware button of the one or more input devices (e.g., 1502C and/or 1540) (e.g., as described with respect to method 1300).

In some embodiments, while displaying the digital assistant user interface, the electronic device displays, via the display generation component, respective visual content (e.g., 1018A, 1530, and/or 1530A-1530F) (e.g., a viewfinder, user interface, and/or other content displayed with, integrated into, and/or overlaid by the digital assistant user interface), wherein the first plurality of user inputs includes an input directed to the respective visual content (e.g., 1502B, 1508B, 1510B, 1532A, and/or 1532B).

In some embodiments, a duration of the input directed to the respective visual content exceeds a threshold duration (e.g., as described with respect to input 1532A). In some embodiments, in response to detecting an input directed to the respective visual content and in accordance with a determination that the duration of the input exceeds the threshold duration, the input is registered as one of the first plurality of user inputs. In some embodiments, in response to detecting an input directed to the respective visual content and in accordance with a determination that the duration of the input does not exceed the threshold duration, the computer system does not display a visual context item corresponding to the input.

In some embodiments, displaying the set of visual context items within the digital assistant user interface includes, in response to detecting the input directed to the respective visual content (e.g., 1502B, 1508B, 1510B, 1532A, and/or 1532B), displaying, within the digital assistant user interface, a respective visual context item that includes a representation of a first portion of the respective visual content (e.g., 1504C, 1536A, and/or 1536B) (e.g., a thumbnail, cut out, and/or other display element), wherein the input directed to the respective visual content is directed to the first portion of the respective visual content. In some embodiments, the respective visual context item does not include a representation of a second portion of the respective visual content (e.g., the respective visual context item includes a cropped, cut out, and/or otherwise extracted portion of the respective visual content).

In some embodiments, the second user input is detected while displaying the first visual context item (e.g., as described with respect to FIGS. 15B-15D and 15I), and in response to detecting the second user input, the electronic device maintains displaying, within the digital assistant user interface, the first visual context item while displaying the second visual context item (e.g., as illustrated in FIGS. 10E-10G and 15J) (e.g., the second visual context item is displayed at the same time as the first visual context item). For example, in response to the first plurality of user inputs, multiple visual context items are displayed together within the digital assistant user interface, providing a record of the available visual context.

In some embodiments, while detecting the first user input of the first plurality of user inputs (e.g., prior to displaying the first visual context item), the electronic device displays, via the display generation component, the first content at a first size, wherein the representation of the first content is displayed at a smaller size than the first size (e.g., the visual context item is displayed with a scaled-down and/or cropped thumbnail or cutout of the first content).

In some embodiments, while displaying the set of visual context items within the digital assistant user interface, the electronic device receives a second user request, and in response to receiving the second user request, the electronic device provides a second response to the second user request based on a second subset of one or more of the set of visual context items (e.g., as described with respect to FIGS. 15F-15G). For example, the user can make follow-up requests based on the displayed visual context, including using the same visual context items multiple times, editing the visual context items being used, and/or adding additional visual context items.

In some embodiments, while displaying the set of visual context items (e.g., 1504A, 1504B, and/or 1504C), including a respective visual context item, within the digital assistant user interface (in some embodiments, after providing the response to the user request based on the subset of one or more of the set of visual context items), the electronic device detects, via the one or more input devices, an additional user input (e.g., 1516). In some embodiments, in response to detecting the additional user input, the electronic device displays the set of visual context items within the digital assistant user interface with an additional visual context item (e.g., 1504D) (e.g., adding another visual context item to the set) including a representation of additional content (in some embodiments, the additional user input is detected while displaying, via the display generation component, the additional content), wherein the second user request (e.g., 1520) is received while displaying the set of visual context items including the respective visual context item and the additional visual context item and the second subset of one or more of the set of visual context items includes the respective visual context item and the additional visual context item (e.g., as described with respect to FIG. 15F) (e.g., the user can add new visual context items to the visual memory without discarding previously added/used visual context items).

In some embodiments, in response to detecting the first user input of the first plurality of user inputs while displaying the first content, the electronic device modifies (e.g., temporarily modifying) an appearance of the first content (e.g., as described with respect to FIG. 15D). For example, the content being added as visual context is temporarily highlighted, outlined, enlarged, and/or otherwise emphasized or changed to indicate that it is being added to the visual memory. In some embodiments, the representation of the first content does not represent the modified appearance. In some embodiments, the modification is displayed temporarily (e.g., for a short, predetermined duration, such as 0.1 s, 0.5 s, or 1 s) and then removed and/or reverted.

The operations described above with reference to FIG. 17 are optionally implemented by components depicted in FIGS. 1-4G, 6A-6B, 7A-7C, 8, 9, 10A-10V, and 15A-15L. For example, the operations of process 1700 may be implemented using digital assistant system 700, foundation system 800, system 900, system 1000, and/or processes 1100, 1200, 1300, and/or 1600. It would be clear to a person having ordinary skill in the art how other processes are implemented based on the components depicted in FIGS. 1-4G, 6A-6B, and 7A-7C, 8, 9, 10A-10V, and 15A-15L.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods or processes described herein.

In accordance with some implementations, an electronic device (e.g., a portable electronic device) is provided that comprises means for performing any of the methods or processes described herein.

In accordance with some implementations, an electronic device (e.g., a portable electronic device) is provided that comprises a processing unit configured to perform any of the methods or processes described herein.

In accordance with some implementations, an electronic device (e.g., a portable electronic device) is provided that comprises one or more processors and memory storing one or more programs for execution by the one or more processors, the one or more programs including instructions for performing any of the methods or processes described herein.

In accordance with some implementations, a computer system is provided that comprises means for performing any of the methods or processes described herein.

In accordance with some implementations, a computer system is provided that comprises a processing unit configured to perform any of the methods or processes described herein.

In accordance with some implementations, a computer system is provided that comprises one or more processors and memory storing one or more programs for execution by the one or more processors, the one or more programs including instructions for performing any of the methods or processes described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to provide context for generating outputs to user prompts. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide context for generating outputs to user prompts. Accordingly, use of such personal information data improves the accuracy, relevance, and quality of generated responses. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of digital assistant systems, the present technology can be configured to allow users to select to “opt in” or “opt out” of participation in the collection and/or use of personal information data during registration for services or anytime thereafter. In another example, users can select whether to grant permission to provide camera data to one or more services use as context for generating responses. For example, as described above, digital assistant systems can request user permission prior to providing camera data to other applications and/or services, including remote (e.g., server-based) services, machine vision services, and/or generative AI services. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app. For instance, a user may be prompted to grant specific data sharing permission each time the digital assistant service attempts to invoke and/or share camera data with another application and/or service.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, context information can be determined based on non-personal information data or a bare minimum amount of personal information, such as the content being requested by the device associated with a user, other non-personal information available to the digital assistant services, or publicly available information. For example, rather than share camera data directly with other applications and/or services, the digital assistant system can process the camera data using local and/or secure processes to extract limited and/or anonymized information (e.g., a text description of the camera data) to share instead.

1-140. (canceled)

141. An electronic device, comprising:
a display generation component;
one or more cameras;
one or more processors;
a memory; and
one or more programs, wherein the one or more programs are stored in the memory and configured to be executed by the one or more processors, the one or more programs including instructions for:
displaying, via the display generation component, a representation of a feed of camera data from the one or more cameras;
while displaying the representation of the feed of the camera data from the one or more cameras, detecting a user input;
determining, based on the camera data from the one or more cameras, first visual context information;
in response to detecting the user input, providing a representation of the user input and the first visual context information to a digital assistant agent; and
generating, using the digital assistant agent, a response based on the representation of the user input and the first visual context information, wherein generating the response includes:
selecting an application intent corresponding to the user input; and
providing the application intent to an application, wherein providing the application intent to the application causes the application to execute a task.

142. The electronic device of claim 141, wherein selecting the application intent corresponding the user input includes:
in accordance with a determination that the first visual context information includes a first type of visual context information, selecting a first candidate intent as the application intent; and
in accordance with a determination that the first visual context information includes a second type of visual context information different from the first type of visual context information, selecting a second candidate intent, different from the first candidate intent, as the application intent.

143. The electronic device of claim 141, wherein generating the response based on the representation of the user input and the first visual context information includes:
determining, based on the first visual context information, a set of one or more parameter values for performing the task.

144. The electronic device of claim 143, wherein the set of one or more parameter values includes a plurality of parameter values.

145. The electronic device of claim 143, wherein determining the set of one or more parameter values for performing the task includes:
determining a first parameter value based on a first portion of the first visual context information, wherein the first portion of the first visual context information corresponds to a first image captured in the feed of camera data from the one or more cameras; and
determining a second parameter value based on a second portion of the first visual context information, wherein:
the second portion of the first visual context information corresponds to a second image captured in the feed of camera data from the one or more cameras; and
the first image and the second image were captured by the one or more cameras at different times.

146. The electronic device of claim 143, wherein determining the set of one or more parameter values for performing the task includes determining at least one parameter value based on the first visual context information and additional context information.

147. The electronic device of claim 146, wherein the additional context information includes gaze information indicating that a gaze of a user is directed to first content included in the feed of the camera data from the one or more cameras, wherein the first content corresponds to the at least one parameter value.

148. The electronic device of claim 141, the one or more programs further including instructions for:
in response to detecting the user input, generating the representation of the user input based on the first visual context information.

149. The electronic device of claim 148, wherein generating the representation of the user input based on the first visual context information includes:
converting the user input into a rewritten query based on the first visual context information, wherein the representation of the user input includes the rewritten query.

150. The electronic device of claim 141, wherein the digital assistant agent includes a large-language model.

151. The electronic device of claim 141, wherein the representation of the feed of camera data from the one or more cameras is included in a media capture user interface of a camera application.

152. The electronic device of claim 141, the one or more programs further including instructions for:
while displaying, via the display generation component, a respective user interface, receiving a respective input requesting the representation of the feed of the camera data from the one or more cameras; and
in response to receiving the respective input, displaying the representation of the feed of camera data from the one or more cameras while maintaining displaying at least a portion of the respective user interface.

153. The electronic device of claim 141, the one or more programs further including instructions for:
while displaying the representation of the feed of the camera data from the one or more cameras, displaying, via the display generation component, a set of one or more prompt user interface objects associated with one or more prompts, wherein displaying the set of one or more prompt user interface objects includes:
determining, based on the camera data from the one or more cameras, current visual context information;
in accordance with a determination that the current visual context information satisfies a first set of one or more suggestion criteria, displaying a first prompt user interface object associated with a first prompt; and
in accordance with a determination that the current visual context information satisfies a second set of one or more suggestion criteria, displaying a second prompt user interface object, associated with a second prompt, that is different from the first prompt user interface object.

154. The electronic device of claim 153, wherein:
the user input includes an input selecting a respective prompt user interface object of the set of one or more prompt user interface objects; and
the representation of the user input includes a respective prompt associated with the respective prompt user interface object.

155. The electronic device of claim 141, wherein determining the first visual context information includes:
in accordance with a determination that a set of one or more view criteria is satisfied, determining the first visual context information based on first camera data from a first camera of the one or more cameras; and
in accordance with a determination that the set of one or more view criteria is not satisfied, determining the first visual context information based on second camera data from a second camera of the one or more cameras that is different from the first camera of the one or more cameras.

156. The electronic device of claim 155, wherein the set of one or more view criteria includes a criterion that is satisfied based on the user input.

157. The electronic device of claim 155, wherein the set of one or more view criteria includes a criterion that is satisfied based on a set of current contextual information.

158. The electronic device of claim 141, the one or more programs further including instructions for:
in response to detecting the user input, outputting, based on the user input, a capture guidance indication, wherein the first visual context information is based at least in part on camera data from the one or more cameras captured after outputting the capture guidance indication.

159. A non-transitory computer-readable storage medium storing one or more programs, the one or more programs comprising instructions, which when executed by one or more processors of an electronic device with a display generation component and one or more cameras, cause the electronic device to:
display, via the display generation component, a representation of a feed of camera data from the one or more cameras;
while displaying the representation of the feed of the camera data from the one or more cameras, detect a user input;
determine, based on the camera data from the one or more cameras, first visual context information;
in response to detecting the user input, provide a representation of the user input and the first visual context information to a digital assistant agent; and
generate, using the digital assistant agent, a response based on the representation of the user input and the first visual context information, wherein generating the response includes:
selecting an application intent corresponding to the user input; and
providing the application intent to an application, wherein providing the application intent to the application causes the application to execute a task.

160. A method, comprising:
at an electronic device with a display generation component, one or more cameras, one or more processors, and memory:
displaying, via the display generation component, a representation of a feed of camera data from the one or more cameras;
while displaying the representation of the feed of the camera data from the one or more cameras, detecting a user input;
determining, based on the camera data from the one or more cameras, first visual context information;
in response to detecting the user input, providing a representation of the user input and the first visual context information to a digital assistant agent; and
generating, using the digital assistant agent, a response based on the representation of the user input and the first visual context information, wherein generating the response includes:
selecting an application intent corresponding to the user input; and
providing the application intent to an application, wherein providing the application intent to the application causes the application to execute a task.
